(19) United States
(12) Patent Application Publication
(10) Pub. No.: US 2015/0294325 A1
(43) Pub. Date: Oct. 15, 2015

(54) METHOD FOR ANALYZING ECONOMIC PHENOMENA

(71) Applicant: Frank Patrick Cunnane, Burton, OH (US)

(72) Inventor: Frank Patrick Cunnane, Burton, OH (US)

(21) Appl. No.: 14/672,400

(22) Filed: Mar. 30, 2015

Related U.S. Application Data
(60) Provisional application No. 61/979,076, filed on Apr. 14, 2014.

(51) Int. Cl. G06Q 30/02

(52) U.S. Cl. CPC G06Q 30/0201

(57) ABSTRACT

New methods and strategies for analyzing, characterizing, and assessing economic phenomena are described. The methods utilize principles from physics and in many applications actual laws of physics to evaluate economic phenomena.

### CROSS REFERENCES TO RELATED APPLICATIONS

The present application claims priority upon U.S. provisional patent application Ser. No. 61/979,076 filed Apr. 14, 2014.

### FIELD

The present subject matter relates to new methods and strategies for analyzing economic phenomena. The present subject matter also relates to computer readable media and systems for performing the noted methods.

### BACKGROUND

Economic analysis concerns the collection, processing, compilation, dissemination, and evaluation of economic data and phenomena. The data may include those of any economy of region, country, or group of countries. Analysis may include topics and problems in microeconomics, macroeconomics, business, finance, forecasting, data quality, and policy evaluation.

Many methods are known to analyse economic phenomena and data. These include, e.g., time-series analysis using multiple regression, Box-Jenkins analysis, and seasonality analysis. Analysis may be univariate (modelling one series) or multivariate (from several series). Econometricians, economic statisticians, and financial analysts formulate models, whether for past relationships or for economic forecasting. These models include both partial equilibrium microeconomics aimed at examining particular parts of an economy or economies, or they may cover a whole economic system, as in general equilibrium theory or and in macroeconomics. Economists use these models to understand past events and to forecast future events, e.g., demand, prices, and employment. Methods have also been developed for analysing or correcting results from use of incomplete data and errors in variables.

Although satisfactory in many respects, a need exists for a new approach for analysing economic phenomena and data.

### SUMMARY

The difficulties and drawbacks associated with previously known practices are addressed in the present methods for analyzing economic phenomena.

Generally the present subject matter provides methods of analyzing economic phenomena. The methods comprise identifying at least one economic variable of the economic phenomena to be analyzed. The methods also comprise assigning one or more physics variables to each of the identified economic variables, wherein the assigned physics variables correspond to the respective identified economic variable. And, the methods comprise evaluating the assigned physics variables using physical laws to thereby analyze the economic phenomena.

The present subject matter also provides articles that include machine-readable instructions for performing the noted methods.

And, the present subject matter also provides systems which include processor(s) and memory that are configured to perform the noted methods.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic diagram showing energy input to a system and work output.

FIG. 2 is a schematic diagram showing a physics to economics analogy.

### DETAILED DESCRIPTION

The present subject matter provides a new strategy for analyzing economic phenomena by identifying one or more economic variables of the phenomena to be analyzed. After identifying the economic variables, one or more physics variables are assigned to each of the respective economic variables. Thus, the economic variables are replaced by physics variables. The physics variables are those that correspond to the economic variable, as described in greater detail herein. After assignment of the physics variables, the resulting collection of physics variables are then evaluated using physical laws, as described in greater detail herein, to thereby analyze the economic phenomena.

### I. Prologue—To Begin

How can a block of steel sitting on a flat surface move? Why is it sitting still? Why does the block of steel not move on its own? These are questions of physics and ultimately natural science. Questions of physics or natural science may be directed to the behavior of mass (the block of steel), its movement in distance and time, and what causes it to move, “the cause”. Restated, where does the cause come from or what is the origin of the cause? The answers, methods, mathematical formulas, and principles of truth are the domain of natural science. Natural science is of the natural world, and the methods are constrained by the laws of behavior of the natural universe. If magic, mysticism, wishful thinking, or beliefs have an opposite, it is the natural science view of how things work.

How much does it cost to move a block of steel? Who will move the steel? How long will it take? How far is it going to be moved? Where did the steel come from? Who made the steel and how much did it cost? Who put the block of steel on the flat surface and how much was the delivery cost? Who owns the steel? Have the taxes been paid? Was there debt involved? How much steel is available? These are all questions of economics.

In natural science what makes things (objects) move is they are caused to move. The cause moves and the movement is the effect from the cause. The cause of movement is from an origin where energy is generated and applied as force and in the application of force there are counter forces to be overcome and if the net force, the applied force—counter force, is sufficient to move the block of steel, then an effect of the net force is that the steel moves. The steel can never move unless it is caused to move. The steel can not just move on its own and claim it caused itself to move. Only by the cause of applied force derived from energy can the steel move.

In the language of physics how is the movement of the steel defined? The origin of force applied is from energy which is the applied force as force push which is counteracted upon by counter force and also counteracted upon by force drag (friction) when the total force (summation of force) must be greater than the counter force due to the resistance of the mass of steel (steel block). The summation of force is the cause. The cause always happens first. The force must actually contact or otherwise be applied to the steel to move the steel. When the steel moves its movement is the effect due to the summation of force (the cause) and the effect always comes second in the time order of the laws of physics. Adding more detail to motion are the definitions or components of each part of the movement:

Energy enables the applied force to exist;

Applied force is the force push;

Force push is counteracted upon by counter forces;

The force push minus the counter force equals the summation of force written as (Σf);

If the (Σf) is greater than zero then the steel block moves;

The block of steel is mass, as mass resists force;

Gravity on the surface of earth pulls downward holding objects in place;

The (Σf) must overcome gravity to move the object;

The quantity of the object is mass, typically measured in kilograms (2.2 pounds);

The quantity of its movement is distance, typically measured in meters (about 3 feet); and

The quantity of how long it took is time, typically measured in seconds.

Then the summation of force is equal to mass moving a meter in a second and going faster the next second. This is Newton's second law written as Σf=ma, which is the summation of force equals mass multiplied by acceleration. Acceleration is a more complicated concept. As noted, Newton's second law of motion is Σf=ma. To describe this second law in units is called a “Newton” and a “Newton” is equal to one kilogram multiplied by a meter divided by a second squared. Written as a formula this relationship is: N=Kg (m/s²).

How does present day economics describe the block of steel? The steel is a good, it is to be distributed, and the good is scarce. This description by present day economics is derived from a social science, not a natural science method of reasoning. Social science is not based on principles of truth and is not in a useable mathematic form. If the objective is to move a hundred blocks of steel per day and do it faster and cheaper than anyone else in the world can, the social science view of a scarce good which needs distribution is of little practical use.

The present subject matter is directed to providing an answer of exactly how to move more steel, faster and cheaper than anyone else in the world, from a USA perspective for the expressed purpose of making the USA more wealthy. In physics, a steel block in motion is due to the energy as a cause using force to move the mass, distance, in time. Energy, mass, distance, time. So much energy, counteracted upon by so much counter force, can move so much mass valued in kilograms so much distance in units of meters in so much time in units of seconds.

A car uses energy to move distance in time and so does a tractor, train, plane, lathe, saw, bull dozer, fork lift, ship, drill, auger, trencher, pump, turbine, windmill, battery, washing machine, and the movement of electrical power from place to place. It is all motion, whose origin is energy, using applied force—counter force to move mass distance in time. The present subject matter identifies various parallels between economics and energy, mass, distance, and time; at least to a significant degree. Yet there is very little physics in current economic thinking. This seems odd, as before Newton (1640s), there were not any machines at least not to an appreciable extent. It was Newton's Laws of motion that allowed the machine age to begin. Then automobiles, tractors, planes, etc., utilized Newton's Laws of motion. Newton's Laws of motion are natural science, not social science and currently there is very little natural science in economics.

American's economy is over 100% in debt. There is not any way to pay the debt off so inevitably prices will rise. The value of personal assets will fall and wages will decline in the value equal to the debt. Manufacturing can not function and compete in a rising domestic price environment so as a consequence very little global manufacturing is occurring in the USA. In the 1970's 16% of the businesses were rated AAA, now less than 1% or 6/10 of one percent are AAA. American products became fewer and fewer, where almost no American made products are present in stores in the USA. This is significant because lives, well-being, wealth freedom, health, and future for families are completely dependent upon the value of products made.

Economics is lacking in its capabilities to plot a future course to increase the wealth of the nation. A new course must be determined and its basics must be in agreement with the principles, truths, laws and mathematics of the natural sciences.

The present subject matter provides a natural science based solution to increasing wealth.

### Position Initial

### II. The Pilgrim Test of Economic Theory

The pilgrims landed in Plymouth in approximately 1620. It was completely undeveloped, but there were abundant raw materials, a dense forest, plenty of water, wild animals, and next to an ocean full of fish.

Upon arrival in North America the economic conditions of the pilgrim, “system economy”, was 100% unemployment, zero production of any kind, zero housing, their only joules of energy were from the total caloric energy of the pilgrims themselves. They all gathered on the beach and someone yelled “go”, which was the verbal declaration of the starting point (the position initial) of the New England economy. What did they do? They swung tools. In physics, to swing a tool is to have as origin of a cause which is the chemical energy in the human body which contacts the tool as an applied force and is then counteracted upon by gravity, but also swinging the tool downward uses gravity as an accelerant to the effort causing conservation from potential energy to kinetic energy as gravity plus the strength of the pilgrim resulted in an increasing of the force of the tool which maximize their energy resource. The first thing they did was to maximize their energy output.

The purpose of the pilgrim economic system was to do something, but there was confusion and disagreement as to what the objective should be. They used social science to design their economy. There was not any experimentation or applied mathematics, they ignored their religion, they simply decided without referencing history to just work, then at some point in the future, “harvest time”, equally split up the results of their efforts, (social provisioning).

This method failed. Since they were the only members of the pilgrim economy, (monistic), their failure was apparent as they were starving to death in totality. Starving to death makes for an easy debate, not too many long winded eloquent speeches, just results oriented. They concluded everyone would work for themselves, which resulted in an acceleration of wealth, an increase in wealth (becoming more rich than previously existed), and wealth in surplus enabling additional businesses to start up aside from agriculture and housing, such as ship building and repair parts for passing ships. They became so wealthy they broke from England and became an entirely new country. They initially applied social science to their economic system which failed and later converted to natural science to succeed. The natural science method has the least amount of interference between the energy input and the output.

In natural science a theory, or process, with experimentation, plus observation must conform to the laws of physics or it is unlikely to be true. The pilgrim economic system is a historic laboratory to test economic theory, even today's economic theory because it had such a clearly established initial position of zero. This society had velocity zero (v₀) as its starting point and zero stored wealth. This is referred to herein as the pilgrim test. Can a theory pass the pilgrim test? The following are examples of how the pilgrim test might be used as a method of reasoning to determine the validity of an economic theory:

At the initial arrival, within the first 12 months could the pilgrims simply declare themselves employed teachers with good pay and a pension?

Could the pilgrims have printed money and used the printed money to buy a house, food, or clothing?

Could the pilgrims have borrowed money to use to buy a house, or food, or clothing?

Could the pilgrims have started the government and have the government pay the pilgrim so they could buy their necessities?

Could the pilgrims establish a minimum wage?

Could they have started a hedge fund?

Could they have implemented QE 1, 2, or 3?

Why didn't the pilgrims just issue food stamps to feed the poor pilgrim?

When an economic system is in an initial position, at rest (velocity zero), or with zero stored wealth then how does the initial position change to a future position (position final)?

What eventually enables the pilgrim economic system to begin moving?

The present subject matter is directed to providing answers to these inquiries.

### III—the Introduction—To Explain

The purpose of the present subject matter is to advocate applying methods of natural science, a physics based design method of solutions, to reverse America's economic decline. A decline is measured by a reduction in Gross Domestic global market share from the 1950's at a 40% plus wealth share to the present (2014) at a 19% global market share. The average income of the American worker is declining as wages have not increased in the past ten years, (2014), but prices of automobiles and food have doubled making the net economic well-being (well-being means how wealthy someone is) move in a negative direction. Steel production is below 1940 levels, and peace time government debt has increased from the 50% range (in early 2000) to now over 100% of the GDP (as of 2014), (more is owed than what is produced).

American political and military powers are insufficient to suppress Russia and Chinese moves toward expansion. There are more on welfare than ever before and there are fewer working than ever before and those working have less buying power than ever before. There is confusion as to what to do regarding America's available natural resources versus what wealth is being created. Based on resources, the USA should have the relative highest global market share of wealth and be maintained for hundreds of years forward.

For the past seven years the only solution offered to the American people by its representative government is to print money and reduce freedom. The present subject matter questions their methods and proposes new methods based on the principles of truth as methods of natural science where laws interpreted by the process of physics are used to increase domestic wealth.

The present subject matter is a complete re-think of what economics is, how it works and what the best methods are to create a result of an America equal to or better than its available natural resources. The people are told there are scarcities preventing prosperity or that the people are not living up to our exceptional potential. Neither the concepts of scarcity nor exceptionalism exist in natural science. Natural science, physics is saying based upon the cards dealt, the USA should pull x amount of chips off the global table of international trade plus add in the natural resource internal capacity to generate a volume of wealth which should add up to a 40% plus global market share. To fall below that number is mismanagement. The benefit of an increase in wealth to every American citizen is betterment, a better wage, a longer life, a richer longer retirement within the safety of a strong nation state to protect freedom, and an increase in personal freedom. More wealth means a better life as observed throughout history.

To solve the current economic problems by applying the principle laws of physics means to rewrite the interpretation of the definition of economics as well as redefine its concepts using an analogy of the reasoning process of physics to rethink economics in its entirety. Physics is the fundamental scientific reasoning process of cause and effect. Physics is a process to understand the cause and resultant effect with a forward looking expectation.

To understand economics in a view which avails itself to a natural scientific methodology of applied cause and effect seems to be the necessary process to implement to move America forward where a cause results is an expected increase in wealth as a targeted result as an effect which is an expected outcome of increased wealth. By applying a scientific cause, a specific effect occurs. Natural science and its field of study of physics offers great clarity as to the result of cause and effect based on well established principles and truths, repeatable experimentation, and observable laws.

The principle by which economics may be interpreted in the natural science laws of physics are based upon the fact both humanity and goods made are physical and occur against the force of gravity. A human has weight, energy is produced from chemical reactions, and then the effect is to move distance in time. Goods made are in kilograms, and then move distance, in time. Physics is a study of and is written in the three dimensions of mass (mass measured in kilograms), space (measured in distance using meters), and time (measured in seconds). Gravity, force, energy, mass, space, time and the relationship of energy to the motion of mass are the constraints, principles, and laws of physics, and are highly proportional to the answer to economic conditions and effecting improvement which are then based upon these principles and are subject to natural science based solutions.

Economics is mass in motion as a change in the economic system. Human economics is mass in motion. To change the economy avails itself to a physics mass in motion solution: a cause and effect solution.

The dominant economic reasoning method at present, (2014), is defining economics derived from a social science based methodology. Social science as a methodology is not based on principles of truth or laws where there is a starting point, a change due to a cause and an ending point as an effect which occurred from the cause. Social Science does not have a starting point or an ending point and is not based on the principles of truths. Social science can say being a surf is good, a subjugate non-asset owner worker is good, or a free individual is equally good as well. There are not any principles of truth or laws allowing a repeatable observation in social science as there are in physics. Mathematics alone absent of physical laws is also free to stray from the principles of physics allowing theories not based on the natural world.

Current definitions of economics are in the reasoning process of social science. A social science view is absent of the cause and effect capabilities. The social science view has brought America, an abundantly resource rich country, to become debt ridden, void of growth, offering little opportunity for the young to build careers and has also failed to match the availability of resources to the generation of wealth equal to those resources: American is poorer than it should be.

The present subject matter rewrites the present day view of economics dominated by a social science view to a parallactic vision based on an analogy of the reasoning process of physics as utilized by the natural sciences. The objective is, by introducing the application of physics to economics it enables a superior process to determine how to change the current economic position to an improved changed future economic position by more clearly defining what cause manifests to a specific result as an effect resulting from the cause.

In physics, a joule is a measure of energy. A joule is a complex unit of measurement of the effect of energy upon mass, distance and time. The present subject matter is the process of going from the current economic thinking in social science to a natural science physics view of economics. In physics the origin of economics is energy and the effect is a result enabling wealth to occur.

### Introduction—New

From approximately 2006 to 2014, the global markets share as measured by the “Gross Domestic Product” or “GDP” of the USA has declined from a 25% share to a 19% share. Worse, in the 1950's the market share of the USA was 40%. In the 1950s the USA produced 90% of all automobiles in the world, now it only produces 5%. America's ship production is gone, the steel production is at 1940s levels, almost no clothing is domestically produced, electronics are mostly foreign and to launch a US satellite, assistance is needed to have the Russian's do it because apparently the US is now unable. There has been a long decline since 1971 (the end of the gold standard) and in the first decade of the 21^{st} century a more rapid fall off which began in 2007. A 19% market share is not a super power. The evidence and observation is the USA is incapable of applying enough pressure to suppress volatile regions into stability, or be a manufacturing leader: America is a non-super power. How many goods in American stores are made is the USA? The answer is almost none.

In complete contrast to what is observably the fact of the loss of American relative global economic strength is the physical superiority of American domestic natural resources. Based upon the combined natural wealth the comingling of resources such as arable land, water, water higher than sea level, river, precipitation, forests, access to the ocean, internal natural navigable rivers, a mild climate and oil, coal, gas plus other energies, the USA is far more wealthy than the GDP measurement implies. Additionally, given these resource advantages, the USA is in a position to consortium its way to a majority position, a 50% plus global market share simply due to its combined resource position. It is not just a single resource; it is the mixture of agriculture, metals, energy, climate, water, mixed just right by the natural order which gives the USA an absolute advantage. American products should be the best and cheapest.

For the USA to be out produced is 100% the fault of domestic policy. The value of America is being mismanaged.

An objective of the present subject matter is to explain how to increase the wealth of the USA by 200% or take the current GDP multiplied by three in a period of time of eight years. A two hundred percent growth rate is equal to the best year of the 1950's, which means it is possible. A 200% change in wealth in eight years is approximately a 14.7% annualized growth rate. The long-term historical growth of the USA has been in the 6-7% range. China has grown 12.8% per year from 2000 to 2005. The objective is to outgrow China by (14.7-12.8) 1.9% versus their strongest period of growth. True, the circumstances are different, but the first question is can it be possible for the USA to grow as fast or faster than China? China only has a small fraction of America's resources and American has one-third the population. In the laws of physics it is certainly possible because the USA has superior resources and fewer people. A 14.7% American growth rate in eight years is the objective and it is possible under the principles of natural law.

The obstacle is less from the natural order of the physical world and more from a limitation of the current established social science methods, the field of economics as of body of study which is based on methods which are not principles of truth. Presently economics is defined in the domain of the social sciences, and under weighted in the natural science. A purpose of the present subject matter is to propose more of a natural science solution to economic growth as opposed to using social science.

Social science as an academic field of study developed out of the age of industrialization as nation states began to take a more political approach to quantifying their observations of society. Natural science unlike social science was the predominant process of using mathematics to solve problems of western civilization until the 1970's. The communist Soviet Union began a formalization of social science in 1917. Social science uses statistical averages and draws conclusions. This method does not use principles of truth or observable facts. Theories in social science can easily draw opposite conclusions from the same data. Social science in the Middle East encompasses a heavy application of religious authority as creating what is best, communism uses social science to prove oppression is best, the business oriented west has allowed free markets concluding that method is best.

The age of enlightenment began with the renaissance period of the 14^{th} century as the dark age ended. Natural science was the dominant method of science until the 1970's. However, the definition of economics as a social science became more popular in the 1920's.

The institutional presence of social science increased during the post World War II period. The USA in 1996 established (BSSR), “Behavioral Social Science Research”, instituted by order of Congress. The English have a social science institution and the old USSR published theories based on social sciences from the USSR's academy of science beginning in 1917.

China established the (CASS), “Chinese Academy of Social Science”, in 1977. Vietnam established the (VASS), “Vietnam Academy of Social Science”, in 1953, the Catholic church established the (PASS), Pontifical Academy of Social Science”, in 1994 and there is the (ISSA), “Indian Academy of Social Science” established in 1974. Levin established the Russian Social Science organization the first year of the Russian Revolution in 1918. These academies are using social science methods of reasoning, which is not a principle observation, not based on truths, and does not have a beginning point or an ending point. Social Science theories or proposals are in contradiction to observation, yet persist in spite of facts to the contrary. Natural science specifically conforms to the natural science world, observed behavior and established principles of truth. A common definition of economics in the USA's social science method of reasoning is the distribution of goods are from scarce resources. This is solidly a non-natural (physical law) science as the definition is clearly absent of natural law concepts, or at least under weighted by natural science. As late as 1970 only the natural sciences were regarded as a true science according to the American Dictionary (1969). The general definition of science has been broadened to include fields of study in both social sciences and natural science with similar sounding titles but with close to opposite methodologies.

The definition of natural science is a branch of knowledge or study dealing with a body of facts or truths systematically arranged and showing the operation of general laws, the mathematical science. A systematic knowledge of the physical world is gained through observation and experimentation. Knowledge of facts or principles is gained by systematic study of any branch of natural science or physical science.

As so much of economic occurrences are not simply social science, but are actual physical events such as iron ore being mined against the force of gravity, shipped distance, in time, melted with temperature from energy it seems a greater grasp of economics as field of study can be improved by adding physical science to the field of economics and applying definitions in economics constrained by the theories and mathematics of physics. Physical laws have a high degree of problem solving capability as their specific methodology is to solve problems and if such laws were applied to economics they could be used to more clearly establish the cause and effect of generating great wealth for the betterment of humanity, (the betterment means to be more wealthy than previously).

An objective of the present subject matter is to increase the wealth of the USA by 200% in eight years as a proposed process based more on mechanical physics rather than the current social science view. The process is to first redefine economics along with the subsequent categories of economics such as wealth, trade, debt, cost of capital, capital, unearned currency in circulation (printing money in excess of the underlying value of production), the expected return on assets as a national aggregate (GDP) and concepts which are the catalyst for economic change into an analogy using the principles of physics.

These principles of science differ between various scientific methods; different fields of study use different methods. Social Science uses methods of statistics, historic data, which are non-forward looking. A negative (−25) can be made positive by squaring it (−25)² then un-squaring it by using the square root=+25. Social Science uses averages; squared, un-squared, divided, multiplied where averages upon averages upon averages are manipulated. Social Sciences will know the average income of society, but social science can not understand scientifically how to increase the average income. Natural science also uses statistical methods, but as an attempt to establish a fact to purposefully look forward to an expected effect from a defined cause. Natural Science can look forward by design of its methods. Looking forward is useful when seeking a solution.

Physics is science that deals with the structure of matter (stuff) and the interactions between the fundamental constituents of the observable universe. “Physics is field of study of matter, force, energy, space (distance), and time understood in physical theory” (American Heritage).

Mechanical physics is a science of energy, force, mass moving, distance, and time. There are other fields of physics, thermal dynamics, nuclear, electrical, however the present subject matter is focused on the mechanical analogy of physics and how economics can be interpreted in the principle concepts and mathematical constraints of energy, force, distance, and time. These methods have a purposeful use in physical science to obtain answers and are the construct of the mechanical age.

Modern finance is both a method to count and a method to manage assets and is heavily reliant upon social science methods. Finance uses statistics, but not physics. It is difficult for the methodologies of finance to answer questions of cause and effect just as it is difficult for social science to determine cause and effect. Finance typically extrapolates the past events as a reason to expect similar results will occur into the future. This is not unreasonable, but these methods of statistics, the squaring and un-squaring of average upon average can not obtain an origin cause and resultant effect as physical science might. Finance is based more on a social form of reasoning than a natural physical principle based cause and effect.

Natural science, physics, mechanics, is a form of mathematics, methods, principles derived from observation and experiments repeated over and over to understand the physical world. Its language is mathematics in principle, in concept, and in its reasoning. Not every concept is formula, but the basis of a determination must conform to observation, exact observations are not always possible, so similar circumstances are used in experiments and measured. Natural science measures in specific types of measurements to derive conclusions. Reasoning is constrained into accuracy by principles of truth bound by consistent measurement methods which must reflect observation. Something counter to an observation, no matter how badly the desire for it to be so, is not true. Social science is not constrained in this manner from observations when the USSR, China, England, the USA all believe equally (from the opinion of the institution producing the finding) their respective societies are all equally wonderful. From observation this is not true. Conversely natural science (not social science) in the USSR (their dam produces x kilowatts) is exactly the same as in American as an American dam producing x kilowatts based upon what force enables the generation of electricity is exactly equal in both countries. The mass flow rate in a hydroelectric dam is physical law and is the same everywhere on earth because gravity is the same globally as it is the globe which generates the force of gravity and natural science measures the force in a quantity with distance, time, magnitude, and direction.

Interpreting the field of study of economics in the form of natural science narrowed more toward using a mechanical physics methodology with principles as the process used to determine the generation of wealth has the capacity to solve problems, particularly economic problems. The present subject matter is a rethink of economics diverting away from a social science view and moving toward a physics view to a physical science analogy as a methodology of reasoning.

Economics as a concept can be interpreted in the methods of physics redefining economics, wealth, debt, cost of capital, energy, force, trade, money printing, the expected national aggregate rate of return and related economic concepts to a redefinition in an analogy of natural science.

For the economy to change means in physics (as an analogy to the reasoning process) a change in position of mass or economic system (the object of study) from its natural position over distance, in time resulting in a change in value where there is an assumption of direction. To change the position of mass requires the ability of energy by the conduit of force to move mass, put mass into motion, where the mass moves distance, taking some amount of time, eventually going someplace. Energy, force, distance, and time; physics, is what happens in daily economic events.

Iron ore is moved out of the ground against the force of gravity moved distance in time, shipped against the force of gravity, overcoming friction, a span or a length of distance, taking time. Then inevitably the mass is being accelerated if the objective is to cause an increase where acceleration is the change in velocity, where velocity has direction, where velocity is distance divided by time (d/t), the velocity changes from its initial velocity to a faster velocity (assuming betterment) divided by time to measure the change in velocity by a change in time. Time is the measure of rate. Fifty miles per hour is 50 miles divided by time in hours; 50 mi./time in hours, mi/time, distance/time, d/t. To make the USA more wealthy means, “more”, is a change in velocity, which has direction and is a rate in time. To increase the GDP is to change the velocity of the GDP. To change it in eight years is to change it in time. What will enable the GDP to change? Assuming the change has a positive direction then only with energy using force as a conduit can the economy be accelerated. Simply making it accelerate does not guarantee greater wealth as wealth is an additional concept. However, to make the USA 200% more wealthy in eight years will make acceleration necessary in a practical sense. Acceleration can be in the form of more efficiency or more force: likely both.

Energy, force, mass, distance, time, and acceleration are measured as both quantity and units. Stoichiometry means using units to solve the quantity, something finance neglects to do. Two plus two is four. The units are two what plus two what? Two apples plus two apples is four apples, but two apples plus two cars is not four of anything. The typically used units for quantity in physics are kilograms (Kg) of mass, mass is the quantity and kilogram is the unit, distance is in meters (m), and time is in seconds (s). Kg, m, s (kilogram, meters, seconds) are standard units of measurement. Then the iron ore is Kg of ore, moving meters in distance in seconds of time against the quantity of gravity in meters divided by seconds squared. As the units are consistent then solutions can be determined.

How much energy is necessary to move so many kilograms of iron ore over so much distance, in so much time is answerable in physical science. What does it take to move ore further and faster is also answerable in natural laws, but not determinable in the concept of social science or finance.

It is not always possible to have the same units on both sides of the equation so proportionalities (α) can be used when units on the left side do not match the right side.

In summary, the natural science field of study, narrowed to physics using principles, concepts, reasoning based mathematics can also be used to interpret the body of knowledge of economics as a field of study. The answers are going to be different as the methods are different.

The following questions in the redefined natural science analogy point of interpretation are examples of how the answers may differ. The social science answers and the natural science interpretation of these may be in disagreement.

Does printing money cause the USA to become more wealthy or better off?

Does printing money cause the individual average wage earner to become more wealthy or better off?

Does printing food stamps make the USA more, less, or the same degree of wealthy?

Does the government printing money and using the printed money to buy goods from the people increase, decrease or keep the same level of wealth in the USA?

Does inflation make the USA more, less, or the same degree of wealthy?

Does government debt in the form of treasury bonds make the USA more, less, or the same degree of wealthy?

Does taxation make the USA more, less, or the same degree of wealthy?

Does the money spent on unemployment make the USA more, less, or the same degree of wealthy?

If everyone were employed and as a result there was zero cost to unemployment would the USA be more, less, or the same degree of wealthy?

Does leverage (government borrowing) make the USA more, less, or the same degree of wealthy?

Does moving assets from “A” to “B” make the USA in the name of the “greater good” more, less, or the same degree of wealthy?

Does the IMF (International Monetary Fund) make the USA more, less, or the same degree of wealthy?

What exactly is a job?

What is the cause of jobs?

What causes commodity prices to move up and down to the degree which occurs at present?

What causes the stock market prices to change 50%?

Can any subsidy, in any form, for any reason make the USA more or less wealthy?

Does recalibrating an inch alter actual distance?

Does speed change chance?

Does increasing minimum wage either increase the wealth of the individual being paid the minimum wage or decrease the aggregate wealth of the nation?

Can the economy be stimulated by artificially low interest rates?

What exactly does increase in the economy mean?

Can government spending change wealth?

What is the cost of government?

The reader should also be able to differentiate between the physics view of economics vs. the present linguistic belief vision of economics as interpreted by the social science method of reasoning.

### IV—Three Favorite Graphs—To See

Certain analogies or examples can be referenced to explain how the physical world is the basis for economics: first, energy compared to the GDP of the 20 richest countries, secondly how H₂O (water) changes temperature when the amount of energy in the form of heat changes, and thirdly perturbation, where when something is introduced as a cause where the effect, which must eventually happen is delayed, however, there is a non-linear distance over time response, seemingly no change at first then eventually an overwhelming response in the form of a rapid change. These examples are observations. To understand the observation, the interpretation must be put into a useable form of knowledge or a methodology. The knowledge must be retrievable and when reapplied to either exacting or similar circumstance or compared to similar other observation which have some commonality where observation “A” is only similar to observation “B”, there still needs to be some type of useable answer derived. Knowledge obtained via observations which are repeatable over and over, observed over and over, are the data inputs which create laws of what physical behavior actually means. Not legal laws, but rather laws of natural science constructed into a standardized mathematical form or concept, which can be used and understood to solve problems.

The first example is an observation of the importance of energy by plotting the GDP of the twenty richest countries in the world with their kilowatts produced.

This is the foundation of the observation where energy as measured physically formulates it is the basis where wealth is proportional to the generation of energy.

This example is saying the GDP (a measure of wealth) has something to do with electrical generation. The energy is doing something and energy has a place in the understanding of natural science as the origin of the cause. In the time order of cause and effect the cause comes first and the effect second. The kilowatts generated do something. The observation is gross domestic product increases as kilowatts generated increase. The same for fuel burned. Again, in natural science energy comes first and the effect is a result of the cause. As GDP is greater than fuel burned is also greater where the observation is fuel burned is causing greater economic activity.

The next example depicts how change occurs due to a change in energy. As heat energy increases ice does not at first change temperature. Energy as heat is going into the ice, but the measure of temperature is slow to change even though the heat is increasing. There must be some other use for the energy to explain the lack of change in temperature of the ice. The reason for the lack of temperature changes is that the energy is being used to break the ice crystals down and therefore there is not enough energy left to change the temperature. Eventually the H₂O is no longer a solid and the applied energy in the form of heat increases then changes the temperature of the liquid because the molecules increase movement, and increased movement increases temperature. As the water heats to the point of becoming a gas the change of state from liquid to gas occurs and this change in state also consumes energy where the energy is used to alter the state rather than increase the temperature. There is less change of temperature as water changes to gaseous state because there is less energy available to alter temperature because the energy is required to alter the state of the liquid to another state.

For something to be worked on, for anything to be done, no matter what it is, to do anything is to use energy. Every cause originates as the application of energy.

There is not any way to hide from the fact to effect a change there must be an application of energy. Once this is understood it becomes more clear how inefficient policy which does something other than producing wealth wastes energy and therefore must be a waste of wealth or reduce wealth generation. Energy input spent upon non-wealth generation is energy wasted.

An objective of the present subject matter is to increase the wealth of the USA. In natural science how to increase wealth will be related to the concept of energy.

The third example is that of a typical perturbation, a ratio of response to time. It appears there is not an equilibrium forming where some input is not causing an effect. Equilibrium is a law of physics and it says, as a theory, force in must balance with force out, but the perturbation is showing no initial effect related to the input. However, eventually, in time the effect happens all at once as a dramatic effect. The time interval observed may fool the observer as a non-changing environment is occurring where there should be some evidence of change. The time interval is too short. As time increases the effect occurs, as it must in the laws of physics. It may take some time for cause and effect to occur. However, determining the correct definition of a cause is necessary to succeed in having the desired effect occur. A cause can only be derived from energy. Without the input in the time order of physics as energy first then there can not be an expected effect.

These examples are observations of energy causing an effect. This is the natural science cause and effect derived from the principle and laws. Economics must therefore follow these principles to a significant proportionality.

### V—Measurement

An objective of the present subject matter is to change the wealth of the USA from its current position to a new position, with a direction of an increase (forward) in a specific amount of time. The various current definitions of economics, of wealth, capital, the cost of capital are linguistically descriptive, non-mathematical, non-scientific, typically non-quantitative, (amount), not measures (how much) are not necessarily concepts, and are not in units which enable a process to determine answers as to why do events occur. The current basic definitions of economics are not measurement definitions. An objective to increase the wealth of the USA by 200% in eight years can not be addressed by descriptive statements. Attempting solutions by some method of manipulating descriptive phrases is independent of practical. Adding to the problem, the current linguistic phraseology is particularly antithetical to the reasoning process of physics. There are not any measurement capabilities in the current economic definitions. Social science the current method of thinking does not possess a clear process of cause and effect or apply a process of measurement.

To increase the GDP of the USA 200% in eight years is to do something where the something is measured. All that exists can be measured in some form as a magnitude, quantity, with direction, as a basic unit, or a complex unit, (a set of other measures together to form a complex unit). Measures can be a single number or complex concepts. Physics is a reasoning process which is a mathematically based method using well defined various measures.

Currently there are many descriptive phrases linguistically labeling economic concepts with words which do not relate to either measurements, units or follow any scientific reasoning. The current descriptive word phrases are not in mathematical form or in the scientific method of physics. Mechanical physics, a field of study within the broader scope of physics describes the natural world in scalars, single measures, magnitude (how much), both with and without direction as speed or vector, a measurement with both magnitude and direction in quantities, units, quantities, and complex units made up of multiple units. Time is a quantity and seconds is a unit. Distance is a quantity and a meter is a unit of distance. The phrase, a person went distance, is not very useful. Saying distance in time is speed, d/t, as in 50 miles per hour is better, but there is not any direction. The 50 miles is the magnitude, but without direction it is a scalar. Going 50 miles per hour south at 180 degrees is a velocity, and it is a vector. It tells magnitude and direction which makes it a vector. To become more wealthy is a direction, where more means a magnitude.

Economics must be written in a form where there is both magnitude and direction making the assumption free people are spontaneously moving toward betterment. Improvement in the human condition through history is an observation. Economics is a vector, with magnitude, direction, in units, which describe quantities, and where some definitions are complex units made of multiple units. Mass is a quantity with a SI unit of kilograms with a symbol of Kg. Time and distance have units of seconds and meters where the SI units of mechanical physics are Kilograms, seconds and meters or Kg, m, and s. Then economics should be defined in SI units of Kg, m, s as the units of quantity of mass, distance and time and can be proportional where the units are different. A complex economic concept should be written as a complex unit in physics. A unit can be other measures such as feet, yards, inches, however the SI units of kilograms, meters and seconds are easier to work with and are prevalent in scientific communication. Along with SI units are complex units of Newtons, Joules, and Watts which are made up of multiple units and are vectors. Economies, to be interpreted in mechanical physics should also be defined in Newtons, Joules, and Watts where a Joules and Watts are derived from a Newton.

If the progression of humanity, where progression is a vector of betterment, was plotted on a growth curve, the point of inflection, where the growth begins to increase more so than previous periods in history would be the point of Isaac Newton's life. Newton changed the world, specifically his laws of motion enabled the machine age.

Physics, Greek for the, “natural order”, is a human activity of mathematical based reasoning of principles and laws to form a process, with specific types of measurement to answer questions of how the universe operates. Two thousand years prior to Newton, the Greeks saw motion as a single event. The arrow flew then slowed because they believed the force pushing the arrow dissipated over distance and time. Galileo in 1560's made progress in understanding motion concluding motion is from multiple forces. It was Newton who was able to further define the behavior of motion into his three laws of motion where the second law is the formula for force accelerating mass from multiple forces a summation of force. Newton said the arrow flying will continue to fly unless acted upon by opposite (counter) forces. Making the force which moves mass to acceleration being actually a summation of multiple forces where the net of the multiple forces is a summation that is the cause from something which accelerates mass or the object of study. Newton's second law of motion is the summation of force equals mass multiplied by acceleration, written as: Σf=ma. The summation of force is (Σf) a net force derived from force push being subtracted by counterforce and also reduced by force drag, where force push−(counter force+force drag)=force net, written as Σf. It is the Σf which causes the acceleration of mass or stuff to move faster than it was previously moving. There is a cause and effect and they are not reversible in practicality. Then a Newton is force push−force drag=mass multiplied by acceleration. Mass is just a scalar of a quantity view alone but mass being accelerated is a vector because the force net is accelerating the mass in a direction. The unit for mass is typically written as a kilogram with a symbol of Kg.

Acceleration is complex. Speed as a scalar (a quantity with magnitude without direction) and is distance divided by time, d/t. The units of distance and time are meters and seconds. Speed in units is meters/seconds or m/s. Speed does not have a direction making it a scalar. Velocity, a concept and how to calculate it, is in the same quantity and units divided as speed, but with direction (and can be written with an arrow v). Velocity is m/s with direction. To accelerate is to change the velocity where acceleration is the final velocity minus the initial velocity divided by the final time minus the initial time which is the change in velocity/change in time (Δv/Δt). It is the Σf which changes the mass's velocity by making the mass go faster measured in a change in distance as a rate of time. A rate of time is to divide by time.

Velocity final−velocity initial/the change in t is Δv/Δt. In units it is m/s² (meters/seconds²). The seconds are squared because velocity is m/s then m/s is divided by seconds again or m/s/s=m/s². A Newton is mass multiplied by acceleration, calculated in units is Σf=Kg(m/s²).

Acceleration is essential to understand as to pursue the objective to make the USA more wealthy is to accelerate the aggregate domestic wealth of the USA where the production and resultant gains are owned by a free people. It means velocity of the USA is going to be changed and changed in a way Newton said it would change.

Newton's seconds law is written as Σf=ma, which means force push−counter forces−force drag=mass multiplied by acceleration.

In units it is Σf=Kg m/s², the summation of force equals kilograms multiplied by meters divided by seconds squared the seconds are squared to note acceleration. This equation does not go backwards. Kilograms just sit in natural position or current position as the current position could already be in motion and the Kg will not be accelerated or have its motion or position changed until force is applied, better to say net force is applied when the net force is force push−counter forces−force drag is the net force or summation of force (Σf). The amount of kilograms of mass does not change when accelerated but the behavior of the kilogram of mass are altered by being forced to go faster. The cannon ball does not change size when shot, but the ball goes faster from being fired out.

Then a Newton is a complex unit of the summation of force which is a vector because it has multiple measures, magnitude and direction as a Newton in units is calculated as Kg (m/s²) or a Newton is (ma) or (mass multiplied by acceleration) can also be written as (m(Δv/Δt). A premise of the present subject matter and an analogy of physics to economics is the change in position of mass. In economics, this is the change in an economy (or the economic system of ownership entities) from its natural position over distance as Newton's 2^{nd} law explained. The mass or the system is not going to change position unless made to do so by a net force. Thinking in the physics view means using the reasoning of physics to understand economics as measurements in quantities, units and complex units where force push, counter force, force drag, kilogram, meters, and seconds are the concepts to apply to derive solutions.

James Joule is honored by having the complex unit to measure energy, a unit of energy, being named a “Joule”. A joule is a complex unit of the effect of energy, as there are multiple units within the unit. A joule is a Newton multiplied by distance or a Newton meter.

A Joule in units is (kilograms multiplied by meters divided by seconds again multiplied by meters) or J=Kg m/s² (m) or J=Kg(m²/s²). A Joule clarifies how far the accelerated object of study went. For example, it takes so many Joules of energy to push so many kilograms a thousand meters. Since there is direction the unit of a Joule is a vector.

A Watt, named after James Watt, is a Joule as a rate. A Watt=Joule/time. In units a Watt=Kg(m²/s²)/t=Kg(m²/t³). It means how much energy in units of Joules are being used in time. A Watt is a complex unit of the rate of energy used.

Kinetic energy is energy from motion which is the average (½) of energy from mass being accelerated in time in distance. KE in units is % Kg(m²/s²) or KE=½ Joule, or KE=½ mv² as a quantity.

Einstein wrote E=MC² which is in units of E=Kg (meters travelled in one second of light/second)² and there is not any ½ because the speed of light is not an average. E=MC² is not part of the present subject matter, but is assumed some events common to everyday life are speed of light events, such as electricity.

A Newton, Joule, and Watt are complex units of force, energy and rate of energy usage, written in units are:

The mass, distance and time are quantities and the units of the quantities are mass in kilograms (kg), distance in meters (m) and time in seconds(s), then units are kilograms (kg), meters (m) and seconds (s). More specifically:

Newton=Kg(m/s²)=Force to move a kilogram one meter in a second per second;

Joule=Kg(m²/s²)=Measure of energy to move a Newton one meter of distance;

Watt=Kg(m²/s³) A joule per second;

Then economics should be written in this same method as economics is the proportional change in position of the economy in distance taking time to do so and the assumption is free people will have direction toward betterment. Economics in the analogy of the reasoning process of physics enables a cause and effect process to analyze to obtain a desired outcome.

The question of increasing wealth in economics is to derive an answer to this problem by the application of methods which are scientific methods to determine a solution within the constraints of how the natural world operates. Theories which can not meet the test of conforming to the constraints of the natural world are likely incorrect.

A tractor is made of iron ore measured in units of kilograms with a unit symbol of Kg. Then it is possible to understand in physics how much iron to mine, against the force gravity, how much energy it takes to ship the iron distance in units of meters, how fast in time in units of seconds it takes, measured in energy, in complex units of joules, and know the answer.

To make a tractor better and faster than the global competition can produce, is a question of force push—counterforces—force drag moving Kg of stuff meters in so many seconds. To make the USA more wealthy is a problem of force push—force drag moving Kg to acceleration meters in so many seconds. This is an analogy of the methods of physics which can be used to interpret economics.

There are a variety of linguistic definitions based on social (not natural) science concocted from principleless methods which incorrectly describe economics, which is part of the impediment to finding solutions, and one such common definition is based on the non-mathematical method where social science defining economics means: “a social science multiplied by goods distributed/scarce resources”.

This is a linguistic phrase, none of it measurable, it is neither scalar nor vector and there is no distance or time. Perhaps goods are a scalar, but “goods distributed” is a non-measurable phrase. Social Science is also not measurable. Social Science is the study of human behavior. There is little behavior in gravity or friction which is not physical science. How much of economics is human behavior? To have economic events mass must be moved against the force of gravity and against the force needed to overcome friction as well as other counter forces. The mass, iron ore for metal products, stone, sand, food, are all mass moved, moved distance in time. It takes energy to move and process the mass into useable form. A worker is working, then sleeps, eats, works, rests, and is obligated to spend a little time in socialization: there is not much time remaining between work and rest. There is very little social science in the economy of free people as people will act in a direction of betterment naturally and most time is spent working for betterment. Free people obtain betterment by generating energy, applying it as a force, when the force overcomes the counterforces, then the net force moves the mass distance in time and wealth results. A significant proportion of economics is net force moving mass distance in time.

Scarcity is the most unique part of the social science descriptive definition because there is no scarcity in the natural world. There is no scarcity of the sun light, at least in reference to the sun. The sun is just magnitude. Scarcity is more likely in the definition to create an emotional response to serve a political end for a social control seeker, control not likely used to further the interest of a free people as a non-mathematical, non-scientific definition can not possibly be used to generate the betterment of humanity. There is no scarcity of iron ore, there is just, “x”, amount of iron ore on earth.

As an objective of the present subject matter is to make the USA more wealthy, assuming a direction of the natural spontaneous desire for betterment of humanity, then the definition of economics is not to create an emotional response to fool or manipulate, but to rather be based in natural science (physics), subject to observation, criticism, and experimentation as natural science should be.

Economics based upon the premise of the present subject matter is the movement of mass, the object of study which is an economic system of ownership entities, multiplied by a change in velocity divided by a change in time. To change the economy assuming with direction (vector) for betterment is to move the economy by accelerating it from its present velocity to a changed velocity in a change of time. The velocity is changed by the origin which is energy to apply force as force push where the force push is counteracted upon by counter forces and counteracted up on by natural force drag from the force of gravity and the force of friction. This means the summation of forces, or force net must be sufficient to accelerate the economy of free people who own production as ownership entities. It is the free people who own which is being accelerated, which means to change the initial position of the free people to a new position where the new position possesses more wealth. This can only be accomplished when force net the summation of force written as (Σf) increases, or the counter forces to force push decrease or both.

### VI—Energy—the Origin of the Cause

A hypothesis of the present subject matter is economics in concept and practice is more usefully interpreted as a natural science based upon the principles of the reasoning process of physics as opposed to a social science, or descriptive linguistics in non-mathematical form stated in definitions absent of the capacity to process a cause and effect determination. Social science has no units of measure, and no beginning point or ending point. Social science definition can not be used to calculate an input which results in an expected output.

By using the analogy of the methods of physics applied to economics which establishes boundaries and constraints of what is observably consistent it elevates the practicality of a process of expected causation resulting in a related effect. A premise of the present subject matter is economics occurs due to the change in position of the object of study, over distance, in time. Physics is measured in units, has a beginning point and ending point where the cause allowed the movement from the starting point to the ending point to occur.

In physics mass, or the object, or the object under study, is moved by energy. The necessary truth of the natural world, is to do something, the ability to do work, in mechanical physics, is a result from the application of energy as an applied force. The analogy of mechanical physics applied to economics is the ability for an economy to do work, is a result of the availability of energy. This is observable where energy generated is highly proportional to national wealth measured in GDP, (it is recognized GDP is a problematic measure).

Physics is a set of principles and laws in a scientific process which is a determination of how the natural world operates. The methods of physics can also be carried to the concept of economics. This means economics is a result, of the application of energy. Energy applied to economics is the physics definition of energy as opposed to the everyday descriptive term for energy.

There needs to be some additional clarity of how to explain the concept of energy; because definitions of energy are generally uncommon in everyday usage. Energy is typically thought of as oil or gas. The concept of energy in physics is different than the everyday usage of the term. Energy defined in physics as the ability to do work, it is the capacity of a system to change position, to change speed, to change its state (gas to liquid, to solid, to heat), to change form, to change from its surroundings and move to a new position in new surroundings and change relative to time. Energy is the property of a system which is a quantity and has magnitude. Big mass takes more energy to move versus smaller mass. This is important as the USA is a big economy; therefore it takes big energy to move it. The USA is not Sweden. Energy can be in multiple forms and is necessary to move mass as mass is something which resists. The purpose of this aspect of the present subject matter is to clarify how energy is generally understood in the view of physics and how the analogy of energy in physics is applicable to the cause and effects of economics. To improve the economy of the USA the role of energy is essential.

Energy is not stuff, but stuff can have energy in it. Energy can neither be created nor destroyed. The universe is made up of energy and the energy can not be used up. Then this follows that energy is conserved. Not the conserved in everyday use when conserved means using less; conserved in physics means energy can not be destroyed therefore when used it changes form to another form, but does not end or disappear. Often the changed form is not practically useful. Regardless, the energy used does not go to nothing it changes form. The energy of a moving car is conserved to heat in the brakes as the car slows. There is potential energy (stored energy), kinetic energy (energy in motion), chemical, electrical nuclear, height, solar, etc. The sum of all energies in the universe is unchangeable. The, work out equals the energy in, principle in physics is also a real physical occurrence in economics and the principle of the change in work=the change in energy is a practical analogy to economics. Kinetic energy is the average of mass moved multiplied by velocity squared. Average is %, mass is “m”, and velocity squared is v² where KE=½ mv². Then net work is KE_{final}−KEᵢₙᵢₜᵢₐₗ. The kinetic energy used did work. The work can not occur without the energy being applied. The change in energy equals the change in work as this is a law of physics.

To speak of employment without understanding the role of energy can not lead to a useful solution. Production is an effect of energy, anything in motion is derived via energy. The automobile, mining, farming, melting, shopping, occur essentially due to the source of energy. Without energy then there is not motion, other than what is naturally occurring. Energy consumed is energy changing form from one type of energy to another where kinetic energy+potential energy+stored energy=conserved energy. The analogy in economics is the energy of electricity generated (not created as energy can not be created as it is always there) also changes form from kinetic energy to stored energy, from production to stored wealth; where wealth is a form of energy. Then the economic process is the conservation of energy. Energy is the capacity to do work, the economy is the capacity to do work and wealth is the capacity to consume. What alters the path of the capacity to do work? Energy is applied by the conduit of force push and force push is obstructed by counter forces and force drag, which then results in force net as the summation of force Σf. Then the Σf enables production and production is a form of energy (KE) and wealth resulting from production is a form of stored energy (SE). Wealth is energy out. Energy out can only exist from the cause of energy in: as energy in=energy out.

The objective to make the USA more wealthy is a change in energy in, or a lessening of the counter forces which results in energy out. Everything must balance in the natural world (a law of physics) and economics is very much of the natural world. It is quite impossible to have zero energy in yet expect energy out. It is equally impossible to have zero change in energy and expect a change in work. Mass is accelerated by force where Σf=ma. This does not work backwards; acceleration can not make, cause, or generate force. This means to effect the economy the answer lies within the summation of force. An artificial input in physics is the same as zero energy in. Mass can not be accelerated or be maintained in motion via an artificial input as an artificial input is in natural science, “nothing”. In science, “nothing”, in will equal, “nothing”, out less the force of gravity less the force necessary to overcome friction. Then zero in actually causes a loss in natural science and this analogy is proposed as the same occurs in economics as it does the laws of physics.

Kinetic energy in units is KE=½ Kg m²/s², energy is measured as a complex unit of a joule which is J=Kg m²/s². It means to move the kilogram distance in meters in time is an effect by energy using force as a conduit (to touch) where force push−less the counter forces plus force drag is the force net which is the summation of force (Σf) where Σf=ma. To understand economics as a natural science enables the understanding of the causation and the resulting effect. The change in the cause will result in a change in the effect. Then in physics to change the economy requires a cause, where the cause has an origin of energy when the summation of force must be greater than zero (Σf>0), or nothing can change.

### VII—Re-Defining Economics in Natural Science

The current definition of economics is based on a field of study from the social sciences. The study of human behavior using statistical averages, but not based on principles of truths. Social science applies to human behavior, human interaction, psycho (mental), psychology (ology—to study), political science, using statistical averages and history. The social scientific methods are observations of situations creating data which is averaged, assumptions are made, then the averages are manipulated to guess toward a conclusion. Social science is the study of people, relationship with each other, groups, motives, values, studied with scientific methods, but there are not any laws or principles. There is room in the social science methodology for broad interpretation. Interpretations which are in conflict with the reasoning of the natural science field of study. As social science is of the self and natural science is independent of people.

Natural science is a branch of knowledge or study dealing with a set of facts or truths, in a system with first principles arranged and showing the operation of general laws, the mathematical science, as a field of study, “collings English” and physics as a branch of the natural science field is the study of energy, force, time, space (distance) and motion. Physics concepts are in complex mathematical formulas, values are in quantities and measured in standardized units. Physics is a reasoning process, using mathematics based upon principles derived from observation and experimentation to understand how the natural universe behaves and operates. Physics should apply universally regardless of the political system which applies its principles. A peasant under a king, a comrade under a dictator, those subject to religious or atheist rule, and free capitalists should use the exact same principles of physics to shoot a rocket, build a farm tractor, or mine for minerals. However, socially life would be extremely different as a serf versus a middle class American. But social science is incapable of clearly differentiating between the desirability of being free or heavily subjugated. Conversely, physics thrives on freedom.

A social science conclusion can vary from society to society. Vladimir Lenin started the Soviet Union Academy of Social Science in 1918, within the first 24 months of the Russian Revolution. Vietnam established the Vietnam Academy of Social Science (VASS) in 1953, the Chinese have the CASS (Chinese Academy of Social Science)(1977), Cuba has an academy of social science, as does the Muslim faith. Bill Clinton started the BSSR, (Behavioral and Social Science Research) in 1996 which apparently is different than the Russian, or Chinese, or Cuban Academies. Studying behavior has its place in economics. However, the social science method is not a natural science where the constraints of proof in natural law must conform to the observation of the natural universe in a mathematical form. Physics must be followed to follow natural law. Not so in social science, one social science conclusion can be radically different from then another social science conclusion: this method allows inconsistent conclusion as its norm.

It seems rational to view economics at least partially or perhaps significantly as the majority method, based on the field of natural science and particularly within the field of physics. Iron as a quantity is measured in units of kilograms which can only be mined, shipped and melted by energy moving distance in time. To make more cars or make them cheaper is a kilogram, distance and time problem.

Currently, economics is defined by the methods of social science as “a social science for the distribution of goods/scarce resources”. If this definition (a social science multiplied by distributed goods divided by scarce resources) were put into a formula it could not be calculated. What are goods/scare resource multiplied by 5 equal to? A number multiplied by scarcity is nothing. There is not any useful meaning derived.

It is not clear what this means. The social science methodology is a loose set of observations in a variety of averages, standard deviation, and grouping of averages written in non-mathematics. There is little cause and effect methodology. Specifically, what is a “good” (merchandise) and how did it come into existence is not made clear either. What caused, the “good” (merchandise), and what effects are there upon the “good”. What if there were not any goods, what about newly invented goods, what if no goods were invented, how much does a good weigh, was the good imported or made domestically, and so on.

More concerning is the term, “scarcity”. Scarcity is a very non-natural science thought or belief. There is not a scarcity concept in natural science or mathematics: it is a judgment. The North and South Poles are not scarcity of sunlight. The sun's energy can not be scarce; it just is in, “x”, amount of energy. By saying there is not any scarcity in physics, it means there is not any method to calculate scarcity. Scarcity is non-mathematical, as in 2 multiplied by scarcity is nothing, or 2 divided by scarcity is nothing and the square root of scarcity is nothing. It is impossible to change with clarity that which can not be in a mathematical form as a principle or a similar concept. Economics can not be defined in social science terms and avail itself to the implementation of practical solutions. The solutions to improving the economic conditions are most plausibly found in modern principles, laws and concepts of physics.

Historically, the Greeks, 2000 years ago, incorrectly interpreted natural law in motion as a dissipation of force. This view, although when observed looks plausible; is not Newton's view. It is Newton's views of motion where motion must be acted upon by a counterforce to be forced to slow down, when the motion is acted upon by multiple forces of force push—(counter forces), the concept of force push and counter forces allowed the machine age to occur, or the modern era to begin. Motion has to be understood in a formula first, before machines could be built. Motion is multiple forces not a dissipation of force, plus the concept must be in a useable form to allow clarity of cause and effect then 2 multiplied by kilogram is equal to 2 kilograms, 2 multiplied by meters=2 meters and so on.

Scarcity in concept is similar to the ancient Greek view of the natural world, but even less so. The Greeks understood the natural order has an environment which must balance where scarcity is a state of non-balance versus dissipation where dissipation is a form of balance against the original force. Both non-balance and dissipation are in direct conflict to natural science. In physics the natural world must always balance or the earth would fly into space or machines would be impossible. Motion is in multiple forces as when an object moves in its direction it keeps going until acted upon by a counterforce. Motion does not dissipate and mass or motion can not be out of balance. In physics the poor exist because of inefficiencies cause by governmental rules which are a counter force to the distribution of goods. The poor are out of balance because they were put out of balance by the civil authority as the civil authority did something to cause a counter force of some kind.

By writing the definition of economics in a usable form it is possible to understand what alteration of causes are needed to alter the effect. Most importantly, this method enables the differentiation between which is a cause and which is an effect. As cause and effect are in an order of occurrence in time where cause comes first and the resultant effect arrives secondly: not the other way around. The order of time is not, in a practical sense, reversible. This definition enables an understanding of what to do to alter the outcome. Then to endeavor to increase wealth is possible because the change in wealth occurred due to a change in the net input.

Economics is an occurrence of activity caused from the origin of energy as applied force, which is counteracted upon by both human policy and by the natural force drag as natural counter force, establishing a net applied force as a summation of force (Σf) which is the prime mover as the cause that effects the change upon the system (economy) of free people who make up the ownership entities as, “the system to be altered,” by the cause by being accelerated (α) by the change in the transaction rate by the change in the time. This definition follows Newton's second law of motion, the summation of force (Σf) equals mass multiplied by acceleration which is the change in velocity divided by the change in in time (α) written as a formula Σf=ma as in SI units as Σf=Kg m/s².

The following is the natural science view definition of economics:

The process of mathematical reasoning based on principles and laws of physics are then made into an analogy of a reasoning process to the physical world to economics. Physics is a natural science field of study which attempts to understand the natural world through laws and principles of truth and is a discipline. Newton's second law of motion is a hard science truth of reasoning based upon mathematics to the observation of motion in the natural world. Mathematics is not truth, however it is useful to use the discipline of mathematics to attempt to understand the natural world supported by observation and experimentation where the physics of motion is truth.

Newton's second law of motion is the summation of forces=mass multiplied by acceleration, (Σf=ma). Where the force which moves mass (starts the arrow) is not a simple form, but multiple forms of force push and subtracting counter force and force drag (force push−counter force−force drag)=Σf (the summation of force).

Energy uses force as a conduit (to touch) to accelerate mass. However it is the force net which accelerates and force is multiple forces of force push−counter force and force drag, multiple counter forces are factors, as an impediment to force push which alters the process to slow and friction with gravity are also reductions to force push as well. Where force push (1−f₁−f₂−f₃) are factors which reduce force push. Also gravity (g) (acceleration due to gravity) and friction (μ) (pronounced mue) where (μ) is a coefficient of force drag and mass (m) are natural counter forces to force push. Then Fₚ(1−f₁−f₂−f₃ . . . )−μmg=ma. Force push multiplied by one minus the factors 1, 2, 3, reduce force push and natural counterforces also reduce force push [Fₚ (1−f₁−f₂−f₃ . . . )−μmg] are the summation of forces (Σf). It is the Σf which accelerates mass (ma) or mass multiplied by acceleration.

This is the physics view of Newton's second law of motion. An analogy of Newton's law to economics follows the same form of reasoning method.

Force push in economics is electricity generated plus fuel burned other than fuel used to generate electrical power. This then makes the economy go as energy is the origin of movement. Force push makes the economy accelerate assuming the direction of economic activity is a spontaneous behavior for the betterment of humanity (a positive vector). The counterforce to force push are factors of inefficiencies from the governmental policies as factors of taxation, government debt (failure to balance the budget) and the cost of unemployment. Before going any further, a solution of the present subject matter will advocate full employment. Force push is confronted by taxation where taxes can be zero or 100% of force push, (0>1). Where the factor of the counterforce of taxation is fₜₐₓ where 0<factorₜₐₓₐₜᵢₒₙ<1. Then 1−fₜₐₓ is for example, suppose taxes are at 50% then 1−0.5=0.5 multiplied by force push making Fₚ0.5, cutting the accelerating ability of force push in half due to taxation.

The definition of economics is an analogy to physics as a formula is:

Force push (1−fₜₐₓₐₜᵢₒₙ−f_{government debt}−f_{cost of unemployment})−μmg (the coefficient of friction, the force of gravity on mass) which equals the economy multiplied by acceleration.

Then, Fₚ (1−fₜ−f_{d}−fᵤ)−μmg=ma, where the fₜ is the factor of taxation and the subscript t is for taxation, the subscript d is for government debt, and the subscript u is for unemployment.

The analogy to economics is the object of study is the system of ownership entities of a free people. Acceleration is the change in ownership rate divided by the change in time. The alternation of behavior occurs as the free people of entities of ownership which is the system to be accelerated and then changes. The acceleration is the change in ownership rate divided by the change in time.

Acceleration in physics is the change in velocity/the change in time. The economic analogy is the change in the ownership rate of free people/the change in time, which is the transaction rate or the change in transaction rate divided by the change in time where change=Δ (ownership rate/Δt) written as Δ (transaction rate/Δt). Then energy generation is force push, inefficient policy is a counterforce reducing the positive effect of energy of force push and additionally there is the counterforce of friction (ρ) (the Greek myou) and gravity (g) against mass (m), (μmg) which energy must overcome. Then the (μmg) are natural counter forces to force push. To dig up iron ore is to dig up against the force of gravity and then additionally be taxed at the same moment, as the natural force reduces production and the counter force of taxation also reduces production.

As the units on one side of the equation are not the same on the other side proportionality is used (α). Fpush (1−fₜₐₓ−f_{debt}−f_{unemployment})−μmg α (production owned by ownership entities (the object to be studied)).

(Δ(ownership rate/Δt) as energy out and wealth results as energy out, wealth is highly proportionate to energy out. The resultant wealth can only occur from the input of the summation of force (Σf) and it must be clear counter forces reduce wealth.

The Σf=ma→Fₚ (1−factor)−μmg=ownership entities of a free people Δ(ownership rate/Δt)→energy out. Than this formula is applied to economics.

Fp (1−fₜ−f_{d}−fᵤ)−μmg=the system of ownership entities A (ownership rate/Δ time).

The process is to determine given the input of applied force as electricity generated plus fuel burned less the counters of government policy plus the friction due to natural forces equaling a net force when the net force (force net) will cause an output of wealth as an effect from the cause. The process enables the management of the net inputs to increase the aggregate wealth of the USA.

The following Table 1 summarizes the physics to economics analogy:

TABLE 1
Physics to Economics Analogy
The Physical World
Human activity of mathematics and reasoning of physics
Mathematical/reasoning of the scientific view of the natural world supported by observation
Newton's second law of motion are principles of truth of reasoning with mathematics
are used to understand the observation of motion in the natural world
Newton's Second Law of Motion is Σf = ma

| The Cause | | The Effect | |
|---|---|---|---|
| Σf | = | m | a |
| Summation of force | = | Mass | Acceleration |
| Applied Force − Force Drag | = | Mass | Δvelocity/Δtime |
| Force Push (1 − Factors) − Friction | = | Mass | Acceleration |
| Mass Gravity | | | |
| A Newton | = | Mass | Acceleration |
| (Force Push) (1 − factor₁ − | = | m | a |
| factors₂) − μmg | | | |
| Σf | = | m | a |

It means net force causes an object to accelerate,
that is to move faster than it was previously going before
The First Principle of Economics as an analogy to a Newton

| The Cause | | The Effect | |
|---|---|---|---|
| Σf | (α) | m | a |
| | Proportional | | |
| | to | | |
| Applied force − counter forces − | (α) | m | a |
| force drag | Proportional | | |
| | to | | |
| Electrical generation + fuel burned | (α) | Owned by ownership | Δ²(ownership)/(Δtime)² |
| push − counter forces − force drag | Proportional | entities of free people | |
| | To | | |
| Electricity + Fuel_{burned} | α | Ownership entities of | Δ (transaction rate)/ |
| (1 − Fₜₐₓ − F_{Gov debt} − | | a free people | Δtime |
| F_{cost unemployment}) − μmg | | | |
| Force Push is electricity + Fuel | α | As a system of the | Transacted in a rate in |
| burned other than fuel used to | | number of economic | time between free people |
| generate electricity | | entities of ownership | with the assumption of a |
| Less counter forces | | being altered in | profit |
| Counter forces are the counter force | | behavior | |
| to production (that which prevents | | | |
| the input to production) Also there | | | |
| are natural counter forces on earth | | | |
| which are the force of gravity and | | | |
| force necessary to overcome friction | | | |
| as (umg) | | | |
| Counter forces are factors of | | | |
| taxation, government debt, and the | | | |
| cost of unemployment which reduce | | | |
| production because they consume | | | |
| energy, therefore counter forces | | | |
| cannot be force push and secondly | | | |
| counter forces reduce the Fₚ and | | | |
| reduce Σf. There is an assumption | | | |
| iron ore is not put back into the | | | |
| ground without any reason than the | | | |
| use of energy is assumed for the | | | |
| purpose to make a gain. | | | |
| Factors of counterforces are 0 > 1 and | | | |
| are cumulative | | | |
| The factors of taxation + the cost of | | | |
| government debt + the cost of paying | | | |
| people not to work all add up to | | | |
| counter act upon the generation of | | | |
| wealth. | | | |
| For example, a 100% tax on all gains | | | |
| would eliminate gain from | | | |
| transaction regardless of how much | | | |
| force push was generated from | | | |
| electricity + fuel burned this means | | | |
| counter forces are a waste of energy. | | | |
| This actually happened in the old | | | |
| USSR causing it to fail. | | | |

Table 1 includes several assumptions or bases. Transaction business is a value added transaction. A tax is inefficient to collect and distribute. A transaction is efficient to both make goods and distribute goods. The inefficient has drag. Wealth is a concept and is understood as a quantity, not who is the owner.

Table 2 further summarizes the physics to economics analogy.

TABLE 2
Physics to Economics Analogy

| | |
|---|---|
| Energy In | Energy In |
| ↓ | ↓ |
| Physics | Economics |
| X = position | X = net worth of ownership |

Δx = x_{f} − xᵢ
Δt = t_{f} − tᵢ
v = Δx/Δt = (x_{f} − xᵢ)/(t_{f} − tᵢ) = d/t = distance/time with direction
Acceleration = Δv = (x_{f} − xᵢ)₂ − (x_{f} − xᵢ)/t₂ − t₁ = Δ²(x)/Δt

| | |
|---|---|
| Distance is a change in position of | Distance is the average velocity multiplied by |
| x = x_{f} − xᵢ | the change in time |
| d = (v)(t) | \tilde{v}(Δt) |
| x = position | x = ownership |
| Δx = position_{f} − positionᵢ | Δx = ownership_{f} − ownershipᵢ |
| Δv = (position_{f} − positionᵢ)₂ − | Δv = (ownership_{f} − ownershipᵢ)₂ − (ownership_{f} − |
| (position_{f} − positionᵢ)₁/t_{f} − tᵢ | ownershipᵢ)₁/t_{f} − tᵢ |
| Acceleration = a = Δv/Δt = | a = (ownership_{f} − ownershipᵢ)₂ − (ownership_{f} − |
| Δ(Δx)/Δt = Δ²(x)/Δt² | ownershipᵢ)₁/t₂ − tᵢ/t_{f} − tᵢ |
| | a = Δ² (ownership)/(Δt)² |
| x = change in position | Δx = transaction → the change in the |
| | ownership in an interval of time |
| v = Δx/Δt = | Transaction rate = Δ(ownership)/Δt |
| change in velocity/change in time | |
| a = Δv/Δt | a = Δv/Δt = Δtransaction rate/Δt = |
| | Δ²(ownership)/Δt² |
| The object of study is accelerated by the | The economy as the number of ownership |
| summation of forces | entities of free people is accelerated by a |
| | change in the summation of force |

The economic analogy of each quantity for each item is summarized in Table 3.

TABLE 3
Physics to Economics Analogy

| Physics | Economics |
|---|---|
| Fa = force applied | Applied force from some resource |
| Fp = force push | Electrical generation + fuel burned |
| 0 < Factor₁ < 1 | f₁ is a factor of counter force from taxation |
| a counter force | |
| 0 < Factor₃ < 1 | f₂ is a factor of counter force from the cost of |
| a counter force | government debt plus interest paid |
| 0 < Factor₃ < 1 | f₃ is a factor of counter force from the cost of |
| a counter force | unemployment |
| V = velocity = d/t → | V = Δownership/Δt |
| a = Δv/Δt | a α to Δ in the transaction rate/in Δt |
| | where the economy is a system of ownership |
| | entities change in speed (velocity) |
| E = energy = concept | In the analogy Kinetic Energy α wealth |
| | Where wealth is concept |
| M = mass | Number of ownership entities of a free people |
| μmg = friction | Force drag = natural counter force of friction |
| coefficient mass | and gravity, the same as physics, where |
| gravity force drag | economic activity must overcome gravity |
| | friction, maintaining against the wear and tear |
| | due to the environment |
| ueEnergy In | Energy In |
| ↓ | ↓ |
| Physics | Economics |
| Energy as a concept | |
| ↓ | ↓ |
| Energy out less friction | Wealth out proportional to energy in less the |
| | counterforces of nature additionally less the |
| | counterforces of government policy |

Various definitions and relationships for components and/or variables noted in the tables are as follows.

a=Δ (transaction rate)/Δ time=growth

ΔE/Eᵢ=the growth factor

ΔE/Eᵢ=wealth out a ERR

Then to have a growth event or occurrence there must be a change in force net as an input into the aggregate USA economy which will have an effect, in time, of an (ERR).

The Δ in energy (ΔE)=Σf(d)

ΔE=E_{f}−Eᵢ=F(d)

D=speed (time)

d=\tilde{v}=average velocity

ΔE=\acute{v}Δt/kinetic energyᵢ α growth as a percentage

Growth as a percentage is the expected rate of return (ERR) which is proportional to the Σf(ERRαΣf)

The velocity in the analogy of physics to economics is the change in ownership of assets is the velocity. The change in ownership occurs as a change in the transaction rate/Δt.

Transactions are already going on in the economy. By just waiting nothing happens or there is no change in wealth. To increase wealth the transaction rate must increase (assuming the dollar values remain the same or also increase, but does not go lower). True, transactions then must increase for growth to increase, however it is incorrect to attack the problem of too little growth by attempting to alter transaction by thinking it is possible to alter transaction by avoiding altering the summation of force.

Transactions are an effect from the cause of applied force less counter forces.

Transactions come second in the time order of physical law. To increase transactions, to increase wealth, to make the USA more wealthy, the cause must increase and the cause in economics is the summation of force, which originates from energy, applying force, via the summation of force to alter the behavior of the ownership entities to increase the velocity where the output is a change in wealth.

An objective of the present subject matter is to increase (accelerate in the rules of physics) the gross domestic product (production in mass owned by entities) causing an increase in wealth as a change in the energy out relative to the current energy out by 200% in eight years (time) an approximate annualized increase of 14% per year. Since the economy is already growing at 2% then to accelerate it to a total growth is 14−2=12%. The objective is to become more wealthy. The social science method of reasoning is not capable of accomplishing a 14% growth rate by intent because it can not clearly understand the cause resulting in an effect. The physics method is particularly cause and effect oriented. The physics method is more accurately reflective of how an economy increases, decreases and how much wealth is generated. Physics is designed to understand and calculate the change in position in an interval of time. To become more wealthy is to accelerate the current position of wealth to a new position. The formula Σf=ma does not work backwards, meaning acceleration can not cause force. The cannon ball hits and releases energy, but the energy released is not useable. The cannon ball can not un-hit, a cannon ball after being shot can not go back and re-shoot itself. Then what specifically should be the cause applied to improve the economy to increase it? The answer is clearly more rational from the physics form of reasoning. Where the cause and effect are more clear. The cause comes first in the time order of physical laws and the effect comes second. To increase wealth requires the summation of forces to increase where either force push increases or the counter forces decrease or a combination of both.

In many embodiments of the present subject matter, the one or more physics variables are selected from velocity, acceleration, position, energy and mass. For example, if the physics variable is selected as velocity, that physics variable is assigned to certain economic variables such as economic transaction rate and time. Another example is if the physics variable is selected as acceleration. That physics variable is assigned to economic variables of changes in economic transaction rates and changes in time. Yet another example is if the physics variable is selected as position. That physics variable, i.e., position, is then assigned to ownership entities, assets, net worth, and combinations thereof. Still another example is if the physics variable is energy. That physics variable, i.e., energy, is then assigned to wealth. Another example is if the physics variable is mass. That physics variable, i.e., mass, is then assigned to a number of ownership entities.

A particular example of analyzing economic phenomena is analyzing change in wealth. The change in wealth can be that of a defined society, system, or group (herein referred to as the “system”). The method of analyzing such change in wealth is performed as described herein. A step of identifying at least one economic variable of change in wealth is performed by selecting at least two variables from the following collection: gross domestic product of the system, economic consumption of the system, total energy available to the system, costs of ownership changes within the system, taxation within the system, cost of debt within the system, and costs of unemployment within the system. A step of assigning one or more physics variables to the selected economic variable(s) is performed by selecting physics variables from gravity, friction, mass, distance, time, force push, summation of forces, speed, velocity, and acceleration. The assigned physics variables are then evaluated using physical laws such as set forth in Tables 1-3 to thereby analyze change in wealth.

### VIII—Redefining Wealth in Natural Science

A purpose of the present subject matter is to make the USA more wealthy by a definable quantity and measured in time. The objective is to accelerate a GDP change in value from a starting point, and to increase it by 14.7 for eight consecutive years, which is an increase of the GDP from the current (2014) 17 trillion dollars (3×17=51 trillion dollars) to $51 trillion dollars.

As economics is currently defined in a social science human relation construct it is not possible to clearly envision how to change wealth over some period of time or even understand what wealth is. Social science is a study of human relationships and interactions and its methods do not include laws, truths, or principles in concept with starting and ending points. The linguistics used to define social science concepts can not be used to form complex units to solve problems.

A present day common definition of wealth is to own a lot of stuff. This definition quickly runs in trouble as the value of stuff is inconsistent, changes over time, and ownership has relative interpretation from country to country and is complicated by taxation systems. Some countries outlaw the ownership of stuff making ownership of a lot of stuff impossible, yet wealth in physics would still exist under the constraint of no ownership, but to a far less degree and be concentrated in the hands of a few unelected rulers.

It is difficult to determine wealth or the change in wealth based on the study of human relationships or from the amount of stuff definition. Social science is a study of the self, and this narrow field of knowledge does not include the physical world. Simply an amount of stuff, although physical is too simplistic to be usefully used when challenged to attempt to increase the wealth of a society. A society could have more stuff but not become more wealthy.

Applying the methods of physics, a natural science which is outside of the self and is a process of interaction of force, energy, space (distance) and time is a better methodology as exhibited when attempting to change the position of anything, including changing wealth from a present value to a future value. By using physics as an analogy to economics and defining wealth as a complex unit of physics then this methodology is more likely to enable clarity. The understanding between the cause (the attempt to increase wealth) and the effect, where wealth did increase, is the effect, and is a measurable increase in some measurable way and is determinable in the physics method of reasoning.

To cause a change in wealth in physics is to cause a change in the summation of force which is the input, which enables the change to occur as the output, where wealth is an output, an effect from the cause, where the cause is the input. The output can not change unless the input changes first. Natural science is not a trick or mysticism, there are principles in concepts and laws of cause and effect based on mathematics, and reasoning where experimentation should have consistent and observable outcomes.

Then to define wealth in an analogy to the process used in physics reasoning applied to economics is to define wealth in a complex relation of mass, distance, and time. James Joule is credited in defining the definition of the unit of measure of energy as a Newton multiplied by a meter or force multiplied by distance. Then a Joule in units is kilograms multiplied by meters squared divided by seconds squared or J=Kg m²/s². It means to measure the effect of energy through a kilogram of stuff moved a meter accelerating every second multiplied by a meter making Kg m²/s² a complex unit of energy. Energy is a concept and is defined by its measure of effect, then its effects are measured in a complex unit as a Joule or kinetic energy as average acceleration where KE=½ mv². A Newton in units is a Kg m/s² and a Joule is a Kg m/s² multiplied by m=Kg m²/s². Then energy is force multiplied by distance when the force causes mass to move, eventually in time and some distance occurs: mass, distance and time, kilogram, meters, and seconds is the measure of what the cause did. To increase wealth will involve a change in Joules or as a Joule is a complex unit of energy, a change in wealth will involve a change in energy. Energy is the input where the effect of the output is wealth.

Energy is the basis to increase wealth. Energy as an applied force is then a force which is counteracted upon by counter forces and force drag where force push−counter forces−force drag=force net as the summation of forces (Σf) when the summation of force contacts the mass to be accelerated. Wealth is an output, which makes it an effect, where wealth is the effect of force multiplied by distance when energy as a measure=force multiplied by distance, or a joule which is (force distance), as Kg m²/s². The average unit of energy is the energy in motion when an average is to multiply by ½. The kinetic energy in units is ½Kg m²/s² written as ½ mv².

Average energy as motion is a concept, a joule is not energy but is a method of how to calculate a unit of energy and energy from motion is a concept and calculated as kinetic energy (½ mv²). A joule in units is Kg m²/s² when a unit of energy moved a kilogram of stuff a meter squared (a meter multiplied by a meter) divided by a second squared (a second multiplied by a second). A second multiplied by a second means acceleration when the movement in the next second of motion is greater than the preceding second of motion. A second squared means going faster and faster. Then kinetic energy is an average when an average is noted by multiplying by a half ½. Then kinetic energy is one half multiplied by mass multiplied by acceleration written as ½ mv². Average energy as motion is a concept and to calculate the concept is to calculate it by multiplying ½ mv². Concept to calculation is the reasoning of physics and is the process to solve problems. Energy is the input and the result as an effect is ½ mv² as a calculation. Then it can be calculated how much energy to apply to move so much stuff (measured in units of mass as kilograms) so much distance (in units of meters) in so much time (in unites of seconds).

The energy in, (applied), caused work to be done, (work is defined in science to say a position was changed as an effect), because the kilogram moved distance in time. If the kilogram of stuff does not move then no work was done. The kilograms were accelerated by the net force of the applied energy moving distance in time. Work is then an occurrence originating from applied energy where the outcome is kilograms moved distance in time. To move more kilograms at the same speed or to move the same kilograms faster requires either more energy or less counter force or a combination of both. This is very pertinent to how stock markets operate.

Wealth is a concept just as energy is a concept. To calculate wealth is to use the complex unit of kinetic energy, ½ mv². The ability to so work (the scientific definition of work) is where energy is the capacity of a system (where the system is what is being accelerated) to change potion, speed, state, or form (shape) of its surroundings. Energy in as net force caused an effect of the change of the position of object under study which is the acceleration of the object.

The analogy of physics to economics is wealth is a concept calculated as a unit of kinetic energy (½ mv²).

Wealth is the ability to consume as work is done in consumption. Wealth is the ability to engage in commercial transactions (a change (Δ) in ownership) after which ownership is acquired, (assumed at a profit), which is an effect of ownership of additional goods or experiences of service.

The event of wealth generation occurs when natural resources are altered from their natural state to an altered state, the change in resources to manufactured goods, iron ore to automobiles. The good is sold for more than the isolated value of the natural resource. The ownership entities of the natural resources are the system to be accelerated by externally applied energy causing a change outside the system to occur. The change outside the system is the change in wealth. The origin of the change is from the cause of applied energy and the effect is the generation of wealth.

However, in economics there are multiple forms of capital, such as skilled human capital, as well as elements and compounds. Regardless, the skilled labor only occurred or came into existence because resources were altered first by energy. The position of the present subject matter is the steel mill came first, before the skill. It was the iron ore being mined against the force of gravity, moved distance, in time opposed by friction, then melted, pounded into shape by the applied force derived from energy which enabled the stored wealth to occur and in turn used to educate as a use of stored wealth is applied to pay for the education which was created from the manufacturing process. The manufacturing process came first resulting in stored wealth and education came second as a consumer of stored wealth. Skilled human capital is an effect from energy being input and the position of resources being altered.

Within this analogy it is important to note energy is conserved. Conserved does not mean to use less energy to conserve it. Electricity as a form of energy is conserved to wealth which is another form of energy. Energy can neither be created nor destroyed, but energy changes form and often this change in form is not reversible. The conservation of energy in physics is the change in the form of energy from one type of energy to another. The every day lesson in the conservation of energy is a roller coaster where energy changed form from kinetic energy (motion) to stored energy (height). Conservation is not a zero sum game. A zero sum gain is to destroy the one and replace it with another. Energy is not destroyed when it changes form, energy can not be destroyed. As energy has multiple forms so wealth also has multiple forms.

Then the characteristics of wealth in the reasoning of physics are it changes form, it is generated, not created, is often not reversible once applied, is stored and stored wealth changes form to motion, kinetic energy when applied to move an object of study over distance in time, to consume.

Stored wealth, changes form to kinetic energy such as for example in cutting grass. The cut grass is the effect, and the cut grass can not or can not easily be converted back to energy. The energy used to cut the grass is lost to reuse, but is not destroyed and the useable energy goes back into the universe. Although it is possible to make fuel to cut grass.

The definition of wealth is kinetic energy or ½ mv². As kinetic energy can be acquired from stored energy and applied to move mass distance in time. Then to cause a change in wealth is to cause a change in energy where energy in is proportion (α) to energy out. To become more wealthy is to increase fundamentally the energy in. The Chinese know this, as their energy in kilowatt generation capacity has been increasing at 10% per year for the past 20 years versus the USA's year over year change in kilowatt generating capacity growing at 1-2% per year. The Wall Street Journal on Jul. 10, 2014 notes natural gas use in China from 2000 to present growing at 13.6% per year versus the USA's growth at 6.3%. This is how the China has gained global market share over countries which had the advantage over them only just a few years ago. The change in wealth is highly proportional to the change in energy and this is observable and it is a proof of existence.

The definition of economics in the physics reasoning process as an analogy is: (Energy)→force push (1−Fₜₐₓ−F_{gov debt}−F_{cost of unemployment})−μmg α the number of ownership entities multiplied by the change transaction rate/Δtime, when force push is the generation of electricity plus fuel burned lessened by the counter force factors from taxation, government debt, and the cost of unemployment, less the counterforce of the coefficient of friction and the force of gravity which causes the number of ownership entities multiplied by the change in ownership rate divided by the change in time to accelerate or change its behavior.

Electricity+Fuel Burned (1−Fₜₐₓ−F_{government debt}−F_{unemployment cost})−μmg α ownership entities owned by a number of free people multiplied by the change in the ownership rate divided by the change in time (Δ(ownership rate/Δt)). This follows Newton's second law as Σf=ma.

Wealth is the average of force multiplied by distance where (W=wealth) W is approximate to ½ mv², or wealth in a form is likened to kinetic energy, ½ mv².

Work done in physics is when energy uses force to contact mass and move it. If force is applied and the mass does not move then no work occurred. If no work occurred it means the force was too little or insufficient or is net zero. Then high paying jobs are highly proportional to strong increases in energy generation only when resulting in a strong increase in force net.

Wealth is the ability to consume, and the ability to consume essentially is synonymous with the ability to cause work (move mass) where the change in energy=the change in work.

Wealth is the energy out, after the counterforces are accounted for. Energy out is the effect from the cause of the energy applying contact to mass from the summation of force (Σf).

To make the USA grow more rapidly is to either increase force push or decrease the counter forces or both increase force push and simultaneously decrease the counter forces. The best method to increase wealth is to do both, increase force push and also, at the same time decrease the counter forces of taxation, government debt and the cost of unemployment. Natural counter force from gravity and friction can not easily be reduced, however taxes can be lessened to 10% and the income taxation method of collection should be eliminated entirely and replaced by a bank reduction method, which takes zero time from production, government debt can quickly be zeroed out permanently and unemployment nearly eliminated by guaranteeing jobs on a voluntary basis. If everyone has a reasonable paying job, retirees at 60 will 100% of pay by becoming an ownership entity with paid vacation then physics methods can be an answer to growth.

The definition of wealth in the analogy of physics to economics is ½ mv² as a form of wealth which occurs as being generated derived from energy. As energy is used to apply force net the effect is either more production or more rapidly occurring transactions or both. The effect from production increases and or transactions increase as the generation of wealth on average occurs. Wealth is the effect which originates from energy. Then the origin of energy is proportional to wealth. This means being resource rich should certainly enable becoming a wealthy nation. The cause of activity is energy and the effect is eventually wealth if force net is sufficient to cause the object of study to move distance in time or accelerate the economic system of the number of ownership entities. If the object does not move then no work was done and the reason no gain occurs is because net force is zero. Zero net force is not the same as no force being applied, but the force is insufficient to move whatever it is pushing against. Real force can be present but insufficient. To grow, then the increase in net force must be greater than the system to be accelerated.

The observation of European zero growth is from a causation. In economics as analogy physics the summation of force is contacting the number of ownership entities and results in a change in the ownership rate in a time interval at an assumed profit. The physics view is the European force net; the summation of force (Σf) is too little to enable acceleration to occur. The French growth in GDP has been zero for many years; the reason is the Σf is too little. The physics answer to zero growth is to alter the summation of force by increasing it. Then Europe fails to grow because either there is too little force push, too little generation of electricity plus fuel burned, or too much counter force due to government policies or some combination of both resulting in the French summation of forces (Σf)=net zero. This means the policies of the European authority are 100% responsible for the zero growth as in physics the zero growth is an effect from a cause. Now, (2014), the same anti-growth policies are becoming prevalent in the USA.

The cannon ball's force in motion is from the cannon not the ball. To make the ball go faster requires a change from the cannon. The ball can not be stimulated in flight. The ball in flight is the effect. The cannon is the cause. A cannon ball can not be reshot. Attempting to stimulate an increase in wealth can not be from an attempt to alter the effect, which would be the same as an attempt to stimulate transactions or stimulate demand which is a useless linguistic phrase. Transactions, the buying and selling for a profit in a rate of time, is an effect not a cause. Wealth occurs from ownership entities of free people multiplied by the change (Δ) in the transaction rate divided by the change (Δ) in time multiplied by distance on average. To increase is to change. Wealth is proportional to the average ownership entities multiplied by the change (Δ) in ownership rate divided by the change in time (a Newton meter in motion is kinetic energy). To transact there must be ownership as a transaction which is a change in ownership in an interval of time. To increase wealth then is from the cause of applied force which is counteracted upon by counter forces, both man made and natural resulting in a force net, or the summation of force (Σf). It is then the summation of force which accelerates. That which is accelerated is the effect. To accelerate the object of study or accelerate the entity of the system is to alter the behavior of the system, but not change its size. The alteration is from the change in speed with direction making it a change in velocity in occurrence of time. The alteration of the velocity is the effect from net force. No net force, or insufficient net force, will result in no effect, or no acceleration. The gain in wealth is the alteration of the system where an increase in transaction, a change in ownership by a free people occurs at a profit (excluding government transaction). For zero growth to occur means something must cause the existence of zero change. To successfully accelerate wealth there must be ownership, as it is the ownership which is being altered, and to have ownership there must be the highest possible allowance of personal freedom. A police state is not freedom and it will not allow ubiquitous wealth to facilitate. From the history of observation has any police state become wealthy? The answer is no. To require everyone to be the same in wealth prevents transaction, prevents ownership, prevents wealth, and uses energy to control rather than to produce; this is why socialism fails to produce wealth and it is observed to be true. To increase acceleration means to increase force net, to be more efficient, to produce more and is transacted faster. Efficiency only works in a short duration of time then the effect ends. Once a competitor obtains the same or similar techniques of efficiency then the competitive advantage reverts back to the origin, which is the cost of energy. To beat the competitor is to maximize the low cost of generation of energy and minimize the counter forces of taxation, government debt, and the cost of unemployment.

For prolonged acceleration the (Σf) must be sufficient to accelerate over time. The (Σf) is the cause. Energy is the origin less the counter forces. If the counter force from policy and natural force drag equals or exceeds force push then net force is insufficient to enable acceleration (economic growth) to occur, which is today's America. This means an economy which has zero growth, similar to what the USA is experiencing presently (2014) is caused; then the fix is to alter the cause. Stimulating the effect by artificial means can not in the laws of physics allow prolonged economic prosperity; when prosperity means acceleration over many years. An output can not be stimulated as it is an after the fact event from the preceding cause. To correctly use the phrase, “economic stimulant”, would mean to increase the generation of electricity plus fuel burned and or decrease the counter forces of taxation, government debt and cost of unemployment. A true stimulant would eliminate 100% of government debt for example. In the analogy of physics to economics real force push causing a positive force net enables an increase in net wealth.

Wealth is generated from the cause of energy using force to contact the object of study and move the object faster from its current speed or move the economic system from a stand still, such as what the pilgrims did. From 2000 to 2014 the Chinese have increased their application (use) of natural gas by 13.6% per year for the past 14 years compared to the USA which has more slowly increased its use of natural gas by less than 1% per year (Mitsui OKS Lines BP Statistical Review and the US Dept. of Energy). Acceleration is a change in velocity. A change can only occur due to a change from the input of the summation of force (Σf).

Wealth is proportional to Kinetic energy (½ mv²) where wealth can also take the form of stored energy and wealth can change forms as energy changes forms. Wealth is not a zero sum game where wealth is destroyed when used. Wealth as a form of energy may, most of the time not be reversible in its use, but there is nothing stopping the generation of wealth except for the counter force of policy and the counter force of nature. The impediment to the generation of wealth is the counter force of poorly constructed policy by the government. There is simply nothing preventing the USA, given the enormity of natural resources within its domestic borders, from growing at 14% per year for 8 years. Since the USA is already growing at 2% then the net change in growth is 12%.

Wealth is an effect from energy out derived from energy in. Energy is first, then the effect from energy is second and wealth is an effect from energy. Wealth is the net effect of energy in, as energy in then is in contact with object of study or the economic system as the summation of force is from (force push—counter forces—force drag) moving the system (the economic system of ownership entities) to acceleration. The applied force as force push, from the energy, must come from somewhere: in economics it is electricity generated plus fuel burned lessened by counter forces. Importantly, not just energy will succeed in generating wealth. To beat the competition the energy must cost less than the global competitors energy costs them. Economics is then a competition over the generation of cost effective energy.

Then wealth is highly proportional to force multiplied by distance.

To become more wealthy is to: Generate more force push or generate more electricity and burn more fuel; reduce counter forces from policy as counter forces waste energy unnecessarily (the green solution as this does not require the use of energy); and increase personal freedom (green solution as this does not cost energy).

It costs energy wasted to use the people's time by personally taxing individual income. It is better to take the government's portion of the peoples wealth from the banking system by an independent institution because it is significantly more efficient. Wasting the people's time costs 10% of the annual growth to be lost for no reason. It is like driving millions of cars for no reason.

Embrace differences in wealth as differentiation is a natural state and it requires the use of energy to cause sameness or to redistribute, (it is not green to waste energy on sameness). The energy used to attempt sameness of wealth is like driving a million cars every year for no reason.

A block of steel at rest at room temperature has some molecules moving fast and some slowly. To make all the molecules move at the same speed would require significant energy; energy completely wasted and the second the energy is no longer applied the molecules will immediately differentiate and remain differentiated for all of time. Attempting to even out income is anti-physics, wastes energy and causes eventual social failure as observed through historical observation.

Wealth generation from the physics, natural science view, has clarity of cause and effect. Of course there are compromises with social science; however the compromise should not be at the expense of the betterment of humanity or at the expense to the greatness of the USA.

### IX—Redefining Capital in Natural Science

The natural science view of capital is that it is a physical object or has resistance to force and therefore is subject to the physical laws of the universe as mass interacts with force, energy, gravity, distance and time. Then in concept, the behavior of mass is a hard principle and expressed in mathematics as a law. Then to acquire capital is to move mass and the movement of mass is primarily understood from the field of knowledge of physics. To have an economy mass must be moved from its natural position to an altered position with a starting point (initial position) and an ending point (final position) or a change in position over distance in a time interval. The change in position is position final-position initial and a change in position will require force, from energy, moving the mass distance in time.

Social science avails to the belief the cost of capital can be manipulated by altering the measurement system in financial accounting. Social science is saying to make a house bigger the standard measurement of one foot should be made smaller (changing a foot to a half foot). This will increase the square footage of the house based upon the new altered measure in question, but the size in physics remains the same. Cheating on measurements can not change the natural science value. This is an extremely misdirected view if the objective is to increase the total aggregate wealth of the nation. To change the cost of capital would require the change in gravity, the change in the atomic weights of atoms and the alteration of chemical bonding of friction. To engage in an attempt to alter the cost of capital is a falsehood as the cost of capital can not be altered as it is constrained by the laws of nature. Accounting methods can be altered however; accounting methods can not alter mass, gravity, weight, distance, and time. To pretend something is not so does not make it not so. To pretend is nothing.

An economy in the natural science method of principles, starting points, mathematics, laws, observations, and repeatable experiments, is the relationship of, and interactions outside the self, of the behavior of mass, energy, time, distance which is understood within the conformity of those principles, laws, and mathematics. One can not wish it so and therefore make it so, not in natural science.

The natural science view of economics in the present subject mater is electrical generation+fuel burned.

(1−Fₜₐₓ−F_{government debt}−F_{cost of unemployment})−μmg=the number of ownership entities multiplied by the change in (transaction rate/the change in time).

The cost of capital is both a natural counter force to force push plus there are also man made counterforces as well. Capital is the mass being moved in the analogy of physics to economics as the mass is the economic system of ownership entities to be accelerated. However, the movement of mass is not entirely an analogy. To move mass follows the laws of physics. The mining, shipping, and processing of the iron ore is physics. The iron ore is the capital and in natural science the capital is mass of one type or another. The common definition of capital as, “wealth in money and material owned” is not too different from interpreting capital as mass. Mass is a quantity and money could be the unit of measure (the present subject mater realizes the value of money is inconsistent).

Capital as mass then has a cost in energy to be delivered for production. The cost of capital is subject to gravity and friction and costs energy to move it distance in an interval of time. What does it cost, not for the mass itself, but to deliver the mass? To move an object requires force. Mass offers resistance to its change in position. The summation of forces must overcome the natural counter force of the mass to cause the mass to move. Force could be applied but if the mass does not move then the force would be net zero (insufficient). Work can not occur unless the mass moves distance in time. An accounting scheme, no matter how clever, is not energy. Only energy as force push in contact with mass can move mass; then only energy can enable the iron ore to be delivered to the back door of the factory. Work occurs when the mass is moved and mass can only be moved as an effect from the cause of energy.

Capitalism in a natural science view is energyism which uses forceism to accelerate massism distance in time. Capital is the mass delivered and is owned by a free people. Mass delivered is a universal necessity for production to occur. The idea of capital as good or bad is to say iron ore is good or bad. The elements are capital moved by energy then to say capitalism is bad is equally to say elements moved from their natural state distance in time is bad. Social science phraseology is often in unusable words.

The cost of capital on earth is the friction coefficient (μ) multiplied by gravity (g) as friction and gravity are force drag. As work divided by distance=μmg (the friction coefficient multiplied by mass multiplies by gravity) then work divided by mass multiplied by distance=μg. The cost of capital is μg (the friction coefficient multiplied by gravity), as the concept of the cost which is a counter force to force push. This means to overcome μg energy is required and energy is not free. Nor can the expense of energy generation be manipulated by accounting tricks. To move the mass, is to cause work to occur, is to generate sufficient energy to do so. Every country, every position on earth must overcome μg to move mass. The Russians pay μg, the Chinese pay μg, and so does the USA pay μg to deliver the mass. The total cost of capital would include the capital itself (mass) making the total cost of capital μmg. UMG is a natural counter force (force drag) to force push. For an economy to grow there must be acceleration of the movement of mass owned by a free people as entities of ownership where a change in velocity occurs when both the quantity of capital increases along with the velocity change in transactions or both.

Additionally, the cost (energy used) of capital is also the force push necessary to overcome the counterforce of government policy of taxation, the cost of government debt and the cost of unemployment. A society can only be as wealthy as its force push less the counter forces−force drag relative to its size, assuming maximum personal freedom and the assumption of spontaneous behavior acting for the betterment. It also costs energy to put iron ore back into the ground, but there is an assumption people will not act against their own self-interest. However, historically societies have destroyed themselves by their own policies.

The cost of capital is a counterforce to force push which must be overcome, along with the counterforce of governmental policy, if acceleration of the economy is to cause a change, (increase) in the effects of the summation of force: resulting in a change of wealth. Then to artificially pretend the mass does not present a counter force to force push can not be correct. Artificial (fake) unnaturally low interest rates can not be a correct solution as the real cost of energy is omitted. Re-pricing the cost of capital by the authority of the government does not absolve society from coming up with the necessary energy to move the mass to overcome friction and gravity over distance in time. The price of goods sold must increase if the input is mispriced (artificially manipulated) beneath its true cost because the energy to deliver the input can not be lessened without lessening the output. As energy in=energy out, and to change the output to increase wealth is also to change the input where the summation of forces as the input also increases. Unless the input increases then the output can not increase. To become more wealthy is to change the summation of the forces as the input, as the cause and in the time order of physics, “the cause”, comes first. Re-pricing energy does not affect energy; the price of gold does not affect its kilograms. Re-pricing is an alteration of a measurement as changing an inch to something smaller such as a half inch.

Capitalism in natural science is a free people who have the right to own property and transact for a profit contingent upon the summation of forces being sufficient to generate wealth.

In natural science eventually there must be balance. Balance is a theory as actually there is imbalance caused by a force and counter force which cause rebalance and this occurs and reoccurs as imbalance always corrects in the universe in a practical way. The balance means to artificially misprice causes an equal (approximately) misprice somewhere else. To underprice one particular counter force will increase the price of another counter force resulting in a balance of forces. The cause of a real change is the change in net force; not cheating on artificial financial measures. To make the house bigger in physics requires more building material not altering the meaning of an inch. The cost of capital is (μg) friction multiplied by gravity (excluding the material) making the cost real and not subject to being altered without causing an equal reaction somewhere else, which means a price increase somewhere else. Look at food prices before government stimulus in 2007 and look at food prices in 2014 and what is observed. Artificially changing measurements in one place simply cause increases in pricing in some other place. The physics view used to actually become more wealthy as a nation and also as an individual to be independently more wealthy can only occur by a change in the summation of force, by either generating more energy as an increase in applied force or reduce the counter forces of government policy or do both.

### X—Acceleration is How we Change

A purpose of the present subject mater is to explain how to increase the aggregate wealth of the USA. The objective is to increase wealth, and inclusively increase the wealth of the average employed person. The target amount of the expected increase is to grow, (accelerate), approximately at a 14% annualized increase for eight consecutive years using the current Gross Domestic Product as a starting point. Although the current design of the GDP calculation should be adjusted to exclude government spending, as government spending is a negative event, not positive. At present the total GDP includes government spending which is incorrect as government spending is a subtraction from production and individual wealth. An individual would not borrow money and say the borrowed money makes them wealthy. The government can not borrow money and say the USA is wealthy by the amount of the borrowed money. Debt is a negative event not a positive regardless if the debt is paid back or not. The method used to generate the increase in growth (acceleration) is applying the concepts of natural science, narrowed to the formula and disciplines of physics as defined in physical law and principles. Then the methods of physics are used in an analogy to understand economics. The current social science methods of reasoning are not capable of determining a change from a cause at a starting point to the ending point which is a result of an effect of a change in position from the starting point.

To become more wealthy, to become more wealthy faster, faster than the historical norm and faster than likely the global competition can accomplish, means a change in speed with direction. To become more wealthy is to move more quickly than whatever the current movement is and the movement should be defined and understood. Both the cause and effect need to be understood.

Speed is distance divided by time, distance/time, or d/t. How far did the object go and how long did it take. Velocity is the same as speed except velocity is with a direction, where velocity=distance/time with direction or v=d/t→, velocity is used in acceleration because acceleration has direction. To become more wealthy also has direction which is positive as the assumption is not to by intent to become poorer.

Then velocity (→d/t) must change from however fast something was going at the starting point to going faster and if the acceleration continues over time then the acceleration is to go faster and faster and faster. Acceleration is the change in velocity divided by the change in time (Δv/Δt) because the idea of acceleration is to change how fast the object is going from how fast it was going, either if the object is at rest or is in motion. To become more wealthy requires a change in velocity divided by a change in time.

Newton's second law of motion is force push−counter force−force drag=mass multiplied by acceleration. Then force push−counter force−force drag is the force net or the summation of force and the summation of forces are in contact with the mass or object of study causing an effect upon the mass (a change in behavior) to change the velocity (the mass in motion has direction as a result of the contact with force); where the mass will transverse distance in some amount of time. Then the formula for Newton's second law is Σf=ma, the summation of force=mass multiplied by acceleration. Force is necessary to cause the mass to change its velocity divided by the change in time where the, Σf=m(Δv/Δt). The economic analogy using physics to apply the same reasoning to economics is a change in wealth (assuming an increase in wealth is desirable) is as acceleration, where a change occurs assuming a positive direction as an increase.

In economics, what is being accelerated? Going back to the physics analogy of economics where Electricity+Fuel Burned (1−Fₜ−F_{government debt}−F_{cost of energy})−μmg=the number of ownership entities multiplied by the change in the ownership rate divided by the change in time is forceₚᵤₛₕ (1−Factorₜₐₓ−Factor_{government debt}−Factor_{cost of unemployment})−μmg=the number of ownership entities Δ (ownership rat)/Δt, or Fₚ (1−Fₜ−F_{gd}−Fᵤ)−μmg=the number of ownership entities Δ (transaction rate)/Δt and in the analogy the equal sign of (=) is replaced with the symbol of proportional (α). This formula is saying as energy increases then the effect of wealth increases as a cause and effect. However, the cause and effect are in different units where more energy is proportional to more wealth and the symbol (α) replaces the equal sign (=). Then Fₚ (1−Fₜ−F_{gd}−Fᵤ)−μmg α the number of ownership entities Δ (transaction rate)/Δt.

The acceleration in economics is the change in ownership rate (transaction assumed for a profit) divided by the change in time, Δ (transaction rate/Δt). The Δ (ownership/Δt) occurs by the number of ownership entities being accelerated, moving faster. The mass multiplied by acceleration side of the equation of Newton's second Law Σf=ma is the effect side. The Σf is the cause side. Although the definition of energy can be circular as mass in motion has kinetic energy; there is still a cause and effect. The origin of the kinetic energy however is the summation of force from observation. The cause and effect of the economic analogy of physics to economics can not say, “is”, as an equal sign (=), but instead the analogy does say proportional to (α) then there is the economic analogy when the summation of force a the system multiplied by acceleration.

In economics the wealth in general of a society is closely matched to kilowatts generated plus fuel burned, where the force push is essentially electricity generated plus fuel burned. It is fundamental to understand that acceleration is derived from the cause of force net. This does not work backwards. More transactions can not generate electricity of fuel burned. The force occurs first from energy which causes the effect of acceleration, secondly. The equal sign in the equation does not mean there is a time occurrence, it is just for calculation purposes and the same is for the proportional sign (α). The force contacts the mass and accelerates it instantaneously. Without the force the acceleration can not occur, even if we wish otherwise.

Then to become more wealthy as a nation while also including the free people of the nation to participate and also become more wealthy is to increase the summation of force. As the summation of force is force push−counter forces−force drag then either decreasing the counter forces or increasing force push, or both is the physics process necessary to increase wealth as wealth as defined by a complex unit of time, distance, and mass where wealth is (w) makes (Wα ½ mv²) where wealth is proportional to kinetic energy which can change form to stored or potential energy as wealth is proportional to the ability to consume. To consume moves mass and only energy can move mass outside its natural state. Although a kilowatt can not be exactly translated to a dollar through observation more kilowatts cause more wealth where wealth is measured in units of dollars.

An artificial attempt to become more wealthy can not succeed in the discipline of physics because in physics Newton's laws of motion is Σf=ma. An artificial effort is a counter force, as a non-energy or a non-force push. Any counter force or force drag reduces force push, which lessened the summation of force (Σf). To lessen the summation of forces (Σf) must lessen the contact force upon the mass which is to be accelerated (made to alter if behavior to increase is speed with direction). If the summation of force (Σf) is insufficient to move the mass, then nothing happens.

Printing money in any form is a counter force. Stimulus of any kind is counter force; as well as any alteration of the unit of measure of finance. To alter the value of a dollar is a counter force. A counter force always lessens force push. Creating counter forces via government policy can not increase wealth, it will decrease wealth because policy is not energy, but the policy uses energy for other than production.

Acceleration is the physical manifestation to increasing wealth as the cause can not be separated from the effect. The acceleration in economics occurs from free people who are free to own transacting faster at an assumed profit which is the effect of an increase of wealth. The cause enabling change in the rate (time) of transaction is from the cause of energy.

The desire to improve the economy in the physics to economics analogy is to increase the effect. Only energy can cause a change. Mistakenly, current economic thinking seeks the desired effect without consideration of what causes the effect. The time order in physics of cause and effect is the cause comes first and the effect comes second and this is not reversible in a practical sense. An attempt to alter the effect is quite impossible. Then an attempt to stimulate demand is equally impossible as demand is caused by the input of energy first and demand is an effect, the result of the energy input.

### XI—the Counterforces to Economic Growth from the Natural Science View

The objective, the desire, is for the betterment of humanity (to become more wealthy as an American nation and individually) through perpetuity based on the assumption humanity spontaneously has a direction (vector) toward an increase in wealth among free people. As history has observed, the increase in wealth enables an increase in what is good, better health, longer life span, time available for leisure, personal freedom, capacity for invention, and general prosperity. In the natural science reasoning methodology this means energy using force to contact mass, move the mass distance in time, assuming a direction (vector) resulting in acceleration, as an effect from the cause of force push derived from energy. Newton's second law of motion is Σf=ma. The Σf is force push−counter forces—force drag when the summation of force push−the counter force is sufficient to move mass in a direction resulting in a change in velocity (Δv) divided by a change in time (Δv/Δt). Newton's formula is force push−force drag=m multiplied by acceleration=the change in velocity divided by the change in time (Δv/Δt). The net force is the cause and the mass being accelerated is the effect. To become more wealthy the force net must increase. There is an assumption where decreasing kilograms in economics which is decreasing the number of ownership entities in a global environment is against the nations interest although this can temporarily increase a stock market. To become more wealthy can either be from an increase in force push or a decrease in the counter forces or both. This aspect of the present subject matter is focusing on the reduction of the counter forces, the counter forces which impede the increase of motion or impede the increase in wealth. Since the natural force drag of gravity and or friction can not be easily altered therefore the focus is on the counter force to economic growth which is derived from governmental policy.

Counter forces to motion are not within the body of knowledge of social science, making social science a poor methodology as a choice of process to use as a construct to increase wealth.

A counterforce is that which lessens force push and as a consequence reduces wealth which is a proportional effect of force push. The physics analogy to economics is force push is electricity generated+fuel burned. The concept of a counter force is the fundamental principle of Newton's view of how the physical world operates. Prior to Newton (1640) the ancient Greek view of motion was a dissipation of force over time. The Greeks observed an arrow shot, will first fly, then slow, then fall, then stop. They concluded the force push of the bow upon the arrow just dissipated, because less and less force over time caused the arrow to slow over time and finally stop. Seven hundred years later Galileo postulated the shot arrow is subject to multiple forces. This was the correct answer, but Galileo did not have an equation. Newton said the arrow shot will fly indefinitely until acted upon by counter forces which means the energy in the flexed bow contacted the arrow via the force of the bow string and accelerated the arrow. The arrow in motion is acted upon by counter forces which cause it to slow and stop. Newton's concept of nature as force and counterforce has allowed the machine age of the modern era to exist (1640-present (2014)).

The force push is acted upon by that which is not force push, or counter forces. Then the summation of force concept where force push minus counterforces totaling a force net as a summation of force is the revelation of the modern world. Counter forces are what is preventing the USA from obtaining an increase in wealth in time, (growth rate) where growth in time is a growth rate.

That which is not force push is then force drag or factors of counter force. Force push comes from energy which contacts mass via net force when the force is sufficient to move the mass and the acceleration of the mass is the effect from the cause. In the analogy of physics to economics the counter forces are the expense in value incurred by the number of those who own causing fewer and fewer transactions resulting in less wealth due to government policy. The energy generated by electrical power plants plus the energy generated from fuel burned is energy available for production. Dollars spent not for production are the counter to force push.

The equation is Force push (Fp), is Fp (1−factor of government expense of zero to a plus 1 (0>1)) or 0<factor<1.

If force push generates $10 to production capability than a 50% tax rate for example is (10(1-0.5)=10×0.5=$5.

The 50% corporate tax per year (rate is time) reduces the $10 in energy generation available for production to a lower amount, $5 due to taxation. Taxation is a factor (f) in the reduction of force push; as a reduction to the change in acceleration as the factor of taxation is (ftax) results in less. It is the effect from the alteration in the behavior of the number of ownership entities which enables wealth to occur.

Taxation is a reactionary counter force to the generation of wealth. Force push from the generation of electricity plus fuel burned is the primary cause of wealth being generated as an effect from the cause.

Then taxation is a counter force to wealth as a factor (0<ftax<1) to force push. Generating electricity and fuel burned is not an analogy to physics as it is an actual force push. Taxation is not physics, however taxation as a counter force to force push is an analogy based on the reasoning of physics. Then in physics certain types of counter forces are reactionary to force push. The reactionary counter force can only exist when there is an applied force. Take away the applied forces and the reactionary force can not exist. However, take away the reactionary force and the applied force remains. Taxation can not occur first without first there being a gain from the origin of energy using force to contact the economic system as an origination from the applied force. The system of the economy is the ownership entities of free people. Force net is outside the system as to change the system the force must come from outside (this is important and will be addressed later herein). This also means taxation is outside the system: or taxation is not part of the system. Energy→applied force→force push←counter forces which are reactionary exist because of the force push from the applied force occur. If there was not economic activity then there can not be any taxation making taxation a reactionary counter force. At zero velocity (v0) the pilgrims could not be taxed for example.

The equation is Fp(1−ftaxation)=Σf where (0>ftax<1) is and equation of taxation as a counter force results in force net. The reduction of the effect of energy generated is the net force, or the Σf=Fp (1−0>factor of taxation>1). The summation of forces to generate wealth in an economy is energy less the counter forces=Σf economic as the summation of force in the economic analogy.

Various types of counter forces and force drag can react to force push differently. Counter forces can be a direct response of some proportionality to force push or the counter force can be independent. Additionally, a counter force can have its own force counteracting upon force push. Taxation is a reactionary counter force as the force push increases or decreases the ability to tax increases or decreases.

Government debt repayment expense of both principle and interest has a reactionary attribute which changes in value upward due to interest, which compounds the counter force in excess of the original amount borrowed. Government debt is a multiple counter force of principle plus interest payments. Note what interest is; interest is taken from the gain from production where production is derived from the force net or the summation of force Σf. To pay interest is to pay from the ownership of what was gained from production. Interest payments on government debt are a counterforce to wealth. This point is confused by modern finance which is discussed later herein. Interest payments on government debt decrease production or decrease acceleration then also acts to decrease wealth.

The cost of unemployment is more independent to force push the generation of electricity+fuel burned and more associated to→other government policy which lessens the effect of force push. All government expenses are a counter force. Some governmental policy expenses are necessary, but most are not. Taxation is necessary, but not in the method it is collected, unemployment costs are eliminated by being more efficient enabling 100% employment and government debt is completely unnecessary; government debt is just simple mismanagement. Each of these factors, taxation, debt, and the cost of unemployment individually can cancel or reduce the ability of force push to generate more wealth.

A Newton is Σf=ma.

Force push−counter force−force drag=ma where, “m”, is mass and, “a”, is acceleration which in the change in velocity divided by the change in time.

The analogy of physics to economics is Σfα (proportional to) the number of ownership entities of free people where force push−counter force−force drag a the number of ownership entities multiplied by acceleration.

Then Force push−counter force−force drag a the number of ownership entities (Δtransaction rate/Δtime)

Electricity+fuel burned (1−factor of counter force)−natural force drag a the system of a number of ownership entities multiplied by the change in (transaction rate/change in time).

Then, the factors of counter forces are taxation, the cost of government debt and the cost of unemployment. Of course there are many other lesser inefficiencies which should be eliminated to enable an increase in wealth as well.

The counter forces are the factors (f) noted by factors of taxation (ft), factors of the cost of government debt (fgd), factors of the cost of unemployment (fu) where the value of the factor is greater than zero and less than one, (0<factor>).

Then the formula is the analogy of physics to economics is electricity+fuel burned (1−ft−fgd−fu)−umg a number of ownership entities multiplied by the change in the ownership rate divided by the change in time.

The government policy are the factors of taxation, government debt, and the expenses to pay for unemployment, (ft−fgd−fu).

Then policy has the capacity to negate any amount of force push. A policy is a counter force and the counter force reduces force push along with the force drag from natural forces and anything which causes a reduction in force push must, in physics, increase the outcome, where the outcome is wealth. Reducing force push by counter force reduces wealth. A bullet shot into water will only travel one meter versus the same bullet shot through the air will travel miles. It is the difference of the counter force of water versus air which reduces the force push.

The “long version” formula for the analogy of physics to economics is:

Electricity+Fuel Burned (1−factor taxa (0>1)−factor gov. debt (0>1)−factor cost of unemployment (0>1))−friction (μ)mass(m)gravity(g) α number of ownership entities Δ(transaction rate/Δ time).

This can be expressed as a “short version” as:

Fpush (1−Ft−Fgd−Fu)=μmg=number of ownership entities (Δ(ownership rate/Δt)

This is the same reasoning as Newton's second law of motion Σf=ma.

To become more wealthy as a nation, and as an individual then it requires a cause and effect which conforms to the principles of natural law. As ore in kilograms is shipped distance in time energy is applied. Energy is measured by a calculation of a Joule in kilograms multiplied by distance in meters divided by time in seconds squared time distance written as Joule in units as J=Kg (m²/s²) or force multiplied by distance. Then a change in wealth in physics is a result and (highly proportional) to a change in energy; energy as the complex concept in the laws of physics. It is a law of physics where, energy in, equals, energy out. What impedes energy (counter force) will equally impede energy out and the energy out is highly proportional to wealth out as wealth is the effect on the summation of forces as the input.

The fight, the debate, the disagreements in the endless, fruitless, circle, lack of performance of the American economy is currently due to defining economics in social science terms as opposed to applying natural science. The failure is based on the failure methods. The methods of social science are not cause and effect methods under the principles and disciplines of physical law derived from truths. Social Science can not explain how an economy increases wealth, as social science lacks a rational definition of the complex unit of wealth. How can it be fixed if no one knows what it is?

Mathematical physics and other fields of study in natural law are methods precisely formulated to understand a change in position (position final−position initial) and how and why a change occurs. To become more wealthy is a change in the position of wealth where energy is conserved from electricity+fuel burned to the energy which is wealth.

Consider the physics view of government debt. The USA is 100% in debt cause by government policy (this is exclusive of individual and state debt). Being 100% in debt means the total debt owed is equal to the total GDP or eight Russia's. Think if the USA's economy needing to move and process by domestic producers 80 billion tons of iron ore were equal to the value of the debt without compensation. How much energy, distance, and time must occur to dig up, ship, melt, and design it into a product and sell 80 billion tons of iron ore, just to pay back a debt where no gain occurs? Whatever the answer, it means it will have to be done and done for zero compensation because paying off debt is done without compensation. To pay people to move mass, to pay their debt increases the total payment. The USA's debt is 80 billion tons of ore which must be processed into product for free to pay the debt or come up with eight Russia's. This does not include interest. A $100,000 house purchased with a mortgage of $100,000 for 30 years at 3.7% interest costs the borrower 3 multiplied by the original debt or 3×$100,000=$300,000. Then the repayment of the government debt over the next 30 years will be 3 multiplied by 80 billion tons of iron ore (240 billion tons) to be processed for free on the backs of those who must toil to pay it back. Who thinks this is a good idea?

The reasoning process of physics immediately concludes the best policy regarding government debt is zero government debt on a permanent basis. Physics jumps to zero government debt because in the laws of nature, the debt is not a force push and therefore, it is a counter force.

Employment is not a counter force, however, unemployment is a counter force because it involves an expense. Employment could be viewed as a force push as a person has chemical energy. Human chemical energy built the pyramids, and people working is a force push. The physics conclusion is zero unemployment or 100% employment best enables the increase in wealth.

Taxation in any amount is a counter force. It is impossible to have zero taxation, but the time spent on taxation can be zero and the amount spent can be locked down to 10% of the GDP (calculated correctly) and collected via another method where it is not collected from individuals nor corporations. The objective is to pay the expense of social orderliness in a method to minimize the counter force to wealth. Wasted time is an economic counter force when 25 wasted days is 10% of total production in a year. American society certainly wastes 25 days of time on the subject matter of taxation; this is a complete misuse of energy. From the green view, 10% of pollution is from the time wasted collecting taxes. The government can receive 10% of the GDP with zero time spent collecting it; a win, win that is a big gain to wealth.

Using natural science to interpret economics along with social science would create a big gain to the wealth of the USA, easily causing a 14%-ish gain over several years, enough to establish the USA's strength to a position of inchallengability, a position commensurate to its resources.

What is being accelerated? In the analogy of physics to economics the economic system is being accelerated. The economic system is the number of ownership entities of free people (people owning mass or the value associated with the motion of mass and or mass itself). The only possible way to increase national wealth which in turn enables individual wealth is to increase (true based upon observation) force net, the summation of forces (Σf).

### XII—Debt Redefined in Natural Science

An objective of the present subject mater is to explain how to increase the total wealth of the USA from its current position to a future position which generates more wealth than was existing at the initial position for the purpose of increasing individual wealth. To generate more wealth is a change in position of wealth which in the analogy of physics to economics can only occur from the cause of the summation of forces being sufficient to accelerate the system which is the number of ownership entities multiplied by (acceleration) which is the change in the ownership rate divided by the change in time.

The counter forces to force push (electricity+fuel burned) which is the force push allowing the generation of wealth are dominated by taxes (there must be some) the cost of unemployment (can be completely eliminated by employment) and government established debt which can be zeroed out permanently. By lessening the counter forces to the generation of wealth the effect is an increase in wealth. This aspect of the present subject matter focuses on government debt as it is particularly destructive to societal well-being and the general betterment of society. Too much debt destroys nations (by observation).

Egypt spent its wealth building pyramids which produced nothing. If they put the same amount of energy building an irrigation canal system to support its agriculture then they would not have been weakened. Rome's dominance followed Egypt and it too failed due to internal financial mismanagement (too much debt). Germany failed due to debt and money printing; allowing Hitler to gain control. Present day Japan began rapidly increasing its debt 30 years ago, now they are 250% in debt and their stock market has not increased from 30 years ago. The observations are when any society becomes over burdened with debt which it can not repay the result, which is a mixture of various undesirable failures that manifest in the form of zero growth, shutting out the opportunities of the young, ruining the retirement plan of the old, the inability to compete, inflation (the loss of stored wealth), the decline of general well-being of the quality of life, the loss of freedom, and the failure of a nation in all or part.

Considering the concept of debt in a natural science quantitative view, where force push minus the counters force analogy of physics to economics, is applied to the reasoning process, the result is a very different vision of the purpose and consequence of the government borrowing as opposed to the current view of social science. Social science believes in, and financially accounts for debt as a gain to society, which of course, it can not possibly be. In the physics view debt established by the government can not serve any economic purpose as government debt can only decrease wealth and under no condition can government debt increase wealth. Debt is a counter force to force push then lessening the generation of wealth. A practical exception is an unexpected military conflict or natural disaster which would exceed normal budgeting; however, borrowing to finance a war or meteor strike (large) will still decrease aggregate wealth. The World War II example is often cited as an example where debt succeeded in improving the American economy. However, America's original global competitors were in ruin as a consequence of the war enabling the USA an advantage for a while. This advantage was later squandered with bad policy.

The principle truth of debt is it is not a force push. It is a counter force opposing force push plus an additional negative force of interest making government debt a double decrease to the national wealth at a loss of the amount of the debt plus interest because also there is interest owed which is a negative compound. The energy consumed must equal the amount of the value of the debt, plus the value of the interest, plus pay for general improvements. In natural science the value of something is from the change in position of mass a resource, which is accelerated which happens only from net force where net force only happens from energy. Wealth can not just be. The physics to economics view is wealth is from electricity plus fuel burned and this force push is used to pay the principle and interest of the debt resulting in the fact where all the energy used to pay off the debt and interest is wasted. There can not be a perpetual machine in natural science because to move a molecule is to cause heat from friction, heat is energy lost to an irreversible form. In addition to the natural counter forces of heat, gravity, and friction, there are also policy counter forces which must also be overcome to pay off the debt. A force net is always less than the initial applied force before counter forces occur. This is fundamental to physics and observation. A bow can not shoot an arrow greater than the force of the bow. The change of work done will experience a conversion of energy from one form to another, the conservation of energy. The change of form of energy has a practical loss. Only 40% of energy of gasoline moves the car, the other 60% remaining energy from the combustion is lost to heat. The same occurs when wealth consumes (wealth is applied as spending), the consumption will have experienced a conservation of energy when some energy changes form to a new form which is not useable. It takes an enormous amount of energy (electricity plus fuel burned) to pay off debt where the debt should not exist in the first place.

The irony is America's own inefficient policies make it more difficult to pay off the debt as debt being paid off is hampered by the existing debt, and also too much taxation and too much cost of unemployment. Think of all the energy eight Russia's would use just dumped in a field and burned for no reason; that is America's debt. This is the cost of America's debt assuming no interest and assuming no new debt, and assuming immediate repayment.

To pay off the debt more energy is needed than what is equal to the value of the debt, plus more energy still to pay interest plus the counter forces of policy, which makes a gain from debt impossible, just as a perpetual machine is impossible. When energy in=energy out, there can not be energy in=something greater energy than in. In addition to paying the value of the debt there is also the cost of the interest which compounds negatively. A $100,000 debt to buy a house compounds to a total cost of $300,000 in 30 years given a 3.7% interest per year. There is an additional $200,000 of debt on top of the original $100,000 borrowing. Then the 17 trillion dollars of government debt (2014) at 3.7% interest will increase to (3×17) 51 trillion dollars in 30 years assuming no new debt is incurred, which is a weak assumption based upon historical behavior. Debt payments are a little different than mortgage payments, but not much different.

In natural science, to eliminate debt, energy must be obtained by generating enough electricity plus fuel burned to consume wealth equal to 51 trillion dollars where this use of energy provided zero betterment to humanity. How much oil will be burned to pay 51 trillion dollars and is this a good use, best practice use of global resources? The opposite of green is government debt.

Wealth exits as the effect from energy and only the ability of wealth consumed enables the wealth to be used to pay both principle and interest of government debt which is the expenditure of wealth where the cause of the expenditure is the government debt. It takes energy to generate the wealth, therefore to, “pay”, is to use energy. Government debt takes wealth from the people. The people's wealth is lessened by both the principle and interest payments on the government debt.

Business debt (individual) is different because as a free person there is a possibility to make a gain which exceeds the counter properties of debt. Business debt is part of the risk of the attempt to make a profit. However, government is not in business and can not make a gain. Government debt is total loss as it can not engage in a change of ownership in time. Government can not possess the information of private ownership because it is not a private owner and can not price a transaction. When a government can not pay its bills it just counterfeits money.

Only force push being greater than the counter force can generate wealth. Counter force can not generate more of anything as counter forces can only reduce force push. At a given point, a reduction of the counter forces will result in an increase of the summation of force (Σf), which will result in greater wealth. The only way to increase wealth is to increase the summation of force (Σf).

Debt is a counterforce to force push. Debt is not of the origin of energy, but it is a negative force as so much wealth is taken from production to pay the principle and interest. The principle and interest are a loss of energy as the use of stored energy depletes wealth. For the USA to become more wealthy and stay wealthy government debt must be permanently banned and 100% paid off immediately. The formula to pay 100% of the debt in a short period of time includes a ban on future debt indefinitely for the formula to work.

Government debt does deplete the wealth of the people. It does not take from the rich; the reduction in wealth is mostly felt by everyone who earns a wage. Owners are least affected and wage earners are hurt the most. The reason wage earners can not control their individual transaction rate and they can not pass on higher costs as their wage is fixed. Money printers hurt the wage earners.

In the formulas, mathematics and principles of physics, there is not any future energy place. Energy, the origin as the prime mover is in the present. It may sound unusual at first; however debt is sold to the public as something of the future. In the reasoning of physics energy is in the present. There is no future in the physical world. This means, in truth, debt is taking something from the present. This is why poor countries, societies, people, or the pilgrims could not, can not borrow. To borrow is take stored wealth in the present. The IMF (International Monetary Fund) is funded by American workers taking their stored wealth and the money is borrowed by poor countries who will never (highly unlikely) ever pay the loan back. Poor countries can not borrow because they do not have stored wealth. The wealth is taken from American, and given to the borrowers and likely lasts forever.

Debt must be something. For debt to purchase a car then mass was moved. Nothing can not move mass. Only energy using force to contact the mass can move mass. Non-energy is non-force and non-force can not affect the position of mass outside the natural state of the mass. The pilgrims could not use debt to solve their problems nor can a poor country acquire debt, because debt is stored energy. Debt is the use of present stored wealth which is paid back with interest in the future. The loss of use of stored wealth occurs, the stored wealth must be replaced and there is a fee via interest paid to use the stored wealth, which depletes additional stored wealth.

Debt is not time, distance, mass, energy, motion, height, or force therefore it can not be force push. Not being force push means it can not increase wealth. A society which decreases counter forces which lessens force push means it would increase wealth because the summation of force would increase. Then a country decreasing debt will become more wealthy as a reduction in government debt is a reduction in counter forces. The biggest advantage of no debt goes to the average wage earner.

However, in a society which possesses stored wealth, in practice debt can move mass, but it is neither energy nor force push therefore it must be stored energy. Using stored energy makes a nation poorer as observed by the general production capacity decline of the USA which is in a much weaker position than the gold standard which ended in 1971. To borrow is to increase counter force, which decreases the summation of force. Wealth originates from the summation of force as wealth is the ability to do and to do requires the application of energy. Debt reduces the summation of forces. The cause of wealth is the input of energy, debt reduces the input therefore it also must reduce the output: the output is wealth.

### XIII—Printing Money Makes the USA Poorer

If any great nation has an economic Achilles heel it is its domestic currency. Currency, (money), is the measure of work done and wealth stored. Currency is the quantity of measure in finance, it is what is counted, understood as a determination of value, and is a tool used to allocate resources to solve problems. The unit of currency in the USA is a dollar. Work is financially measured in money as distance is measured in physics by various units such as feet or meters and time as a quantity is measured in seconds. The value of the stored wealth is the ability to consume via the application of the money (dollars) as a measure of stored wealth, determined in units of dollars or currency to purchase something in the future.

The determination of the precise measure of a fixed unit (dollar) is necessary to fix the value in a present value relative to the future value. What is an hour of work worth today and if the same hour of work is stored for 20 years to be used to consume in the future what will the future value be? Can a truck driver store a dollar in the present for example (1960) to buy twenty 5-cent candy bars during retirement in the future? The answer is the result of what happened to the value of the dollar over time. A worker driving a truck, working a machine, anyone receiving a wage as compensation works and stores their earned labor thinking the value of the stored wealth will be relative to the stored life efforts to be used in the future. It is to say a working life is worth so many dollars where some stored dollars will be used to pay for the retirement years. The assumption is when a slice of life's energy is stored that it can be later retrieved and when it is used to consume the value of the ability to consume will at least equal or similar to the value of the original slice of life's energy. A truck driver works one hour for 5 dollars in 1960. Five dollars in 1960 could buy one hundred candy bars. Then the value of the stored wealth in physics is 100 candy bars. How many candy bars can five dollars buy today (2014)? The 5 cents stored to consume a candy bar into the future (1960-2014) is insufficient by a multiple of 20 because the money lost 95% of its value over time. The worker's efforts are depleted by a multiple of 20. This means 20 hours worked is only worth one hour in the future. It means workers lost 19 hours of pay due to government money printing. This means 95% of the worker's stored wealth was taken because of bad policy. In physics when something is added to one place some other place must be taken from to enable a balance. There is not any cheating in the natural world as the universe is in balance or being forced back into its balance. The worker's stored wealth was reduced by a loss of 95%. Someone took it. That someone is not the worker's friend.

Modern social science in the view of the current policy makers believes creating unearned money is the solution to employment. Social science in its methods can not measure in the physical world resulting in social science based policies having terrible effects upon the people by depleting 95% of a worker's stored wealth. Conversely, the methods of natural science are particularly designed to determine, by measurement, the cause and effect based upon the principles and laws observed in the natural world, which enable the understanding of a measured cause resulting in measured effects. The difference between the two science methods are social science can not measure the physical cause and effect therefore it can not achieve a desired result, which places the two sciences, social science and natural science at odds in interpreting economic events. This also is putting the two, social science and natural science at odds in terms of creating solutions to increase wealth enabling the betterment of humanity (making everyone more wealthy) through the increase of wealth. The reason 95% of the worker's stored wealth was lost due to a reduction in the value of the money is because the methods of social science failed to understand the consequences of the social science polices.

The natural science view requires a change in wealth can only occur from either an increase in energy (force push), a decrease in counter force to force push, or both increasing energy as force push and decreasing counter force, both would increase force net or the summation of forces (Σf). The natural science view to make society more wealthy is to increase force net, the summation of forces (Σf). Efficiencies also increase wealth through inventions, however inventions are highly proportional to profit, and profit is an effect from the cause of force net or (Σf).

Currency as a measure, a quantity in units of dollars, is the financial value measure of wealth. Currency or money is the measure of work in the financial counting methods and is used to measure stored wealth and the ability to consume from the use of stored wealth. Money is supposed to be fixed in its value to honor the contract of compensation for work done. Money as a median of exchange allows unlike events and items to be calibrated in value, where so many sheep in units of dollars are equal to so many computers in units of dollars, which enables information to be obtained which is necessary for production and transactions. The information is used to determine whether or not a transaction is capable of allowing a gain between the maker and user, or buyer and seller.

When the unit of currency is altered then the value measure of all things valued in the currency are equally altered. If a meter is altered then all things measured in meters are equally altered. As the dollar is the unit of the formula then to change the meaning of the unit therefore must also change the outcome. Currency is supposed to equal an event of value, where so much iron ore is calibrated to a unit in dollars, dollars per ton of ore, dollars per bushel of corn, on and on for all goods. Natural science will not allow the alteration of a value of a unit of measure without recalibrating all measures in the same units because otherwise all the measures would fail. To change the value of a unit affects all items valued by that unit. Social science misses this point. To print unearned money, money not corresponding to an actual event, is to lessen the value of everything in existence valued by money.

It means to build a house in, “feet”, where feet is the unit, and where 100 feet equals 100 feet in distance; then to change the value of “feet” would certainly alter the size of the house linguistically, but the physical sizes stays the same. The quantity (100), the unit (feet) means quantity in units are calculated to determine a physical measure in distance. Changing the unit valuation must change the distance measure, but not the actual distance.

In natural science the value of a dollar is a complex unit of energy. Then to move mass faster than it was already going or to move it from rest requires energy. Energy can not be faked as energy is force push, the generation of electricity plus fuel burned in economics; fuel burned can not be fake. To print fake money causes a dollar per unity of energy to change in value per dollar versus what a dollar per unit of energy was before the fake money was printed. Only by increasing the summation of force can the standard of living increase when the summation of forces (Σf) is both force push less counter forces which=Σf. Printing money can not possibly, under any circumstance, anywhere in the universe alter the state of wealth as wealth is highly proportional to energy and is a result from the cause of the input of summation of forces (Σf).

By printing the fake money the dollar value of energy changes, but the physical energy can not be changed by an artificial financial measure. To become more wealthy requires the actual physical energy to increase as an increase in force net where either both force push increase, and or counter forces decrease. The unit value of the dollar has nothing to do with the physical laws of the natural world. In physical law a change of energy is necessary for the change in work done to occur. A trillion fake dollars has zero effect upon the physical law, but fake money depletes stored wealth if the stored wealth is denominated in the same currency which experienced the fake money printing.

There are many types of and or methods of creating fake money and adding it to society, counterfeiters (criminal) print it and the civil authority print it, both cause a devaluation of the currency. Several types of government money printing techniques are food stamps, rent control, minimum wage, unemployment payments, government bonds, artificially low interest rates, subsidies of any kind, providing credit where repayment will not occur, stimulus of any kind, government purchasing of the peoples assets, just plain old printing it, the banking system of leverage, and other methods operating along the same theme.

Social science concludes the cheapening of the dollar as a unit of valuation is good for society. Is it? Does fake money increase wealth? Or does fake money decrease wealth?

The natural science physics reasoning and principles when applied to economics conclude printing money makes the aggregate nation and eventually everyone in it less wealthy.

The definition of economics in natural science is:

Electricity+fuel burned (1−Fₜₐₓ−F_{debt}−F_{unemployment})−μmg α [the number of ownership entities] Δ(the change in ownership rate)/Δ the change in time:

The analogy to physics is based on physical laws and concepts.

It means force push, in the analogy likened physics is electricity+fuel burned which enables production to occur which then causes the acceleration of transactions owned by free people who then change ownership (buy and sell for an assumed profit) in a measure of time as a rate.

Then in natural science the mass, the object of study, or the entities of ownership is the system, can not change velocity unless acted upon by a force net. This means to increase wealth the input of force is increased specifically the summation of force Σf. The change in wealth is people becoming more wealthy as an effect from the input of energy. The definition of wealth is in a complex unit of energy as quantity of units of kilograms multiplied by meters squared divided by time squared, (Kg(m²/t²) a Newton meter or force multiplied by distance and the ability to consume is proportional to kinetic energy (½ mv²). Wealth is not just owning kilograms. To consume, the kilograms must move distance in time. Which means to move kilograms force is necessary. The system in economics can not be accelerated unless by force net (Σf). Printing fake money is not energy, is not force push, then printing fake money can not increase force net, but it can decrease it. The decrease must occur because that which is not force push is a counter force.

To alter the behavior of the object of study (the system) or ownership entities to change the speed or to accelerate with direction which is to move distance in time. To alter the velocity of the object requires it be forced to move. There must be force first, as a cause, then after the cause the effect occurs. Energy is the input and the effect is the output. Energy in, equals energy out. Fake money is not energy from the origin of energy. Fake money is nothing and in mathematics it is zero. Social science applied in the thinking of the policy makers methods, which the USA government uses presently (2014), is claiming zero in=something out, which is impossible. Zero force can not shoot a cannonball. In physics nothing in, will always result as an effect of, nothing out, where (0 in=0 out) Printed money is zero energy, is zero force, and therefore is zero or the cause is zero therefore the effect must also be zero. Zero movement of a bow string causes no effect upon the arrow then the arrow remains at rest.

Then how does printed money actually cause mass to move or cause economic events? As mass can not move unless forced to do so by the summation of force, how does fake money succeed at stimulating the economy at least temporarily. Stimulating the economy is only possible if the summation of force is increased yet printed money which is 0 summation of force seems to enable a car to be sold where seemingly it would not be sold unless, as a result of the fake, forceless, printed money being put into the economy by the authority of the state was introduced.

The natural science answer is the energy had to come from somewhere; then the somewhere is from stored energy (the people's bank accounts). Then stored energy is used to generate a stored force push. This means, economic stimulus is using the people's stored wealth.

The formula for stored energy is:

SE(1−Fₜₐₓ−F_{gov debt}−F_{unemployment costs})−μmg α the number of ownership entities of a free people Δ (ownership rate/Δt);

Where (SE) is stored energy. Is this observable? Yes. Immediately after the USA stopped backing the currency via the gold standard and began printing unearned money in large amounts in 1971, production declined, manufacturing suffered, the “rust belt” resulted and the national aggregate capacity to produce rapidly declined: America's ability to produce declined and continues to decline downward and struggles to compete at present (2014).

Stored energy or stored wealth is money divided by stuff ($/stuff). As the amount of money is printed where the stuff remains the same, the result is the price of the stuff increases. When the American currency stopped being backed by a standard (gold) (the standard could be any set of elements or commodities) then the price of American made steel increased by the percentage amount of printed money in dollars. This caused the dollar value price of American manufactured steel to go up to the point where it became more efficient for domestic consumers of steel to import steel rather than buy it domestically. The dominating reason the USA imports steel from inferior resource countries is not due to cheap foreign labor, but because the USA's government is printing fake unearned currency and putting it into the domestic economy increasing the cost of American goods. Labor is only a small fraction of the price of steel, only around 7% per ton. The most significant cost of steel is the iron ore and the energy necessary to melt it and ship it. The USA has both the ore and the coal, oil, and gas necessary to melt the steel yet the USA is importing steel from countries which have neither ore or energy and who are additionally disadvantaged by shipping distance and shipping time. America's steel production increased year by year from 1776 to 1971, then in 1972 began to decline every year since. The gold standard ended in 1971 or the money printing began in 1972.

In 1980 the average American family's income was $8,000 per year which could buy a three bedroom house and a car. By 2012 the average pay increased to approximately $50,000 per year, but the $50,000 could only buy the same lifestyle, the same three bedroom house and car. The cause of the change in the value of dollars was due to the amount of printed money year after year, approximately 6% unearned money was printed per year for 32 years. The result is a relative increase in prices of US goods by 6% per year relative to America's competitors resulting in an inability to compete.

An annual increase of 6% fake money per year is the same as a 6% price increase of US made goods per year and a 6% decrease in the value of the stored wealth of all Americans for 32 years. The continuous USA price increases caused by domestic money printing has resulted in American goods being stressed as to their competitive advantage. In natural science the value of the fake money, or the ability of the fake money to force a change is derived purely from taking energy from stored wealth. Society declines as its stored wealth is diminished caused by printing currency which does not correspond to actual production plus the cost of American goods become too high. This means inflation subtracts from stored wealth, making anyone in America who owns stored wealth (which is aggregate stored wealth owned by the people) experience a decrease. American manufacturing is in shambles and the cause is policy: the policy of printing unearned money. The competition took advantage of America's inefficient polices and that is why the resource rich country of the United States of America is in debt to other resource poor countries.

The social science view is to give printed money to essentially anyone who needs it. The effect is the printed money causes the depletion of stored wealth and domestic price increases causing a global competitive failure. Every year since the gold standard ended the USA has had a trade deficit, a lessening of national wealth due to trade.

Consider government decreed stimulus, minimum wage, artificially reduced cost of capital, government bonds (government debt), trade deficits, any form of subsidy, unearned pension, creating fake demand, a reduction in personal freedom, as a policy to increase wealth. The results (effect) of the social sciences view which advocated printing money caused a decline American wealth resulting in a military decline as well.

Taxes from real gains earned are necessary to some degree. Most Americans are not robbed by a band of outlaws because there is police protection (paid by taxes), when fire occurred the fireman did come to rescue (paid by taxes), and disputes are settled in court, (paid by taxes). The police, the fireman, the court system, the teachers are designed by the social science vision of civil orderliness, which is necessary for society to function, but not necessarily to progress. Money can not be printed to pay for the civil servants. The money for civil orderliness must be earned from production. To become more wealthy is a physical change. A physical change in the position of mass or the object of study, which is the system of ownership entities of a free people in the analogy of physics to economics, from an initial position to a new position this event which is better explained by the physical, natural sciences. Both social science and physical science are necessary for economics to improve. To improve means to change. To change is a change in position from the initial position to a final position where position_{final}−positionᵢₙᵢₜᵢₐₗ=the change in position (x_{f}−xᵢ)=Δx. The percentage change in growth of the important is the change in position (Δx) divided by the initial position (xᵢ)=Δxᵢ=% change the cause of the change in the position must come from a positive summation of force (+Σf), in economics this positive summation force must overcome both poorly constructed government policy plus natural counterforce of the force of gravity and friction.

To increase wealth in the analogy of physics to economics is to increase the summation of force: to distribute wealth throughout society is social science. If social science becomes over dominant then the generation of individual wealth may slow, stop, decline, and possibly fail completely terminating the existence of the nation state. The old Soviet Union successfully generated wealth, but the social science of communism beat down the wealth of the individual to a horrid peasantry the social science branch of communism drove the USSR out of existence. What good were the kilowatts from a Soviet hydroelectric dam if the people gained nothing from it. The cost associated with the social science view of distribution of wealth is a counter force to the generation of wealth. The counter force must be less than the force push or failure occurs. A counterforce has the capacity to destroy wealth and consequently destroy a nation. The costs associated with social counterforces to wealth generation (force push) must be considered when the objective is to increase the wealth of a nation. Taking from one group and giving whatever was taken to another group will reduce aggregate wealth of nation 100% of the time because to take is a counter force and not a force push. Also there is friction due to motion and to more wealth from group, “A”, and move it to another group, “B”, experience friction which is an expense which is a counterforce.

To become more wealthy from a present position to a more wealthy future position in natural science requires a change in force net, although an efficiency improvement (because it increases force net) can cause an increase, a prolonged ongoing increased growth in time (rate is in time) growth/time, will require an increase in force net. Force net is not a social science concept, therefore, in the economics analogy social science policies do act as a counter force reducing the generation of wealth. This means more care must be applied to social science policies which impede the generation of wealth.

In the concept of becoming more wealthy, there is an assumption people desire a betterment (being more rich) and do not put mined ore back into the ground. Then an increase involves the system of ownership entities of a free people being moved in a vector (direction) from its present initial position to a change position which occurs in sufficient quantity and quickly enough (relative to an individual life span) in time to enable individuals to own and transact for an assumed profit over long periods of time. To become more wealthy, force net accelerates the economic system increasing the velocity of the change in ownership. When force push is greater than the counter forces and force drag it enables production in kilograms (Kg) to move meters in acceleration in time over distance or force multiplied by distance as a complex unit of a joule in units (Kg m²/s²). A joule is a dimensionless measure of energy. The energy allows force to contact mass, the object of study, to accelerate it. The economic analogy to natural law is electricity+fuel burned less the cost of social policy−less the cost of the natural counterforces of friction and gravity allow the number of ownership entities of free people to increase the transaction rate in a change in time for an assumed profit, quickly enough to improve wealth in a lifetime.

Printed money, unearned, not corresponding to production is not force push. It is not electricity nor fuel burned, or solar, wind, hydro, or thermal energy either. Artificial money is not energy therefore it must be zero as a quantity. The false currency does however carry police authority so it must be accepted. Its use then, is a conservative form of energy from kinetic energy to stored energy. Stored energy is the stored wealth of the individual and stored wealth of the nation, where the printed money depletes bank accounts, pension funds, and coal mines of their resources. If there was not any stored wealth in a society to use then the effect upon the transactions would not occur as printed money without stored wealth is truly zero. Printing money in a very poor country has no effect upon wealth generation as the poor country does not have any stored wealth to borrow from. If the pilgrims printed money upon arriving in North America it would not have any effect upon the wealth of the pilgrim society as the pilgrims did not have any stored wealth, which to subtract from. The pilgrim had to use kinetic energy to till the soil, and hew (kinetic energy) wood products from raw wood to sell to passing ships to obtain the global currency of their time, precious metal coins to increase their wealth. If the pilgrims printed money they could not have used it because printed money obtains its value from taking stored wealth and the pilgrims did not have any stored wealth. The initial position of the pilgrims was velocity zero (v₀).

Then present day stimulus is both printing fake money and also using the fake money, by the authority of the state, to purchase assets of the people, then driving up the price of the peoples assets, which in turn forces the people to buy back their assets from the government in the future for a higher price than it should be, further depleting the assets of the people. Stimulus money printed is not force push. To be force push, is to be from energy. Energy can neither be created or destroyed, but can be generated. False money, unearned, can not generate energy. False money is not energy therefore it can not be force push. However stimulus money does in fact move mass because the authority of the police decrees its use and the mass is moved in the natural science view because the false money changes form (conserved) to stored energy. Then the peoples stored energy in the form of their stored wealth, their bank accounts and assets held in their ownership are depleted via the alteration of the value of the dollar (the unit of measure) making the dollar worth less which then increases the price of all goods and make the people poorer. A dollar saved 30 years ago to buy 20 candy bars can only buy one candy bar because the dollar stored was depleted to 95% from its original value because of the year of deficit spending. Taking from the saver of the dollar, 95% of the savers wealth (wealth as the ability to consume as a complex definition of ½ mv²) is a policy which makes the USA less wealthy. The money printing used the value of the savers wealth to move mass, the mass was moved by stored wealth or stored energy. In physics there is no cheating on the natural world. The fake money, required to be accepted by the authority of the police, must deplete something else because on to itself, it is nothing.

Minimum wage is a similar concept, it used the stored wealth of the people and results in mis-valuing (cheapening) of money. The value of work is from energy using force to contact mass and accelerate it. To transact a sale allowing the consumption of a burger and fries is to move mass in time (when time is a rate) and distance. The change in ownership of food in time can only occur in the natural science view as an effect of the application of the summation of forces (Σf). The wage paid is a proportion of the cost of energy to move the object distance in time. The value of the unit of currency must remain relative to all other economic events. The value of the moved hamburger, which was distance in time, used energy, plus the value of the object moved. If the wage is not in relation to the task performed then it is a misevaluation of currency. To mis-value the currency results in all other events valued in currency to also be mis-valued. For the wage to increase than either more mass is moved in the same amount of time, or the same mass is moved in less time, or less mass is moved in a lot less time. If the dollar remains at a constant value then there is not any other way to increase wages, unless invention allows fewer workers to move the same mass in time. It is impossible to simply decree the hamburger worker be paid more dollars for the same mass in time acceleration unless the value of the unit of measure (the value of a dollar) is altered to a smaller amount (the dollar shrinks in value causing more dollars to buy the same thing). Altering the value of the unit of measure (cheapening the value of the dollar) causes all things in existence to be recalibrated to a higher price negating the gain the wage earner was supposed to receive. Wealth can not be increased by recalibrating the value of a unit of measure. A house is not bigger because the inch is made smaller as a unit of measure to represent less distance than the original inch. Space, time, mass can not be altered. In defense of the workers demanding higher minimum wage, it is not their fault the money has been cheapened by the money printers. It is the money printers fault.

An artificial low cost of capital is the similar problem to minimum wage in concept. Minimum wage is an artificial higher price for labor and likewise, a fake low cost of capital is artificial higher cost of stuff delivered to be produced. Fake low priced interest rates cause commodity price increases. Capital is mass delivered in the analogy of physics to economics. Iron ore delivered to Ford is not free. It took energy to mine, ship, load, and unload the ore, then it takes energy to melt it. To not pay for the actual use of the force net to move, the mass of iron distance in time again requires a recalibration of the value of the unit measure (the dollar is the unit of measure in finance). The cost of capital is the energy it takes to overcome the force of friction and the force of gravity, natural counterforces to force push plus the miners, shipper, and melters still have to pay for the other counter forces of government policy.

Government debt causes unearned currency to occur via government borrowing. The unearned currency is not electricity generated or fuel burned therefore is not force push, it can not be. Then the government borrowed currency causes its use to move mass with the people's stored energy. The people become poorer by the cost of debt occurring. The dollar stored to buy 20 candy bars can only buy one or 95% less because the value of the dollar was recalibrated to become 95% less of an initial position in some point in time.

The domestic recalibration of the unit of value (the dollar) to a lesser amount causes a domestic price increase of domestic goods. This forces domestic manufacturing to move operations out of the (USA) country and also simultaneously causes the domestic consumers to import rather than buy their internally produced goods. Fake money increases the price of American products to the point of intolerance.

Any form of recalibration of the unit of value of the dollar must, in natural law, take away value from somewhere. Everything must be close to being in balance or the natural world would blow apart. Part of the base belief of social science is to claim the economy is never in balance. However in natural science the observation is there is balance. Exact balance is like a perfect circle and not possible, but in nature force always moves toward balance. There is not exact balance in nature, but very close to it. The moon is slowly moving away, the orbit has a force of momentum from the mass of the moon and that force is very slightly greater than the force of gravity on earth, making the orbital imbalance very slight: a billion a year kind of slight: however this occurs because the sun is also pulling on the moon in addition to the earth.

Retirees on a fixed income lose purchasing power, or lose the ability to consume when the value of the currency decreases or it take more currency to buy the same things, which is caused by government bonds and other forms of creating valueless currency. Forms of printing money such as government bonds which are created by government debt, government established artificially low interest rates, minimum wage, stimulus, subsidies, rent control, are all a recalibration of the dollar to a lower unit value and therefore cause the buying ability of stored wealth to dissipate all make the USA and everyone in it poorer: less wealthy.

In natural science, the physics view of economics is to move the ownership entities of a free people distance over time which requires energy. The energy uses force to contact the system and accelerate the change in transaction distance in time. The order is not reversible. The energy contacts the system and the system accelerates. Money printers claim to create demand. Actual demand is the ability to consume and the ability to consume is from energy. Then to increase demand, energy must be generated. Energy can not be generated by printing anything, money or anything else. To increase demand the wealth of the people must increase. To increase the wealth of the people the people must be free to own and transact, and what they own and the ability to transact is from the cause of net force. Demand, is a transaction which is an effect not a cause. An effect can not be altered to create a cause. An un-transacted event must have energy to transact, there must be an assumption of profit from the transaction and there must be the freedom to own. Therefore an un-transaction can not be reversed by the zero force of printed money. Printed money reduces stored wealth, reduces freedom and is not energy. Then printed money can not stimulate demand. To become more wealthy the summation of forces (net force) or (Σf) must increase assuming the spontaneous nature of humanity is for the betterment. Cause and effect have an order in time when the cause comes first and the effect from the cause comes second, this does not necessarily mean time elapsed, but in a practical matter of the economy, elapsed time would be necessary. Then demand can only exist given the input of energy first. Demand comes second after energy is input and demand is an effect from energy, not the other way around. This is the natural science view of economics and to pursue greater wealth for the USA likely will be observed by methods via natural law as opposed social science. Social science is deep into the belief printing unearned currency will increase wealth. This hypothesis is rejected in observation and is rejected by the principles of natural science. Of course there are some whose lives benefit from printed money. However, anyone who earns a wage, or a typically narrow range salary will suffer as prices increase more quickly than the wage or salary increases.

Printed money, false currency, currency printed not in correspondence with actual production is a zero value in natural science. Value is created by the transformation of natural resources to an altered state of the natural resource eventually having energy conserved to wealth. Printed money, unearned currency is a counter force to force push, which reduces the summation of forces (Σf).

### XIV—the Failure of Modern Finance

Modern finance's definition of the disposition and valuation of money relative to the economic system is somewhat ambiguous as it includes the word science, but it is not a natural science and the measure of money is inconsistent. Finance uses quantitative mathematics which typically are statistical methods, but does not apply the principles of truths which are fundamental to the process of natural science. Modern business finance counts things, however, what is being counted is not always clearly defined in measurable units as opposed to natural science where units are consistent. Units in finance are inconsistent and sometimes missing entirely. There is a concrete side to its methods when its purpose is to count. But the clarity falls into disorder when the statistical analytic methods attempt to project and extrapolate historical observations into the future which expects the future to be similar or relative to the past are a predictive method. This creates a cause and effect proposition which is simply the history is the cause and the effect occurs because the effect is likely to be similar to the history. Finance does not consider the methods of physics, the interaction of energy, force, space (distance), temperature and time. Although financial conclusions are often expressed in some quantity divided by time where time is a rate, the how or why things occur are missing. A rate of return is a change in value/time. Absent are the questions of where the return comes from, what is the origin of the cause, what make things change, and why would there be an expectation of an occurrence, all of these are absent in finance as a field of study. The origin, causation, effects, and outcomes are natural science challenges, which are addressed by fields of study with mathematical methods, principles, and truths with laws, which pursue observations to determine the reasons for occurrences. The methods of finance are missing the benefits of physical principles. Financial concepts are intertwined with social science theorems which are often counter to natural law, using social science's non-principles to seek the understanding of an outcome is fundamentally absent of the methods necessary to determine cause and effect. The principles of physics are specifically seeking the resultant cause and effect relationships.

The USA is over 100% in debt which can not ever be paid back or paid off under the current concept of either modern finance or social science methods of reasoning, yet finance seem unconcerned. Most of Europe is in the same condition and Japan is worse (Japan is 250% in debt to its domestic GDP: a hopeless situation). Growth (in America, Europe and Japan) are presently, essentially zero, meaning the betterment of humanity, the capacity to increase jobs and or wealth is boxed in by a counter force equal to force push. The effort to seek betterment (become richer) is facing an equal counter force to stop betterment, and in fact, the progress of an improving middle class has stopped its forward motion where there is not any progress: zero growth.

The social science method to pay off debt is to lessen the value of the citizens assets and wages in an environment of very little forward movement (potential for a gain). Modern finance is part of the problem and lacks the capacity, at present, to provide answers affecting a solution. Methodology of determining useful solutions are absent in modern finance.

To improve the economy of the United States requires the physics methods where the principle of a change in position of and object of study occurs over some distance and in some period of time, where the effect is a change as measured as energy out. Energy out comes from energy in. This is a law, a principle of truth.

The basis of how an economy changes from an initial position of wealth to a future (final) position of wealth are not addressed by modern finance. Finance does not ask how the economy increases, or what the causes are, or what the effects from the causes might be. Financial methods borrow concepts from social science where government debt is considered a positive which is claiming debt is a force push and the payment of interest is somehow a gain. Modern finance is stating government debt plus the interest payment on the debt=a riskless gain. Its position is the cause of debt+interest and the effect is risk free wealth, where debt+interest is equal to risk free wealth. Debt plus interest is not energy, therefore it can not be force push. This promise of, “debt plus interest”, being a positive cause is impossible as debt plus interest is a counter force to force push. Also, the term, “risk free”, is a linguistic phrase outside the basic parameters of natural science. A return implies motion and at the instantaneous point of motion change occurs and change can not be free of volatility. The very existence of debt plus interest lessens capital available for production. Therefore, debt and its additive interest payments must lessen wealth.

The entire concept of energy (not barrels of oil), but energy as the capacity to effect a change in natural law as the driver of a cause of change is absent in finance. Finance seemingly has no idea why things physically change.

The expected gain (Expected rate of return (ERR)), projected by investments, in modern finance is the following:

Expected rate of return (ERR)=government debt+[relative changes as beta] (the Δ in stock market−gov. debt)]. Written as Ex=Rf+[(mᵣ−R_{f})] (the, “cap M”, model). The risk free (R_{f}) return in the definition of finance is the return of government debt. Finance seems to accept the concept of government as defined in the social science theory where government borrowing creates a gain. The formula used is a financial tool to determine relative risk and understand the expected rate of return of investments of financial instruments of, “stocks” and “bonds”. However the formula does not question the level of debt. Financial theory errors in ignoring debt (government) and errors again in thinking interest on government debt is a return. Interest on government debt is not in truth a gain, it is a physical loss of wealth by society. The USA can be disastrously over indebted and the financial formula ignores the environment by accepting the concept debt is a gain. Debt is not a gain, it is a loss. Also, modern finance does not ask why an economy increases or decreases. It is not a, “principle of mathematics,” to say stock prices always gain or always recover, yet finance assumes a constant recovery entirely neglecting the underlying events of the cause. To gain or to have a loss must be for a reason. The origin of the cause which results in an effect is important because to make the USA more wealthy or to increase employment (to have more high paying jobs) is to understand what the cause for a change is.

The modern finance expected rate of return (assumes time is annual) is the expected rate of return is =government bonds+relative historical risk (beta) multiplied by, in brackets, [the return of the US stock market minus government bonds]. This method does not look forward, it does not have a cause and effect, it has no starting point or ending point, and is significantly flawed by incorrectly defining government debt (bonds) as positive, which it is not, as debt can never be positive because debt lessens resources available for production. Government debt in the form of bonds is using the stored wealth of the people and depleting the stored wealth of the people by both the amount of debt plus the interest payment as well, then shrinks available assets to produce.

Proposing the questions of how to increase the economy via the cap-M method of thinking is not possible as it is not a cause and effect method, and has grossly misunderstood what effects government debt causes.

In complete contrast, the physics analogy method of economics is in practice a cause and effect process of thinking and is also forward looking. Then the physics analogy to economics is based on natural science, and is specifically designed to answer what input is necessary to generate more wealth as an output on a national basis. The answer to how to increase wealth is derived from the input necessary to accelerate which is originating from the applied force in a direction as a net force (the summation of force) or (Σf), which is from the origin, where energy is from the origin, resulting in force push less counter forces caused by policy, less force drag from natural counter forces, which total as the summation of force (Σf). The question is how much summation of force does it take to increase wealth? It varies, depending upon the attributes of the economic system and the amount of force which is applied. The applied force is not an exact relationship to the result as other factors alter the one to one relationship. The input and output ratio are a ratio of output divided by the input (output/input) as y over x (y/x) where y=input and x=input.

To increase wealth is also the same as the return on the economy. The future expected rate of return is a change in position of the economic system resulting in wealth as the output as energy out. The economic system is defined as ownership entities of free people. The input is electricity plus fuel burned. Then there is an input represented as the summation of force which accelerates the economic system (ownership entities of free people) where the system has an output. In physics, for something to have happened, meaning a change to occur there must be an input of a positive summation of force (Σf). An automobile engine at zero torque upon the wheels does not have an input and results in no output which means no change. The output of the system is defined in physics as work being done. Work is done because an output occurred. The existence of the output is solely dependent upon the input when the input is the summation of force which is derived from energy. If the input, is sufficient, which then causes the acceleration of the system resulting in the desired effect of an output then a gain can occur. There is a cause (input) and acceleration (change in position/change in time) and an output (work being done) in distance, in time. The cause upon the economic system results in an output as a change in wealth, which is the capacity to do work.

Societies differ. The differences can be natural resources and or cultural differences as well. As both the availability of natural resources and the cultural attributes of a society determine the properties of their economic system then different inputs will affect different systems in different ways. The USA could absorb a trillion kilowatt increase in electricity as an input easily; where conversely a lesser developed country may take a hundred years to develop the capacity to utilize the large input of energy in a useful way.

Different systems have different attributes. The present subject mater is specifically referring to the economic system of the USA at the time of this writing (2014). However, the subject matter can also be applied to economic systems of other countries and/or regions.

The physics analogy to economics is there must be an input from net force acting upon the system to enable an increase in wealth. This is completely different than what modern financial theories conclude. Modern financial theory does not offer any explanation as to why there is an expected return, other than the reference to historical data. Physics, as a natural science, insists a cause is necessary for an effect to occur, as this is observed.

The physics analogy to economics is, first there is energy derived from the origin, (the sun and motion of the universe), where the energy is put into a useable form of electricity plus fuel burned which contacts the system. The system is unique to the society and its policies and resources. Newton's second law of motion is the summation of force is equal to the object (mass), that which has resistance to force, is pushed causing it to move faster (a change in velocity) in a change in time as Σf=ma. In the economics analogy the (Σf) is the electricity+fuel burned, the m (mass) is the system and the, “a”, (acceleration) is the change in behavior of the system. The system is the constant. A cannon ball shot does not alter the cannon ball's mass. What is altered is the behavior of the cannon ball. The alteration of the behavior is the change in velocity in the change in time ((v₂−v₁)/(t₂−t₁)) then the system is the constant, the summation of force is the input and the effect as the result is the output which is the occurrence of acceleration and then in time, distance occurs.

To apply the analogy of physics to economics is to apply natural science to solve problems. The question is, if the economy is to grow, resulting in a positive change in an interval of time which can be noted as a positive, “expected rate of return”, (ERR), then why did the economy change from what were past circumstances (no growth or too little growth), to a change of circumstance where growth occurred. The growth is the gain as the, “expected rate of return”, (ERR) which is expressed in a percentage (%), but what is a gain. What does it mean to experience a gain. In natural science a gain is a change which occurred in time as an effect which can only occur by the application of force derived from energy. Then the expected rate of return has a direct relationship to energy. The analogy of physics to economics definition of applied force to the economy is electricity generated plus fuel burned as force push counteracted upon by negative force of taxation, government debt, and the cost of unemployment and also counteracted upon by natural counter force of gravity and the force to overcome friction which is written as the summation of force (Σf) derived (Fp(1−fₜₐₓ−f_{government debt}−f_{unemployment})−μmg=Σf. Then the expected rate of return as an effect is caused by the cause of the summation of forces. The expected rate of return is expressed as a percentage change, however, the summation of force is expressed in different units, typically kilograms, meters, and seconds. When one side of the equation has different units then the other side then the proportional sign is used (α) as opposed to an equal sign. To write the expected rate of return is proportional to the summation of force is, “ERRαΣf”. This means the effect is proportional to the cause, where if the objective is to increase the expected rate of return then the summation of forces must increase first.

To explain how the expected rate of return is proportional to the summation of forces the problem can be expressed as a direct proportionality of a constant is written as y=kx. Where the y=the output, the k is the constant (the object of study which remains the same), and the x is the output. Breaking this equation down in the view of the physics analogy to economics is as follows:

Proportionality of a Constant.

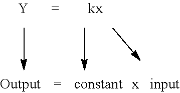

The Physics View:

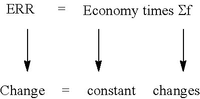

Notice the output is on the left side of the proportionality equation, but this does not alter the fact of the order of time where the input comes first. In physics something must be the same and something must change. An expected rate of return is a change and what is accelerated, the object of the study, the economy remains intact as a constant. To cause a change results in an effect by accelerating the object of study. The object does not change, its behavior changes by being accelerated. To accelerate the economy of the USA is not to change it, as it remains relatively intact, however to accelerate the economy is change the behavior of the economy due to the cause of the external application of energy as force net acting upon the economy then in time acceleration occurs over distance. As the output of energy is calculated as force multiplied by distance then the ERRα force multiplied by distance.

Then the economy is the system as the object of study and the system as properties. The force net accelerating the system and output is proportional to energy out. The energy out is in the analogy where wealth is an output. To change wealth (to increase it) is to change the summation of forces is to increase it. The output can be viewed as force multiplied by distance. The expected rate of return is a change in value divided by the starting value or initial value (the Δvalue/value initial) or Δv/vi=growth. However, since this is in the natural science view then the expected return (ER) is from a change in energy divided by energy initial (ΔE/Eᵢ) as (E_{f}−Eᵢ/Eᵢ)=growth in a percentage. As energy is also force multiplied by distance (f×d) than ER=(f×d/Eᵢ). The expected rate of return includes the change in time as a rate (although in finance time is assumed to be annual. Then ERR=(ΔE/Δt)/Eᵢ. To break out distance as a property of the economic system as the velocity of a transaction distance also equals speed multiplied by time (d=s t) speed is stated as a velocity when there is direction where velocity=speed (→v=speed). The average velocity is used to calculate acceleration (\tilde{v}) in a change in time (Δt) which is distance. Then the summation of force multiplied by the average velocity multiplied by the change in time is the change in energy and when divided by the initial energy as kinetic energy (½ mv²) then: ERR=(Σf\tilde{v}Δt/rate)/(½ mv²ᵢ)=(f×d/rate)/(KEᵢ)=(ΔE/Δt)/Eᵢ=growth, rate.

The attributes of the system as an analogy is (\tilde{v}Δt/KEi) then the summation of force (Σf) accelerates the change and change is relative to the initial energy. Growth is occurring because the velocity of transaction assume occurrence, “at a profit”, increase due to the change in the summation of force. Kinetic energy is used as the initial position as the economy is presently in motion. A slow growth economy in time (growth rate) is still in motion, even though it is slower, but there is not any acceleration. To accelerate external applied force must occur in a positive summation of force resulting in an output, where the generation of wealth is the output which is observed as the consequence of the expected rate of return (a gain in an interval of time over distance which was caused by force, (ΔE/Δt)/Eᵢ.

The cause (Σf) effects a change which is the output as work done and a change in the temperature. The summation of force (Σf) contacts the properties of the system (\tilde{v}Δt/KEᵢ) and acceleration begins and in time goes distance.

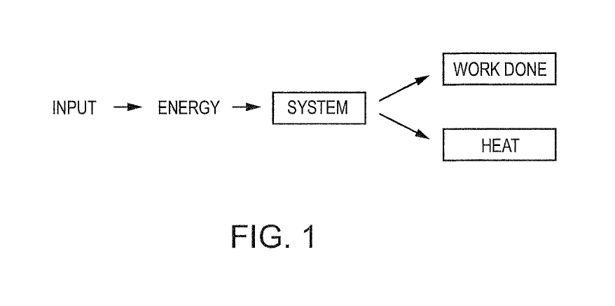

In the diagram in FIG. 1, the input into the system has an output of work done and the change in temperature.

It is important to note there is also heat occurring as a change in temperature due to friction as part of the output. For example, 60% of the output of an automobile engine is heat. The heat is essentially not useable and is lost, going back into the universe. Whenever motion occurs there must be energy lost to use as heat is due to friction. This is why a perpetual machine is impossible. It always takes more input to obtain a lesser output. This subject will be later addressed in the discussion of Keynesianism.

The expected rate (in time) of return (gain) in the physics to economic analogy is the expected rate of return ERR is proportional to the summation of force Σf, ERRαΣf.

Δ in value/in time/value initial=gain in general as a rate (in time)

ERRαΣf

X=Σf−input

Y=ERR−output

K=(\tilde{v}Δt/KEᵢ) as an economic constant

$$E R R = \frac{Σ f ( \tilde{v} Δ t \text{/} K {E}_{i} )}{Δ t} = \frac{( f \times d \text{/} {E}_{i} )}{Δ t} = ( Δ E / Δ t / {E}_{i} ) = gain in wealth ( time could be assumed )$$

The change in work or work done=the change in energy (w=ΔE). To effect work done must be from the cause of the summation of force. As energy out−energy in=work done where work done is the amount of energy which crosses the boundary of the system. Work done can not cross the boundary of the system unless there is an input of energy externally to the system or the system is lessened by the use of stored energy. This concept is also important to understand because in economics fake, printed money is not an input, therefore printed money can not cause work done unless the system is depleted. In economics, to deplete the system is to deplete the wealth of the USA.

In economics as an analogy to physics there are three occurrences to output:

Demonstration: to transact at a profit or transaction rate or money/t/t/=money/t²

Waste: money not used for production

Storage: Money stored or saved. Saved money is depleted by the government printing money.

Growth in the economy occurs because there must be a cause for growth (acceleration of the object of study as the ownership entities of free people) as growth is an effect.

The following system block diagram explains the cause and effect of energy in and the occurrence of the output.

Force is the first in the order of time and effect is second.

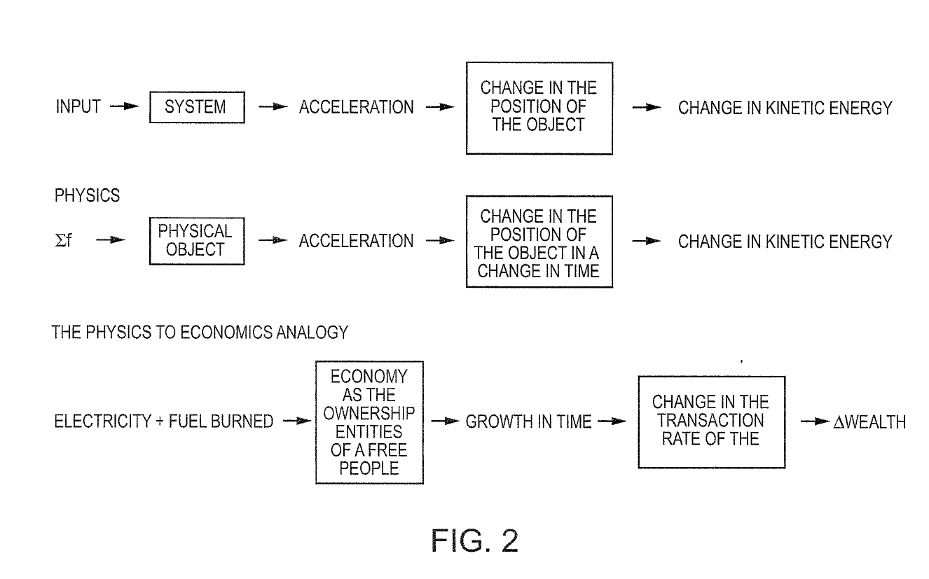

FIG. 2 illustrates a physics to economics analogy.

As printed money, including government debt are not energy as electricity generated or fuel burned then government economic stimulus can not possibly improve the general economic condition. To claim economic stimulus of any kind improves the economy violates all three of Newton's laws of motion as well as the laws of thermodynamics. Printed money, as well as government debt, is a property inside the system. That which is inside the system can not cross the boundary of the system without depleting system. To print money is to use stored wealth, as money printed depletes the total value of the USA.

Printing money or issuing government debt and expecting a gain is the same as saying I can fly because I pull upward on my belt loops. Pulling upward on belt loops is not with an equal and opposite reaction from gravity. External force is necessary to fly such as the force from an engine or allowing an airplane to be pushed up which provides external force to the individual wishing to fly.

To increase the external summation of force will cause a change in wealth or cause the expected rate of return. As ERRαΣf. It takes time to increase the economy. The ending point (final position) is equal to the starting point (position initial) plus acceleration multiplied by time. Velocity final=velocity initial+acceleration x time (vf=vi+at), this means the velocity initial (vi) will accelerate but there must be a time interval if there is distance. There is not any way to know exactly how much time it takes to effect wealth from the cause of the input because the time interval and the exact resistance to the system are unknown and the exactness of the properties of the economic system are also unknown to a degree. However, reasonable estimates are possible.

Then compare the physics natural science analogy of the expected rate of return to the modern finance view of an expected rate of return. The physics view, ERR αΣf versus the modern finance view of the expected rate of return ERR=interest on government debt+(stock gains−interest on government debt).

The modern finance version is a circular definition which says the ERR is the return. By using government debt or any debt as part of the gain function is impossible because debt is counter to a gain. If starting at velocity zero (v0) forward, then a positive increase in velocity could not occur by using stored energy without depleting the aggregate wealth. If three was not any stored wealth, and velocity was at zero then only external applied force could effect a change in wealth. Modern Finance's view of using government bonds to cause a gain is impossible as government debt takes from stored wealth and is not an external force push (energy) to the system. Government debt is of the system as storage, not external to the system.

To expect a gain it must come from the origin, as energy external to the system applied as force, counteracted upon to become a summation of force then contacting the properties of the system to accelerate it long enough to move distance.

Government debt is a counter force to growth and the change is stock prices are dominated by the change in the value of the currency. Fake currency will re-price stock, also valued in dollars, to a new valuation because the measurement value has changed. Change in measurement valuation is not growth.

Stocks, bonds, cash and physics. The present subject mater is not about investing or why stocks go up or down. However, markets are part of the economy as they involve transactions. The public interpretation of economics is heavily influenced by the price of debt and equity (bonds and stocks) as observed when the stock market increases, the leap is made in the public's mind, the economy as the national wealth is also increasing. Then, the gold standard ended in 1971 and the historic foundation of earlier years no longer applied looking forward. The significant government deficit spending began when the gold standard ended. A deficit is an annual occurrence where more money was created by the government than was actually produced by the domestic economy. The amount of money printed became unrelated to goods produced. Via observation in 1980 the average worker made $8,000 annually and had a three bedroom home and a car. By 2007 the same worker now earned an average of $50,000 per year, but still can only afford the same 3 bedroom home and a car. The average percentage change necessary to go from $8,000 to $50,000 in 30 years is approximately 4% per year. This is also the rate of growth of the deficit spending over the same period, approximately 4%. As the fake money printed was approximately 4% per year (rate) will equally cause the depreciation of the value of money at the same rate. Then deficit spending equals depletion of wealth. This is in conflict with stock prices, which is a different problem. In 2007 the economy declined and aggregate wealth declined. From 2007 to 2014 stock prices increased, but in a period of negative or zero growth. The number of workers decreased, fewer people are working, there is lower compensation per job, global shipping has not recovered, more are on welfare, and energy usage is not growing yet stocks have increased. In physics to shoot a one pound cannon ball takes so much gun powder. To shoot a ½ pound cannon with the same amount of gun powder used to shoot the larger cannon will result in a higher velocity of the smaller ball.

To reduce the size of the economy or have zero growth then add a large amount of printed money as stored wealth will accelerate transactions, but not increase the national wealth. The transaction accelerated are money related vs. tangible goods related. Tonnage of steel, plastic and bricks are not changing in production but banking and securities activities in the form of a transaction have increased. There is a change in the velocity of money transaction which includes stocks and bonds due to a shrinking economy, plus the input of stored wealth. Always keep in mind the use of stored wealth is your stored wealth. Your bank account decreases in value when money is printed.

The printed money in physics depletes savings, allowing no reprieve for the wage earner because the typical wage earner's transactions are at a constant flow. Yet the wage earner is faced with rising prices as rising prices are a function of wealth depletion, as stored wealth depletes due to false currency being put into the economy lessens the value of money causing more money needed to buy the same item.

Before 2007 the price of iron ore was $6 dollars-ish for one ton. Once the money printing increased from the typical 4% per year to 20% per year the price of iron ore rose to $150, up 20 times. Gold increased as well as almost every commodity.

The problem is the aggregate wealth of the USA is declining and at present comprises only a 19% global market share and 5% of automobile production, where global market share was close to 30% and automotive production was 90% of global production in the 1950's.

By shrinking the system and using stored wealth to flood the economy stock prices are driven up. It is not the stock market's fault; the market just reacts to the policy of the government.

The average American does not participant in the artificially accelerated velocity of money transaction and therefore becomes poorer. The McDonald's workers who want a pay increase are not to blame. McDonald's is not to blame. Those who suppressed the economy and are printing 20% artificial money per year are to blame.

The input of artificial fake money causes a conservation of mass. When the area of the economy is lessened while the flow of capital is pushed higher via stored wealth then more capital moving through a smaller area, then the present area of the old economy is multiplied by the old velocity must equal the new smaller area multiplied by the new velocity as (A1)(V1)=(A2)(V2). This causes velocity two to increase which is Daniel Bernoulli's formula.

The same conservation of mass occurs as investors move into smaller markets. When the flow of capital is positive the smaller markets increase velocity faster than larger markets do, which is a conversion of mass.

Modern finance ignores the conservation of mass and the conservation of energy as modern finance just looks at the past and projects the past into the future. What happens to their theories when the base fundamentals change? The physics view of economics is constrained by the principles and truths of physical law and therefore the economy must also follow its observable truth allowing the physics view of economics to better understand economic events.

### XV—Redefining the Definition of International Trade

Trade, from the American view, is the USA selling its products outside the United States as an export and also part of trade is buying another country's product as an import. Transactions of trade have been misrepresented to the American people because America loses wealth by trading (transaction at a loss). The phrase, “buy American” emerged in the 1970's and continues on to this day (2014) as a reference to the ratio of imports exceeding the relative sales of domestically produced goods. The ratio of imports to American made goods is to the point where the major retailers such as Wal-Mart, Target, Sears, etc. have almost all non-US made goods for sale. These non-USA made goods are from countries who have far less natural resources than the USA and should not be able to produce goods cheaper.

If the phrase, “buy American”, were actually implemented in terms of domestic consumption of domestically produced goods then would it improve the wealth of America or not? What does the analogy of physics to economics say?

There are fundamental (complex) units of activity which are necessary for the perpetuation of the nation state, and trade is one of those necessary activities. A nation can fail for a variety of reasons; certainly economic failure is a significant cause of distress and often trade plays an important role in the success or failure of a country. Trade is an activity where the interpretation of the benefit to the nation state is viewed differently depending upon the process of reasoning applied. Social science, particularly a global view of social science, may see trade as world improvement. Natural sciences however can more accurately determine the value of trade relative to the specific country of interest. Regardless of the variety of interpretation of the positive and negative aspects of trade a prolonged loss of wealth caused by trading activity, (a trade deficit), will lead to economic distress and possibly significant failure of a nation state. Just like any business, constant losses due to unprofitable transactions conducted at an on-going loss inevitably causes failure.

Trade is generally viewed as a positive concept in the current, social science view, and also in modern finance view. However, the observation is there has been 40 plus years of trade failure by the USA, which means every year the USA trades it loses money and this has not resulted in a fundamental questioning of the modern concept of the desirability to trade from specifically the USA's point of view.

Trade continues to be viewed as an economic activity the USA should engage in even though wealth has depleted from America every year for 40 years. Historically, the theory of international trade was based on a historical period of 1776 to 1971 (the gold standard period) where governmental policies supported economic activity rather than the post 1971 period where policy changed to anti-productivity. There was rapid American growth from 1776 to 1971 where the currency was backed by something tangible establishing account measures of valuation of individual nation's currency, which enabled a USA trade surplus. Eventually, the founding concept of trade, was altered when domestic policy allowed money printing making it impossible for either imports or exports to be priced relative to the actual input it took to make a product.

As a result trade became unprofitable due to changes in policy making the USA generally inefficient: price inefficient, not skill inefficient. Observing America's history of trade, beginning in 1972 in conjunction with the end of the gold standard, the USA's trade began to fail simultaneously as money printing began. Failure is the occurrence of a trade deficit where a loss to national wealth occurs as a result of trading activity where the USA would have been richer if it did not trade in a specific year where the deficit occurred.

There has been a trade deficit every year since 1972 on average of ten billion dollars per year for the past 41 years at an opportunity loss of 8% which equals three trillion dollars of lost wealth to the USA. Adjusting those losses for inflation equals 9 trillion dollars in today's money; a conservative estimate. The USA has lost 9 trillion dollars of wealth simultaneously making our competition 9 trillion dollars richer because of the inefficient management of domestic currency. It is fair to say the present concept of trade has room for improvement. This constant big money loss year after year can not continue and the USA remain a viable world power.

The philosophy of trade has evolved over time, influenced by the European post Renaissance period. Europe, a set of relatively small, resource poor countries found it necessary to trade if their respective political authorities were to remain intact. Small countries must trade because they can not survive otherwise because they do not possess a spectrum of natural resources. These ideas have been engrained in economics for so long they are immune to an alternative view. Is the USA going broke from trade? The answer is clearly yes. However, the failure to make a gain in trade may be a combination of other fundamental failed policies which cause the inability to make a profit during an international transaction. The USA is not small; each American state is roughly the size of a European country. The USA's total GDP is similar to the European common market Eurozone as of 2014, however just a few years prior the USA's GDP was twice the common market. As the USA is in a rapid financial decline at the time of this writing. The relative position of the USA based on its natural resources, implies the USA should be a trade winner, not a trade loser, because the USA as has an energy resource advantage over all other countries except Russia and Brazil.

From 1776 to 1972 the USA made a gain from international trade. Suddenly in 1972 the gains stopped and never reoccurred to this date. The concept of trade is not necessarily a failed concept; it is the domestic economic policies which are causing a resource rich nation to not be able to compete internationally as viewed in the natural science reasoning process of the principles of physics used as an analogy to economics.

The analogy of economics in the form of physics is:

Σf=ma which is Newton's second law of motion means force push is counteracted upon and the net force, if positive, moves mass to acceleration or a net force (Σf) caused the acceleration.

Force push−force counter−force drag=summation of force (Σf) which is equal to the object offering resistance to change velocity in a change in time. This can be abbreviated to:

Force push−force counter−force drag=object multiplied by the change in velocity divided by the change in time.

Fp−Fc−Fd=mass multiplied by Δv/Δt

Σf=ma

Then force push less factors of counter force also less natural counter forces of friction and gravity result in the net force, which moves mass, or the object of study, as a change in velocity in a change in time.

The force push is lessened by (1 factors of counter force)−natural counter force which are equal to summation of force Σf which equal the object having a change in velocity divided by a change in time.

Fp(1−F1−F2−F3)−μmg=mΔv/Δt

The analogy of physics to economics is as follows, which is based on the same form of reasoning where force push is from electricity plus fuel burned as follows:

Electricity generated+fuel burned are force push minus the counter forces as taxation, counter forces of government debt, and the counter forces of the cost of unemployment which are factors of counter forces lessening force push and there is also natural force drag of friction and gravity which is proportional (α) to the object of study which is the ownership entities of a free people (as the system) multiplied by the change in transaction rate assumed for a profit divided by the change in time.

Electricity+fuel (1−Ftax−Fgov debt−Fcost of unemployment)−μmg α ownership entities multiplied by the change (ownership rate)/the change in time

This can be shortened to:

Fp(1−Ft−Fgov−Fu)−μmg αownership entities Δ(transaction rate)/(Δt)

Then trade fits into the equation as an additional factor of factor trade + or −ft+−)

Where Fp(1−Ftax−Fgov debt−Funemploymen+/−Ftrade)−μmg=Σf

If trade is at a surplus then the USA becomes more wealthy and vice versa. As trade losses take energy away from domestic production then the trade deficit is a loss of domestic energy unless the import is an energy item such as oil. The USA may make a gain on importing oil as oil increases force push. However, of course, if the price of imported oil is too high then this may not be true. (Being energy dependent is a false linguistic). More than likely, the price of oil can not lessen domestic wealth because America's competitors must equally pay the same global prices.

The question of trade is in two segments. First, why have trade if it is counter force as a counter force lessens the output of wealth because it prevents or lessens an increase to the summation of force (Σf). Only a summation of force being increased can lead to the effect of an increase in wealth and vice versa. A decrease in the summation of force lessens the generation of wealth. If trade lessens wealth then why have trade? A force drag occurring as a result of trade, (force trade as a negative), implies not to trade or to trade only as little as possible to obtain some necessity which can not be domestically made.

Secondly, a domestic counter force due to policy can be so counterproductive. The circumstance can exist where no matter how trade is engaged in; the result is a loss because domestic policies are so counterproductive, profitable trade is impossible, which is the current situation (2014). Domestic policy is likely the current cause of the USA's failure to produce an aggregate national gain from trade even though America has a resource advantage. American domestic policy is so counterproductive, no matter what an American company does it can not compete globally. Printing money domestically has caused American produced goods prices to increase which prices America out of the global markets.

The formula for trade in the short form is:

Fp(1−ft−fgdt−fu+/−ftrade)−μmg α number of ownership entities multiplied by the change in transaction rate divided by the change in time or:

Fp(1−ft−fgov debt−funemployment+/−ftrade)−μmg=Σf domestic.

Fp(1−ft−fgdt−fu+/−ftrade)−μmg α number of ownership entities of a free people Δ(transaction rate)/(Δt)

Then the total domestic summation of force (Σf) domestic available to accelerate domestic wealth is relative to the effect of how the foreign competitor's summation of force is designed through policy in the competing country. If the USA trades with a country where the competing country is more efficient than the USA, the likely result, as observed, is the USA will fail to make a gain from the transaction. The inefficient country is at the disadvantage in an international transaction. Trade competition is then a competition of whomever has the most efficient summation of force→force net.

The USA has the highest corporate tax in time (rate) in the world (a big counter force). In the natural science view, corporate taxation is a counter force which reduces the summation of force causing the effect of a reduction of national wealth. The combined counter force of over taxation, plus too much government debt which causes USA made goods to be recalibrated to a higher price relative to the global market, plus other social spending (unnecessary spending on unemployment because there should not be any unemployment) results in significant counter forces which negates the efficient American production which causes a reduction in domestic production. Excessive money printing made allowable by ending the gold standard has caused prices of American made stuff to increase has combined with inefficient tax and debt policies to make it impossible for the USA to engage in international trade at a likely gain. Observe 40 years of trade losses, and now observe American businesses finding it necessary to move out of the USA to survive.

Some individual American companies have been able to trade profitably to this point, but that will unlikely continue. American makers of products have responded to domestic inefficient policies by producing outside the USA, because they can not produce internally and make a gain. The well known phrase, “businesses move American jobs overseas”, is obviously directed at business to distract from the likely actual cause which is poorly designed domestic policy. No business would move from an environment which is efficient. Businesses are not separate from people, businesses are a free people.

How to trade profitably. Trade is a competition to make a profit from a transaction. To win a competition is to do better than the competitor. The reason the loser loses is not the fault of the winner. The loser loses because it is the loser's fault. The domestic reason for the failure to compete is not the fault of the foreign competitor. The solution is not to attempt to artificially require the competitor to increase their price by imposing a legal restriction such as a tariff on their goods. A tariff means a failure to compete. Cleveland football is saying the only way to win against the Pittsburgh Steelers is to require the world bank to mandate the Steelers players wear ankle weights when they play Cleveland. The way for Cleveland to beat Pittsburgh is to be better than Pittsburgh, but attempt to pass a law which forces Pittsburgh to be worse. The way to win the completion is to win, to make goods better and cheaper than anyone else can. To make things better and cheaper implies an advantage. The USA has the resource advantage versus almost every other country in the world. If the USA's policies were efficient it would be very difficult to compete against America. The policies must be rewritten to enable the USA to have the most efficient summation of force.

In natural science there is proof of existence. If it occurred then it can reoccur. Rome out produced the world for 300 years, then England did so for 200 years, then the USA traded at a gain for 196 years until the gold standard ended. Japan became a world class competitor from the 1960's to 2000's until Japan started printing massive amounts of money. Germany makes a 50% gain to GDP from trade every year. While the USA loses 3% of its GDP every year. Now China has been making a net gain from global trade for the past 20 years. But Rome, England, Japan, Germany and China are all relatively natural resource poor compared to the USA.

It is only the USA which has a clear natural resource advantage versus the rest of the world. To fail to make a gain from trade is purely a domestic policy failure, as there is not any other possible explanation.

Why trade? The purpose of international trade is to make the domestic nation more wealthy. The European view of trade does not apply to the USA because of the size difference between the USA and individual European countries, plus there is a significant resource difference between all of Europe and the USA as well. The USA has more gas, oil, coal, water, and arable land than all of Europe. The concept of trade when applied to the USA should not follow conventional theory. The USA should invent its own unique theory of trade where the USA makes a gain every year from trade. This trade theory should be based on the ability to generate the least cost, highest joule summation of force.

If demand can be met by internal production, but the demand is met by an import despite the domestic capacity to make the same item, then a loss in trade occurs and it takes energy from the USA to import. When the USA loses energy it must therefore lose wealth as wealth is a direct proportionality of energy. Here is the answer to the underlying truth to the phrase, “buy locally/buy American”; buying locally or buying American in the laws of physics is only possible if the relative summation of force domestic (Σfd) is superior to the competition.

The USA is capable of producing 100% of its automobiles, then there should not be any foreign cars imported. However, if the domestic economy is incapable of making a product due to lack of raw material, or some other natural condition then an import is legitimately necessary, however demand should be met internally when possible. There should not be importation caused by poor policy as this will cause a decline in wealth, therefore the policies must change if the USA is going to become more wealthy.

Italy does not have iron ore, oil, gas, or coal, therefore it must import. Same for Japan, which has very few natural resources. China imports raw material and energy to manufacture and export. Italy, Japan and China are not energy independent, yet they all out produce the USA. Conversely, the USA has all the iron ore, other metals, coal, oil, and gas it needs and agriculturally can feed itself, yet the USA has trade failures (deficits) with all of these countries. The reason the USA loses money on global competition is in natural science, the summation of force, of the USA is too weak to enable domestic production to compete against the foreign (Σff) and the cause of the weakness can only be due to policy as gravity and friction occur equally globally.

The reason the USA imports is because its domestic summation of force is too weak to meet domestic demand. It is not a resource problem, it is a policy problem. The USA is too weak to produce even though it is energy rich; it is the most energy rich nation on earth. The USA is not being beaten by the competition although it is losing to the competition, it is the USA which is causing its own failure through failed domestic policies of too much force against force push.

Kuwait versus Ohio. Just south of Pittsburgh, Pa. the mighty Ohio River winds through the Ohio valley with 10 multiplied by the mass flow rate (water at m³/s²) of the Colorado river where if the energy of the Ohio River was harvested it could power four states and it also passes through some of the richest clay deposits in the world and also has an abundance in oil, gas, and coal resources. This is the most perfect place on earth to make pottery, chinaware, plates, coffee cups, etc. This is the best region to manufacture such products with ample water, rain, clay, coal, gas, and oil to extract and bake clay. There are also many other similar places in the USA with similar resources as well. With all of these resources there is only one large maker of clay flatware products remaining in the USA; all the others have been put out of business by global competitors who do not have nearly any of the resources the USA has.

Kuwait sells coffee cups in Ohio for less than a cup can be produced for in the Ohio Valley (Ohio itself). Kuwait imports clay from central Europe, imports water from outside its borders, and also imports natural gas to bake their imported clay. Then they ship the product by sea 10,000 miles, unload it, ship it 500 miles over land to Ohio and sell it for a profit. Cheaper labor is not the reason this is occurring, because labor is only approximately 7% of the value of the item sold. It costs more than 7% just to ship.

The reason Kuwait can outperform the USA is because its relative summation of force is significantly greater than the USA summation of force. The American made coffee cup costs labor+clay+energy+shipping+government debt payments+the highest corporate tax rate in the world+the cost to pay people not to work (half of the working age population)+domestic currency (dollar) increase relative to the competitors currency due to the US government printing unearned currency which drives up the price of all USA made goods. It all adds up to the inability to compete even though the American coffee cup has the natural resource advantage. America's natural resource advantage is being wasted due to inefficient policy.

The counter forces to the generation of wealth are taxation, government debt, and the cost of unemployment. Note, a view of the present subject matter is for full employment on a voluntary basis and no unemployment money paid as a job should be guaranteed to all. To guarantee a job is a social science concept, to pay for it is a natural science solution. True, the fact is, that a guaranteed job is inefficient, but less inefficient than the welfare payment, because welfare recipients produce zero, but cause an expense resulting in a negative.

The counterforces to force push in the domestic USA are too great to allow a domestic coffee cup maker the ability to compete against a resourceless competitor 10,000 miles across the sea. Observations are the foundation of physical principles of truth. Social science can not answer the question of how to generate wealth, improve trade, or to be more efficient, because social science is not based on principles of truth.

This question is better addressed from the natural science methods of analysis as the physics view recognizes the laws of the universe which are, the cause and effects are resultant from the cause and effect. All events have a cause or there would not be an event. The failure for a resource rich country to compete must be caused.

The philosophy of trade from an American point of view, if the objective is to make the USA more wealthy, should not be along the same concepts originating from the post renaissance European period. Trade for a large, resource rich country should be first to maximize domestic wealth by generating the lowest cost force push in the world and then preserve the minimization of counter forces. Trade is an economic life and death struggle of competition of domestic Σf against foreign Σf. The USA has the natural resource advantage and sufficient economy of scale to improve its wealth more so than all other countries in the global market place. The USA's trade deficit (loss of wealth) is a measure of mismanagement.

### XVI—how to Increase or to Accelerate the American Economy with the Principles of Physics

The best place to begin to understand the concept of a change in wealth is to apply natural science via the laws of physics, which is the ability to do work from energy, where the change in energy=work done. This means to change the wealth, requires a change from the origin of energy, (there is an assumption efficiencies are globally known), or a reduction in the counter forces which reduce applied energy or both.

Physics is a branch of, or a field of study, within the natural science. Physics is a method of reasoning to understand observations, with a starting point and an ending point, disciplines, principles of truth, using mathematics, a numbered form, rigorously defined to solve and seek answers to difficult questions. How to accelerate (increase from its current position) the American economy is a question subject to the very physical characteristics of moving an object of study, producing, heating and or altering natural resources by accelerating the object of study from the current position to a change in velocity, eventually over distance and taking time to do so. Where the generation of wealth is highly proportional to the transaction rate in time of produced goods.

Wealth is generated by altering natural resources (renewable or not) from its natural position and or state to an altered position and or state. Iron ore to automobile, tree to house, coal to heat, and so on, which must transverse distance with direction and must take time to do so.

The process of economics is summarized below in Table 4.

TABLE 4
Process of Economics

Origin of energy is made useful
Energy enables force
Force > counter force
Force net is positive
Force net = Σf (summation of force)
The Σf is the cause
There can not be any occurrence unless caused by a Σf
The economic system is ownership entities of a free people. To
change the position of the ownership entities requires net force
is applied from outside the system.
Σf → owner ship entities → Change in velocity of the entities
Cause, (Σf) → [the behavior change of the object
(economy)] → [the effect is the change in wealth]
There must be a cause → to have an effect

Then to increase the American economy is to apply force net as the cause. More net force then is currently being applied is necessary to change the current velocity to a change in velocity in a change in time.

A purpose of the present subject mater is to explain how to make the USA 200% more wealthy, increasing the current GDP of 17 trillion dollars (3 times its original value) to 51 trillion dollars, in eight years (by growing at 14.7% per year), following the principles and mathematics of natural science methods of physics, then apply those methods in an analogy to economics using the same form of reasoning. Currently, as of the date of this subject mater (2014), the Gross Domestic Product (GDP) of the United States is approximately 17 trillion dollars. The definition of this number, “17 trillion of GDP”, is very problematic as it includes every fake dollar ever printed and the GDP also includes government debt or government spending which is a negative event, but accounted for as a positive. Government debt or government spending is a negative value of wealth and should not be included in the GDP valuation as a positive addition to the total, or the total GDP should not include any government spending as the government spending must take away from production (the wealth of the people) and to take away is a subtraction. The above comment regarding the faulty calculation methods applied by the US government reported GDP is to clarify the objective of a 200% increase in wealth of the USA in 8 years time and is not an attempt to use trickery in accounting methods, which is currently being done. The objective is to achieve an approximate annualized growth of 14% in eight years, an annual (time) change in wealth which is to be measured without printing money, and/or without including government debt as part of the GDP, or any form of government spending whatsoever. The objective is a real change in wealth of a 200% increase change, legitimately calculating (3×) of the GDP, which means everyone in the USA becomes more wealthy.

A principle of physics is an effect, (change), can only occur if it is from a “cause”. To increase wealth is to actually change the behavior of something physically. A physical alteration in behavior (change the velocity), to make kilograms of mass change speed requires specific rules of natural science be followed and those rules, laws and principles are purposefully designed to reject trickery by accounting methods or otherwise. Germaine to increasing a complex unit in physics means there must be acceleration of something. Accelerating in this case, (the analogy of physics to economics), is a change in ownership as a transaction in time at an assumed profit. Those in a position to have simultaneous, multiple large numbers of transactions have an advantage over those who can not do the same given their occupational position of limited transactions. A job doing mono transaction where one transaction, “A”, follows a second transaction, “B”, at a constant speed as a transaction to transaction method accelerate more slowly than a position where thousands of transactions occur rapidly unless, of course, a single transaction is very large. There must be a payoff for jobs which have a slower rate of transactions but not at the expense of the total economic rate of acceleration, a social science concept. However, supporting or sharing benefits of an accelerating economy with varying valued jobs is not a level playing field concept. Attempting to establish sameness in natural science decreases energy and in the analogy of physics to economics as a decrease in energy equally decreases wealth. Natural science rejects the hypothesis where sameness is a positive. In natural science existence is predicated on the opposite of sameness. Something the same next to something the same does not have any transference of energy. Molecules in a body of mass move at different speeds, never moving toward sameness. There is not any observation in either nature science or human society where sameness, “a level playing field” occurs. Sameness would needlessly require energy to cause sameness which means the energy used would be wasted for non-productive purposes.

This means to become more wealthy is specifically not to be the same, but establish a social science pay off to the average income positions which is favorable enough to be accepted. As we say in America, “a deal you can not refuse”. The idea is to move the average pay of $50,000 per year to $100,000 per year without inflation trickery, while generating a job benefit with 100% of pay at retirement of age 60. The observations are, free people, free to become whatever it is they choose to become, generate the greatest amount of wealth. The observation is wealth is greatest among the freeest. As wealth is a form of energy then differentiation generates the most energy, in turn causing the effect of the greatest wealth. It takes energy wasted to reduce freedom, then wasted energy reduces wealth. There still must be civil orderliness where social science applies. However, the construct of an inefficient social science design can take inhuman forms as social science does not have principles of truth to control its ideas. For example, social science can take the form of a harsh dictatorship, allowing oppression, and corruption, or conversely be something positive. This means the projected outcome of social science applications are random, or inconsistent, making it subservient to natural science as a problem solver. A solution method for the betterment, where betterment is invention, increased wealth, longer life span, possessing the military power to secure freedom is most likely to derive from natural science. There are forms of social science reasoning which have historically proposed the opposite of freedom claiming that state control over human activity and suppressing basic rights where ownership is forbidden is the best way to improve the human condition. Historical observations present the freest and generate the highest order of social existence yet social science is incapable of agreement between freedom and oppression. Social science is not a principle of truth, it does not abide by mathematics, observation, results, or cause and effects. Social science is just a tool, multi-purpose; it can be a weapon against freedom or conversely encourage freedom; it depends who wrote it, Jefferson or Stalin. Humanity chooses its social science design. Humanity can be irrational and corrupt. The laws of the universe are outside the self and are expressed by the natural science design. Natural science has no free will and must conform to the principles of natural truths based on mathematics and reasoning. Natural science allows the computation of cause and effect. The summation of force (Σf) is the cause to enable the effect of the change in wealth.

Conversely social science is not a purposeful problem solver, it tends to give up, throw in the towel, as when it can not make progress happen, it loses control, it thinks answers are too difficult or complicated and it allows untrue language such as “scarcity” which natural science rejects to prevail.

The social science definition of economics incorporates the term, “scarcity”, which implies a permanent existence of imbalance. This terminology is a linguistic twist, a (falsity), to justify government's role in artificially establishing economic balance. Natural science rejects the concept of permanent imbalance as such a concept does not exist in the natural world. A permanent imbalance is in conflict to observation and therefore beliefs which are in conflict with observations can not be true. There can not be a scarcity in physics as scarcity is not of the natural universe. Human absence of fulfillment is not scarcity, but social science attempts to blur this concept through an emotional response of an unmet desire. In natural science, humanity is limited by the energy of the universe.

If the USA is in trouble, and it is, and the objective is to maintain its greatness, then manipulations of social science beliefs can not possibly lead to the betterment of American society.

The answer to the equation of how to increase wealth is best served by the application of the natural science process of laws, truths, principles, mathematics, for the purpose of the maximization of wealth for the betterment of humanity that is to, (double the real pay of the average worker). The only way to make certain the average worker receives a substantial gain is from the application of physics to economics. The solution offered by the present subject mater to increase wealth offers concepts on how to enable participation by every worker without causing a detriment (counter force) to acceleration.

How to make the USA more wealthy begins with the objective to increase the American global market share to 40% from its current 19% share where the change in wealth (GDP) is calculated without government spending, without printed money, and without trickery of any kind.

To become more wealthy, to change the position of something “mass”, (a system in economics), is by accelerating it by a cause derived from energy then contacting the mass (system) with force which then will alter the behavior (velocity) of that which is being accelerated. The applied force is counteracted upon by counter forces both natural (from gravity) and friction and counter forces of human design as applied to the analogy of physics to economics. What finally contacts the economic system to move it creating the effect of a change in wealth is the force push−Counter force−force drag from national resistance=summation of force or force net. What increases wealth begins with energy using force net as the carrier. Mass or the system (the object of study) can not be accelerated without force net being greater than the counterforce opposing force push. There is an assumption society will not purposefully attempt to make itself poorer therefore there is the assumption the economy of ownership entities being accelerated will be moving in a direction to increase wealth. The energy it takes to accelerate something bigger is greater than accelerating mass or a system which is smaller. To become more wealthy as a nation by intent assumes greater production by intent. While it is true a smaller amount of production can be accelerated with the same amount energy used for a larger system, but if the purpose is to become more wealthy relative to the global competition, then it means to move more mass (acceleration of the economic system), that is to increase production and accelerate it by increasing the change in ownership by free people faster, more stuff sold faster. To accelerate is a change in velocity in a change in time. To become more wealthy is the effect from the cause of net force being applied via the contact of force with ownership entities of free individuals who own both the input and output of production and the production process itself.

Only by free individuals owing production is production capable to obtain the information of the cost of inputs to the compensation resulting from the output. To win the competition and to use the most efficient amount of energy (the least energy per unit of output) production must be owned by free individuals and not subject to policy regulation to the point of impossible existence. Given the USA's resources, an industry failure in aggregate can only be explained by the cause of policy. The USA produced 80% of all automobiles globally in 1950, but now (2014), it only produces 5%. Policy caused the decline in market share based in the physics analogy view.

The steps to increase the wealth of the USA are as follows:

Begin with force push: generate more energy. More energy is a cause to increase; less energy is a cause to decrease. Burning American coal (the cheapest form of energy other than hydro power) in China does not solve global emission. Exporting coal to America's competition makes America poorer and the competition richer because the competition has cheaper energy which increases the competition summation of force. Competition is a competition between the Σf of the USA versus the Σf of the competition assuming equal resource availability.

Hydroelectric power is the cheapest form of power. Niagara Falls powers New York city 500 miles away and Hoover Dam powers Los Angeles 500 miles away from the Colorado River. The Ohio River which is untapped power has enough energy to power Ohio, West Virginia, Kentucky, and Indiana. This type of energy outperforms international competition unless the competition has similar hydropower equally efficiently provided.

Speed is distance divided by time (d/t): to go x amount of distance in less time means to go faster. Regulation increases time: to increase time is to go slower. Eliminate regulation as much as possible and place constraints on creating any new regulation. The regulation should tell coal mines it will not have new regulations for the next 100 years, this enables the mining operators to input the capital improvement necessary to mine efficiently. Same for the ship builders (who has been put out of business by regulation), the same for coffee cup makers, the steel mill and so on.

Taxation is a waste of time. Get rid of all taxation associated with societal involvement. The banking system can deduct 10% of its flow independently of the government and give the government 10% of the annual flow, fixed for 100 years. The people will spend zero time on taxation and pay zero in on a permanent basis. This way the everyday citizen can spend their time and efforts pursuing the spontaneous natural direction towards increasing wealth.

The government budget is fixed at 10% with 3% going to military. Government debt or deficit or spending of any kind if forbidden for 200 years. Neither federal government bonds or state and local bonds can be issued. There is not any government borrowing as government borrowing is simply taking assets from the people; the very people who generate the wealth. To take from the wealth generators is to reduce wealth. As the USA is capable of acquiring a 40% global market share the 3% to the military will still be the world's largest military budget. Government is obviously incapable of managing their own budget, so this process must be moved into the hands of private banking (excluding a central bank) who must have a specific interest to keep taxation at a fixed 10% of annual growth generation.

Redesign the budget to a fixed 100 year 10% of banking flow which can not be increased in any way and borrowing is forbidden. Debate on increasing the budget is also forbidden with a war exclusion. When the war is over, and if the USA won, then the fixed budget goes back into effect. Flatly eliminate any possibility to increase government spending of any kind. If there is a need for more money, then the solution is for domestic wealth to increase, that is go earn it, otherwise there is no other way to obtain more money.

The money printers, the bond issuers use the presence of the unemployed as justification to create a dominating, freedom depleting, over cost, over regulatory government must be prohibited. The solution is simple; guarantee everyone a job, have the business pay, make it voluntary, remember business owners are paying zero taxes under this concept so there will be revenue to hire in exchange for no taxation. Those who choose not to work are appropriately scorned and receive no support of any kind from the government which is actually the tax payer. This reduces the political power of those who refuse to work. The welfare budget goes to zero, the welfare workers get jobs making stuff, as they are guaranteed a job and it is far more efficient to make stuff as opposed to paying people not to work. Making stuff makes America richer, paying people not to make stuff makes the USA poorer because energy is wasted. The truly disabled are guaranteed truly disabled jobs. Someone who can not do anything, of course, receives the help they need, but there should be very few of those.

Note, to make a law upon a person, is to hire a non-producing deputy whose salary further reduces production due to the loss of capital. The deputy who does nothing more than watch the one who the new law regulates is wasted labor, wasted capital and wasted energy. The more laws passed, the more deputies need to be hired. As the laws grow and grow, there are more deputies than ship builders. Note, the USA lost its ship building industry and all those who serviced and sold to the ship builders when the inefficient laws drove the ship builders out of business, along with driving all of their suppliers out of business, killing millions of very high paying jobs. As a result of the failed US shipping business, the Chinese, Koreans, and Europeans all make ships and although they do not have nearly any of the natural resources the USA has, they succeed in beating the USA because the USA overregulated itself. This would be a good time to smoke a pipe, but it is illegal to grow one's own tobacco and there is a deputy watching to make certain that such smoking does not occur, and if such occurs anyway, the individual must go to court where there are more and more deputies. Every law passed requires someone to watch the law breakers and that someone who is watching is not working at the mill making wealth, but instead wasting resources watching others. Sharing wealth nationally is a profit sharing concept not a redistribution concept. Everyone who works saves 10% into their own retirement, “wealth accumulation account”. Employers must pay at least 5% into the employees retirement, but employers are also free to pay more as they try to attract and compete for talent. All the money saved buys stock of exclusively American companies. There are not any government bonds to invest in, as bonds as a type of investment are debt which is negative and this causes a reduction in wealth. Some portion of the stock is non-voting enabling corporations to raise capital without losing ownership to some degree. Some stock can mature into finite payoffs, acting like a bond, but is part of equity.

The fear for the stock investor is not a fear of a low return, but a fear of a down market causing a fear of loss. The solution to controlling volatility and or suppressing collapse of the financial system (macroprudential) is not difficult. Stop cheating. Stop over leveraging assets, as the volatility equals leverage. Stop over taxation. As taxation reduces the summation of force, use a commodity basket of items (not exclusively gold), which are impossible to counterfeit as the basis of the value of money such as iron, zinc, copper, cotton, wood, corn, and beef. Then the workers are investing in the ownership of American companies who have a summation of force advantage over global competitors, which will in turn generate strong unleveraged returns. Since money printing is forbidden the result will be whoever has the most efficient summation of force (force net) will also have the price advantage. Add an insurance component to retirement savings, with zero fees simply by placing 10% of savings in a commodity basket to insure against loss should markets be weak at the time an individual retires. Everyone wins. The $50,000 dollar earner saves at least 15% (age 20-59). Thirty-nine (39) years of saving 15% is $7500 at 11% makes a 4.4 million dollars of their money in their personally owned account tax free which makes 6% in the world banking system which is $260,000 per year for life and they pass this on to their heirs should they not live to 200. There are no taxes, so the individual is free to work longer if desired with no penalty because there are not any taxes to penalize and no deputy watching to see if their taxes are paid, there is no IRS because taxes are pinched from the banking system without disturbing the on-going concerns of citizens. All the government employers who were taxing the people are now working in the mill making stuff.

Back to the formula:

Force push makes wealth by increasing the velocity of the object of study, in the economic analogy of physics, where the force push makes production (as money in motion) the people owned the production and transact (buy and sell) it at a gain increases in velocity. Energy can accelerate this process and or also reducing the counter forces to the applied energy does the same thing.

Σf=(ownership entities)(Δ(ownership rate+/Δt

What slows the economy? It is the counter forces to force push which are the counter forces of policy, (taxation, government debt, the cost of unemployment), and force drag of nature, gravity and friction.

Fp−Fcounter−Fdrag=Σf

Σf=ma

ownership entities Δ(ownership rate)/Δt)

Σf=ma which is Newton's law of motion

What causes the generation of wealth is energy which is force push. What slows or stops or can even reverse force push are the counter forces of policy and the natural counter force of force drag. Societal policy which is the counter force in economics then reduces wealth. Most problems are the result of too little wealth. Most policy solution devised in the methodology process of social science further shrinks wealth, and does not increase it. Wealth is lessened by any asset taken from production regardless of the form of the subtraction. Printing money, artificially low interest rates, rent control, food stamps, quantitative easing, all of which are a counter force to wealth because such policy is not energy. Only energy can be the cause to effect an increase in wealth. False monies violate the laws of physics as something can not be created from nothing.

Ohio has more resources than Delaware making Ohio in natural law wealthier than Delaware. Yet Delaware outperforms Ohio because Delaware made efficient corporate laws as a consequence more corporations are established there. In physics the counter force to establishing a corporate charter is equal among all states. Yet, Delaware is more efficient economically because it is taking resources from the other states simply because other states are being out smarted and continue to be out smarted.

New York state is losing wealth because it taxes far more than most other states. They are trying to stop the outflow by offering new businesses coming into New York a 10 year zero business tax rate as an incentive. This means New York's government knows, without a doubt, taxation is a counter force.

Florida does not have state tax. They get it. Taxation is a counter force to wealth.

### XVII—Physics Applied to Economics: Natural Science Vs. Keynes

An objective of the present subject mater is to increase the aggregate (total) wealth of the USA by, 200% (3×GDP) in eight years which is an annualized growth rate (time) of approximately 14.7%: and an even 14% would be sufficient for explanation purposes. Why have an objective to increase wealth? Why not keep wealth the same? The answer is in in the observation of human history where only during periods of a new real increase in wealth did actual betterments in humanity occur such as longer life, more leisure time, more freedom. Plus, there also is a physics based assumption from observation where humanity has a spontaneous natural behavior to seek betterment as evidenced of the current standard of living today versus 1,000 years ago. A thousand years ago the life span was age 25, there was a majority of the population suffering from hunger, depravity and constant conflict. Western civilization and now most of Asia's life span is close to age 80 and no one is starving: no one. This is the first step toward the greatness of man/woman kind; as people are actually learning enough to accelerate if we choose. The aspect of the present matter entitled, “Physics vs. Keynes” is a comparative analysis of the problem solving methods of physics relative to the social theories of John Maynard Keynes, a 1930's era economist. Physics reasoning has been absent in the discussion of what the best optimized solution might be for the American domestic economy to achieve the desired goals of betterment through greater wealth. The present subject mater is introducing the reasoning process of physics by explaining how physics would solve the question of how to increase domestic wealth to a significant degree. How does the physics view compare to the Keynesian view. Why choose Keynes' theory as a position to compare physics to. Why not some other social science economist?

John Maynard Keynes theories are significant because the US government has implemented Keynesian methods in the past and they are doing so now (2014). Keynes, an Englishman, theories are also globally being utilized in many countries, even countries of differing legal structures and founding philosophies. His most famous work, “The General Theory of Employment Interest and Money,” was published in 1936, and of course it took years to write, so assuming he wrote through the beginning of the Depression is likely true. Historically, 1936 was seven years into the Great Depression where little economic improvement was either occurring or was in sight, particularly from an English interpretation of the general well being of Europe. Depression in the USA was an economy stuck in weakness, but a depressed USA was still a rich nation with a high global relative standard of living relative to Europe. Europe's suffering had metamorphisized into the loss of democracy in Germany, Spain, Italy, which was the majority of the European's economic continent, turning those nations into dictatorship termed as fascist where freedom was replaced with government brutality and Russia had turned to dictatorship on 1917. From an English point of view the world was failing and worse, threatening the existence of the Great Britain and its culture.

Keynes, not an intellectual, but an “academic economist” by his own words, said he did not like all the “math symbols” used by classical economic theory (mathematical theories) based reasoning. He said he was influenced away from classical economics, which he studied in his youth to an opposing view of government control over individual income, spending, savings, and personal freedom. Keynes is English and England does not have a constitution which proclaims individual rights as necessary nor does English law consider paramount which conversely the USA does. It is typical and usual for English or European economic theories to offer solutions to economic problems by lessening individual freedom, taking property from one group who they perceive to have too much. Given most of Europe at the time of Keynes life still had significant influence by Royalty, then taking shots at the rich monarchs was politically easy shooting. Many of Keynes base visions of the definition of a free citizen in a given society are quite unconstitutional from an American perspective. There is not any disrespect implied toward Keynesian philosophy simply because of the differences from an American point of view where Keynes is both anti U.S. constitution and anti-American Bill of Rights because the English have never liked American freedoms. The English fought America twice to suppress American freedom and they lost both times. He wrote from his English world, a royal world which collapsed during the first world war ending in 1918 and then eleven years later started falling apart again economically. After the roaring 20's the Great Depression began in 1929, plus it looked like a new, even worse war was on its way by 1936 creating an environment of social failure plus military dysfunction. Europe was anything but stable giving way to alternative theories to classical economics.

Others have criticized Keynesian theories as not fundamentally plausible such as Henry Hazlitt's, “The Failure of the New Economics, an analysis of the Keynesian fallacies”. Hazlitt picks apart almost every paragraph of Keynes writings and notes the conflict with basic economic (from a free American's prospective) principles of observation and mathematics. He notes when Keynesian methods are applied what actually occurs is in conflict with its own theory. However, Hazlitt does not offer a principle of natural law as to why Keynes is incorrect, but does attack his theories item by item and does illustrate most of Keynesianism can not work over time. Yet the U.S. government is still using Keynesian methods to overly dominate the present day (2014) American economy, to the detriment of America.

Here is a summary of Keynesian theories. The intent is to accurately state his theories and not alter them as a literal method to set up criticism during a counter point of view. His theories are not complicated, however he writes in a wordy style, but that was typical for an English academic of his time.

Keynes last chapter (24) of his 1936 master piece, “The General Theory of Employment, Interest, and Money” begins, “the outstanding faults of the economic society in which we live are its failures to provide for full employment and its arbitrary and inequitable distribution of wealth and income”, he further says the income tax is the best solution along with the death tax to suppress too much income. Plus, he notes the objective of the taxation is for “measures of redistribution of income”.

Keynes rejects classical economics (a free economy by free individuals) and offers a new theory of governmental control. He says, “the weight of his criticism is against, laissez-faire” in chapter 22.

The Keynesian hypothesis of what makes a given economy operate is its source of spending from:

### Individuals;

### Business;

### Government; and

Foreign (export).

And without this spending there is no economic activity per se.

The detriments of the economy are:

### Savings;

### Investments;

### Consumption; and

Interest rates of borrowing.

His theory is to use external government authority to alter the outcomes of economic events.

He says in, chapter 4, quantitative science is in a conundrum and can not establish a “unit”, comparison of many economic events and therefore there are, “no solutions”. He means, no solutions from the scientific (natural science) point of view because natural science is in units.

In chapter 12, he states “it is usually agreed that casinos should, in the public interest be inaccessible and expensive. And perhaps the same should be true of the stock exchange”, where he suggests speculation is bad for the economy as speculation is a source of instability.

In chapter 14, Keynes states the base premise of his theory as a rejection of an economic system which has balance, or equilibrium and a natural balance is impossible. Much of his book is stating the facts of the condition of the great depression (the time of his writing) are the evidence of how an economy is void of progress bogged down and out of balance.

Money printing as a solution is prefaced in Chapter 13, “we are tempted to assert that money is the drink which stimulates the system to activity, we must remind ourselves that there may be several sips between the cup and the lip.” Clearly this is his theory's position where printing money is the solution to improve an economy. Since the Keynesian theory postulates and economic system can never be in equilibrium, then permanent and on-going government money printing dumped into the economy is necessary which is referred to as stimulus. He argues against the gold standard claiming the wealthy have an advantage in accumulating gold and silver making easy access to money difficult for the average person. Politically it is easy to attack the rich, and by ending a gold standard the door is open to printing money, referred to as stimulus, which he calls the “drink of stimulus”, which is very similar to what the American government calls it today. Linguistically, a theory will use words people tend to agree with as opposed to unpleasant or harsh terms. The fact is, unearned money, just printed for no reason, not related to documented economic activity is plain old fake printed money. It is fair to say Keynes's theory is predicated upon money printing. No one likes a theory which says fake money is the solution so the word stimulus is used by Keynes, but stimulus simply means printing unearned money. However, it is important to understand Keynesian theory is based upon the premise where economics as a system which is unable to balance can be moved to stability by printed money as the artificial counter balance enabling full employment to occur as much as possible. His theory says the source of jobs is from printed money.

The theory begins with the failure to balance as a principle of observation, giving way to the necessity to counter balance the imbalance with a solution using a vehicle of artificial unearned money as the input. In Keynes's mind then the output from fake money is full employment as a result.

His theory is the economy is moved by spending from four primary sources, individual, business, government (domestic) and foreign, where foreign means spending in the form of trade. The solution is to artificially cause an external increase in money and add it to the spending system and as a result a change in something will occur, which is the outcome of more jobs will be caused to come into existence as a result of printed money. Then, artificial spending=more work; is the basis of the Keynesian theory.

The printed money (stimulus), is expected to increase demand by consumers, as consumers demand more by the act of purchasing more (to spend the printed money) then economic activity must increase due to the input of artificial currency being printed. The Keynesian theory is, spending drives the economy as the “prime mover”, and if spending is stuck, as he believed it was in the 1930's, then price changes could become rigid and to break the jam up putting stimulus, (fake money), into the system would effect a change upon the “the system” by the “prime mover” of artificial currency.

It is important to note, at the time of Keynes's theory there was very little government debt, not like now. During the Great Depression, the USA was only 16% in debt. Then Keynes's little sip of government deficit, as that is what he means by increasing spending, is synonymous with an increase of government deficits, which is to literally print fake money, and because there was very little government debt in the 1930's slight debt did not seem harmful. He literally meant a little sip, perhaps giving him the benefit of the doubt because there was so little debt at the time. Also his observations were prices were not changing because during the depression activity, transactions, were actually very slow to change and in fact there was seemingly a truth to the rigidity he observed. It would be interesting to show Keynes today's world where most of Europe is 100% in debt to their total output, along with the USA which is over 100% in debt and unbelievably Japan which is 230% in debt all have a growth rate of essentially zero. The zero growth is exactly what Keynes was fighting against. Would Keynes go along with this if he could see the result?

Keynes accepted on-going inflation, the depreciation of personal assets, which he understood would happen, of the average citizen as the price necessary to bring a rigid economy to anteing up some loss of wealth to buy jobs and to sell his theory. In addition to his theory in what is supposed to be an academic theory he also took shots at European's royalty of Lord's and Barron's who he says have hoarded tons of gold and silver in their coffers and therefore lets pry some wealth loose from their selfish possession. This is a very European view as there are not any royalty (Lord's nor Barron's) in America. This point is only noted because as Keynes wrote, he also mixed in an abundance of socialists base, “worker”, phraseology to further his marketing perhaps at the expense of some stronger facts. However, he was selling his view so he is given his academic freedom to convince his readers, which he apparently did given the wide spread application of his ideas.

This fairly represents Keynes's theory as accurately as possible and as briefly as possible for comparison purposes to an alternative view from the natural science analogy of physics to economics. Keynes's thinking is the essence of social science and the present subject mater is diametrically opposed to this thinking and is based on natural science, not social science.

### The Physics View

To increase the wealth of the USA as an objective there must be an origin of the cause, which affects a solution as an effect which are methods of natural sciences as the branch of physics. The present subject mater is advocating the use of natural science, as opposed to social science, as an additional method of solution generating a new reasoning process to the current economic challenges America faces and which are in full rejection to Keynesian theory. This is why the intention is to accurately reflect Keynes and it is helpful to enable clarity of differentiation so the physics comparison is clearly proposing a hard disagreement with Keynesianism.

The natural science branch of study of physics is based on reality principles or physical laws which are derived from observations, repeatable experimentations, established laws and truths and formulated in mathematics to understand the interactions of the world of matter, mass, force, space, and time. Importantly, physics methods have a starting point and an ending point which are the initial position (beginning) and final position (ending). Physics is a reasoning process of concepts and formulas which seek to answer the initial position of something which resists being moved, then does in fact move to a new position; where the final position occurs. Then a cause is always from an origin, which is the “prime mover” in physics as measured in energy in the complex unit of a joule, (force multiplied by distance), which contacts the natural world of mass with force (force net) than the force is resisted, (and it is very important to grasp the concept of resistance to force), by counter force and additionally by friction as a force of friction, when the total summation of force or net force with a notation of the summation of force as (Σf) is the event of the cause. When mass moves the cause of the movement is the summation of forces, meaning the cause is the summation of force, which has an origin. Importantly, the cause always comes first and this is not reversible. The ancient Greeks (Aristotle) used the phrase of, “prime mover”, and it is still used today. The “prime mover” might be an easy way to understand the origin which is responsible for the cause which comes first. As the force moves the mass and causes acceleration moving the mass (a change in position) occurs by the change in velocity (speed with direction) divided by the change in time it is the acceleration, the change in position which is the effect from the force; then the effect is second in the order of time of cause and effect. The cause is first and the effect is second when the only way the cause has the capacity to be a cause is because the cause is energy, then:

Origin→energy→force←counter force←friction→=summation of force (Σf)→=mass multiplied by acceleration (the effect 2^{nd}). (Cause 1^{st})

This is not reversible where the effect can not be used to generate the energy. A cannon ball once shot can not be re-shot of its own accord. The cannon ball in flight is an effect. An attempt to shoot the cannon ball faster or to shoot a bigger cannon ball would never be applied to the ball when it is in flight because the ball in flight is an effect and the effect comes second. To adjust the ball in flight is to first go to the cause which happens first, in this case the cause lies within the capacity of the cannon and not the ball.

Natural science thinking and the methods of physics resulted in the modern age of humanity, the machine age, including the digital age, with flight, electronics, computers, medical cures, which are all a result of the application of methods of natural science, and particularly with the application of the principles of physics, which are laws and principles of the natural world. Then these methods should also be applied to economic thinking.

Comparing a natural science reasoning process such as physics used as an analogy to economics to the social science thinking of Keynesianism is a comparison of the principles of truths and laws of natural science to a social science based on wishful thinking of what would be desired, but not based on fact. Keynesian thinking is not based on facts. Even Keynes said (paraphrased) too large a portion of economics are merely concoctions of a maze of pretentious and unhelpful symbols (see chapter 24) meaning he does not like mathematical derived conclusions. An airplane flies on those pretentious little symbols and so goes the modern era by use of those symbols as well. It is time for natural science to throw a few more symbols into the game, particularly the symbols created by Newton and then built up and expanded upon by others, which still others have moved forward since.

Natural science has principles which establish a discipline which must be followed to effect an outcome within the confines of the natural world. The theory must conform to the principles and laws or the theory is flawed. To illustrate how Keynesian theory conflicts with the principles of natural science viewed by the physics form of reasoning see the following short list of a few laws of physics. This list is abbreviated for ease of use and it is a very short list as there are many laws of physics and some with lengthy descriptions. The purpose of this list is to compare some basic laws of physics to the base concept of Keynesian theory.

A short list of a few commonly accepted laws of physics are:

1. Something can not be made from nothing
2. Something can not be turned into nothing
3. Every effect has a cause
4. The cause comes first then the effect comes second in the order of time
5. The order of time in the cause and effect are not reversible
6. Newton's first law: an object at rest tends to stay at rest. An object in motion tends to stay in motion.
7. Newton's second law: the summation of force equals mass multiplied by acceleration
Σf=ma (the force on an object equals the product of the objects mass and its acceleration)
8. Newton's third law: a system can not exert force on itself because forces in the universe are equally opposed—every force is opposed by an equal counterforce
9. The change in energy=work done
10. The external change in energy a system through outputs heat plus work done
11. Everything in the universe must balance
12. Two objects can not occupy the same space

These are a few (very few) principles of truths, laws, in the observable world which have never been observed to the contrary, although the abbreviations herein may be a little too brief, but the objective is for ease of use.

The natural science view in the application of physics as a reasoning process is a given theory must conform to the laws and observable principles and the restraints of natural law and to adhere to these laws, and truths can not be broken or the theory can not be valid. To lift 10 kilograms straight up against the force of gravity requires force greater than the 10 kilograms multiplied by gravity. Acceleration can not occur unless first energy using force actually contacts the mass where in the order of time the energy is first then the effect upon the mass or system being accelerated over distance occur secondly and therefore the process of energy first as a cause and acceleration occurring second as an effect from the cause can not be reversed in order of time. The effect can not go back and generate an originating energy. The cannon ball at rest, in a field after being shot can not on its own go back to the cannon and cause the cannon to do anything.

Using the laws of physics (or physical laws) as a guide as an analogy of physics to economics concludes the following theory does conform to the laws of physics. The origin of economic growth is derived from energy which can not be either created or destroyed and the energy is generated by the generation of electricity plus fuel burned as the initial cause of applied force as force push which is counteracted upon in economics by reactive forces such as expenses caused by governmental policy as the counterforce to force push and force push is also lessened by force drag of friction due to the force of gravity which in total is the force net (the net cause) or the summation of forces (Σf) which by contacting mass the system of ownership entities, as the (Σf) then moves the ownership to a change in transaction where movement is an acceleration of transactions as an effect from the originating cause of the generation of energy where the production is owned by free people and the change in ownership (consumption) divided by the change in time is acceleration which eventually goes to some place in space (distance). Then this conforms to the units of physics as exampled in international “SI”, units as energy=kilograms multiplied by meters²/seconds² (joule). Where the energy comes first as the cause and the change in ownership as an output in transaction comes second as an effect. The change in ownership as a transaction is a change of a change in transaction rate divided by a change in time (Δ(Δtransaction/Δt) is acceleration which is of and or related to the transaction is then the physics analogy of acceleration and acceleration is an effect and the effect results in growth. To grow the economy is to accelerate it. This is a law of physics.

An effect can not be altered unless it is from a cause and the cause must be from the origin of energy. There can not be an effect or an altered effect unless from energy which uses force. Then the net force or summation of force (Σf) is what is necessary to enable the effect to exist.

Value is an effect where raw material is moved from its natural state to an altered processed state. The change in value between the natural state and processed state owned by a free people is how wealth occurs. Service businesses or service transactions are neutral value creators, service does not create value, its function is to distribute generated value from production.

The formula in the economics analogy is:

Electricity generated+fuel burned (1−fₜₐₓₐₜᵢₒₙ−f_{government debt}−f_{cost of unemployment})−μmg α to the number of ownership entities multiplied by the change in the transaction rate/the change in time)

Written formula as:

Fp(fₜₐₓₐₜᵢₒₙ−f_{debt}−f_{unemployment})−μmg=number of ownership entities (Δ(ownership rate/Δt)

This is a completely different process of economics versus Keynes' theory. The premise of the physics view is energy is the cause and it is first in the order of time. The “prime mover” is energy in the physics view as there can not be change in the natural world unless with the application of force net as a positive is applied force (assuming moving forward) occurs. Keynes' “primes mover” is either printing money, lowering interest below its natural state, or government borrowing creating government debt to use to stimulate economic activity all of which are forms of printing money. Printing money to use as an origin of a cause violates the laws of physics. Printed money is nothing therefore it can not be something. It is not energy so it can not be a cause. Fake money can not occupy the same space as actual money as printed money is not energy it can not cause an effect to stimulate anything, either demand, wage, or a change in employment. Keynes' theory is to stimulate demand via unearned money just made from nothing. This violates the laws of physics because demand is an effect from a cause and an effect can not be stimulated as an independent event only a cause can change the effect and the cause must be energy. Stimulating demand also violates the time order of cause and effect as the effect comes second. The effect can not be stimulated (assuming a change in position). The cause comes first only a cause can alter the position of the effect. This means to change demand an actual cause derived from an increase in the summation of force must occur first. Note, the objective is to make the nation more wealthy and everybody in it, not make the money printers rich.

In physics to effect demand is to either increase force push (increase energy) or decrease the counter forces (decrease taxation, decrease government debt, and decrease the cost of unemployment in some combination) or both increase force push and simultaneously also decrease counter forces or reactive forces. Keynes also advocates a low cost capital theory. This violates the laws of physics as capital is physical and controlled by the counter forces of gravity and friction as force drag and gravity as a force of gravity. It takes energy to mine, ship, load, and unload iron ore. The essence of capital is physical. This also violates cause and effect as it takes energy to move mass and there is not any way to move mass with less energy without invention. A railroad moves mass cheaper than men with a rope. Once the railroad exists then to use less energy would mean to use less energy than the railroad, which can not be done today. An artificially low cost of capital is also essentially printing money which is a violation of physics if the theory is printed money is something other than nothing. Nothing can not be something, therefore printed money can not move mass. Keynes central objective is full employment. Employment is, “work done”, which is an effect from the summation of force external to the system. This violates physics as the employment is an effect from the origin cause of energy and Keynes offers nothing in his view or theory using energy as a cause to effect the outcome of full employment. As unemployment is an expense, giving assets to the unemployed is a counter force not a force push. Keynes is correct for advocating full employment, but full employment exists because there is sufficient force push to allow it to exist. To be a force push is to be energy. Keynes advocates using debt from government borrowing or printing money as force push to obtain full employment, which actually does the opposite. Debt is a counter force and printing money is nothing, neither can effect a change of position (fake money can not cause a change in demand) or that which resists change as everything on earth does. However, fake money put to use by the power of police decree lowers the value of stored wealth (taking assets from those who saved). Something which resists change is mass and the mass can not change position without being forced and nothing is not force and fake money is nothing. A 100 kilogram stone can not move with zero force applied.

Employment is work and in the laws of physics work is the change in energy equals the work done, plus heat. It means to have work (increase employment) then the summation of force must increase (assuming the objective is to increase employment). A decrease in domestic energy would highly likely decrease work (cause un-employment), unless some super efficiency was introduced. America exporting coal, oil, or gas is the absolute worst action America can engage in. To export energy is to bleed the patient.

Employment can not be a central theme of economics unless it is simply as a political objective where the political sympathy outweighs the truth of the theory. Employment is an effect from a cause. Energy can have multiple forms and any of the forms can cause an effect. Height is a form of potential energy. Hydroelectric generation creates jobs because it is energy and is derived from height which uses the force of gravity to push water to move mass via electricity. The force of gravity conforms to this law of physics where printing money does not. Printed unearned money is not a form of energy.

Keynes rejects the physics observation that a system can not move itself. To change work (cause more jobs) energy from outside the system must occur. Printing money is inside the system and can not effect change. One can not do a pull-up by grasping the air (Newton's third law). The observation is in natural law, in the law of physics is forces always has a counter force, otherwise the universe would blow up, the earth would spin into space, what goes up would just keep going and so on. The machine age is based on the balance of force, air planes fly based on the balance of force, the balance of force is a dominating observation and to say the economy does not balance, can not be, in the laws of physics, and such a theory which rejects this basic physical truth is unlikely to be valid.

Why does Keynes propose a hypothesis as part of his theory where there is an economic world existing in an ongoing (perhaps permanent) state of imbalance, disequilibrium, and or position which is stagnant, unable to be effected via the normal inputs of classical economics, which expect a normalization to occur, as forces balance? Keynes is observing the Great Depression and concluding that his observations are seeing a state of humanity where there is a natural propensity of humanity to be in a predicament of stagnation, decline, unemployment, and there is an inability to be in an improved position of general betterment. What he sees is in fact at a segment of time (1930's). However, he has neglected to ask the critical question of how did the Great Depression occur, or why are economic conditions the way they are? There was a rapid change beginning in 1929 of a decline of valuations of stocks and tangible goods, so rapid the financial systems and the associated institutions had a strong percentage of failures and the demand for goods harshly, quickly declined. The USA's stock market declined approximately 90%. Keynes never asks why. Or perhaps he does not care why because the answer to, “why”, conflicts with his theories. No one knows why he neglected to question the cause of the Great Depression.

In physics, a change of 90% is an effect. Then the effect must have an origin. Something caused the rapid change in stock prices to decline 90% and in physics the 90% change is actually part of the answer to solve for the origin as the effect is on one side of the equation and the cause must be on the other side which means the problem is solvable. Then a cause which had an origin which resulted in an effect is not an imbalance. To the contrary, a cause and effect is precisely an equilibrium, when the quantity of the cause is equal to the quantity of the effect where energy in, equals energy out (less friction).

The 1920's, the immediate post World War I period, then had force push from the energy generated to enable the war production. A newly formed federal reserve further contributed to excessive borrowing which is a force push not from energy, but from stored wealth by allowing the asset to borrowing ratio to be 1:10 for stock purchases. One dollar down allowed ten dollars' worth of stock purchases. This generated a highly leveraged 1920's (roaring 20's) to use stored wealth as a force push to accelerate the economy beyond its ability to process natural resources to keep pace with the rise in prices. The rise in prices was from a balance to the input of 10:1 leverage. It was an imbalance. A temporary imbalance is natural as the imbalance is always corrected by counter forces bringing whatever is imbalanced back into balance or equilibrium. As 1/10−1=−90% then the leverage of one dollar of assets to ten dollars of debt is a 90% change from borrowing. The asset to borrowing ratio was the cause of the imbalance of the 1920's, but since it was the get rich quick side of the imbalance no one complained or no one chastised the government for money printing because money was increasing. Keynes neglects the 1920's entirely. Then the unnatural 90% upside of the 1920's inevitably balanced from an overage of +90% to a correction to the overage back into the state of balance of a negative −90%. It took time for the 1920's to run up with particularly (WWI) as an additional force push plus the high leveraging then the laws of physics would suggest as an outcome of a 10 year 90% dip is necessary to balance out the 1 to 10 asset borrowing ratio, which lasted 10 years on the upside. What Keynes observed in the 1930's was precisely a balance: an overblown negative side to an overblown positive side. A law of physics exhibition in action describing the economic environment exactly how physics should describe it. Keynes' interpretation of the Great Depression as an imbalance being permanent in time. The physics lesson is that not only is there always balance in the real world, the upside debt push of the 1920's fairly, accurately, describes the down side take back: 90% up, 90% down, ten years up, ten years down. Keynes never calls into question those parties responsible for allowing the irresponsible levels of (the borrowing ratio) debt written into the financial laws. He blames the markets, calling them “casinos”, where the markets accurately reflect the design and quantity of the input versus the output which the government set at a 1:10 asset to debt ratio. Too much input in the 1920's was measured correctly to almost mathematical perfection by the corresponding reduction in the 1930's. The markets are not casinos, the policy makers allowing an asset to borrowing ratio of 1:10 caused the problem of the change in value equal to the ratio of assets to lending. This means the borrowing ratio equals the volatility.

As a brief digression, a point of observation of the asset to borrowing ratio which the federal reserve sets, learning from the mistake of the 1920's, the stock to asset borrowing ration was reduced in the 1930's to 1 dollar can buy 2 dollars' worth of stocks or 1:2−1=−50% change. Then, as expected in the post-world war II era volatility experienced in down markets mirrored closely the 50% losses experienced during down markets and then taking 5-10 years to recover. Not enough of a decline in asset valuations to disturb or damage the financial system in general. The present day commodity asset to borrowing is currently 1:20 or a 1/20−1=−95% change. Given that commodity supplies on earth are known quantities with very little expected change in the annual amounts of delivery then how can commodity prices have 95% volatility behavior? The cause of the volatility is the quantity borrowed versus the actual asset. There is a very clear cause (borrowing) and effect (volatility change) where the asset to borrowing and market volatility are approximately similar. The real estate volatility was caused by, “nothing down”, mortgages resulting in a rapid increase in debt followed, as the laws of physics would expect, a rapid decrease in value of home prices occurred in 2008.

When he offers a solution of printing money expecting it will make an aggregate improvement (can not make something out of nothing, a violation of the laws of physics) it is a fake expectation as printed money can not increase wealth as wealth is a form of energy and printed money is not energy. Note, the analogy of using the laws of physics to fashion cause and effect of economic change is an analogy. Printing money and thinking something occurs as a cause is breaking the laws of physics as a natural science, as nothing in, must, equal nothing out; then artificial money as an input can not possibly cause something out. This is not an analogy to physics, but actual physics. Zero force applied can not be a cause and can not result in and effect. Much of economics is actual physics. Tons of ore moved distance in time is physics. Ownership of the ore is a social contract.

Keynes believes the source of economic activity (he does not use the term motion) is (in his theory) spending from four main sources:

1. Individual spending

### 2. Business Spending

### 3. Government Spending

4. Foreign spending as a result of trade

Spending can not be a cause in physics. Spending is part of the effect from a cause. Spending is an effect from the origin cause and without the origin cause, energy, then there can not be spending as there is nothing to spend. A theory must conform to the laws of physics or it can not be correct. A poor country just can not declare government spending and then expect a result. The pilgrim could not simply declare a pilgrim government and start spending fake money and expect an actual effect. Driving home the truth of this point are actual examples which have been tried and fail 100% of the time which is a proof of existence. Debt is taken from stored wealth and if there is not any stored wealth then borrowing can not occur unless the borrowing is from an outside source. This is what the international monetary fund does, it acts as an outside source of stored wealth enabling poor countries, (without stored wealth), to borrow. Spending can not be a cause; therefore spending can not create a change in the effect. To change the effect means the cause must change first and the cause is energy. Then to effect spending requires a change in the summation of force. The input of energy caused the existence of wealth resulting in possession of stored wealth. To spend is to take stored wealth and it is used to consume. To borrow is to take from stored wealth.

To obtain wealth in the first place is from the cause of force push being greater than the counter forces and greater than force drag which changes raw materials to finished products. This is the change in value of raw materials to finished goods which is where wealth, accounted for with money, comes from.

The attempt to alter the effect (spending) is treating the symptom and not the cause. The origin of wealth is energy; energy comes first. To say the economy is driven by spending violates the laws of physics as the time order of cause and effect is not reversible. Spending can not go backwards in time and create energy, as spending is an effect.

An additional problem is government spending is included as one of Keynes' sources of spending. This violates Newton's third law. Individuals can have stored wealth which they can take and use to consume (spending), but the stored wealth originated from applied force. Similarly the same is true for business and business involved in trade from a foreign source. However, government does not possess any stored wealth. When government spends it is because it took stored wealth from the people which is a subtraction from both individuals and businesses. Businesses have less than what they earned because government took from the business in the form of taxation. Taxation is a counterforce to force push and Keynes is saying a counter force is a force push which it is not, because taxes are not energy and are reactive opposing force push. Taxation is not an input to production. Roads and schools built were not paid for by government, but were paid for by the changes in value which occur when raw materials are processed into finished goods in the time order of cause and effect when the origin is energy by business production. Government is not the origin of wealth because government is not energy. Business is the origin of wealth and business built the roads and schools.

Another Keynesian view is he is anti-savings, anti-frugality. Is this view a smoke screen to the consequence of government intervention into the economy? When the government spends, either by money printing or by borrowing it generates a counter force for force push. The ability of unearned fake printed money to cause mass or the system to move is because the value of artificial money is from using stored wealth. As a consequence, the value of personal savings and business savings, (stored wealth), which are cheapened, and lessened, by the very act of government deficit spending (government bonds) and or government printing money via stimulus or any other form of subsidy which is a subtraction from the people's stored wealth. Everyone's stored wealth is taken via government spending, the tinker, tailor, teacher, fireman, mom, child's savings for college, all have their wealth depleted as artificial dollars shrink stored wealth equally. Nothing can not be turned into something; this is a law of physics. The ability of government spending to cause action is derived from someplace; the someplace is your bank account and your assets.

Philosophically, there are other concepts of Keynesian Theory, which are rejected by the theory where liberty (freedom) is economically superior to an un-free society. He advocates an un-free society, rules by an un-seen group. Keynes specifically advocates having individual income and the value of personal savings controlled by an unseen group of controllers, where he never mentioned exactly who the controllers are, where the takers of income live and what they do with the peoples taken assets after the assets are taken.

Keynes is saying the economic policy driver of society is full employment. However, employment is an effect and an effect is not the prime driver: energy is the prime driver. Consider Newton's law of motion. Newton's first law of motion is an object continues in a state of rest or in a state of motion at a constant velocity in a straight line, unless compelled to change its status by a net force. The reader has learned a net force which assumes a forward movement is an applied force which has an origin from somewhere, when the origin is energy where the energy contacts the object with force when the force push is greater than the counter force (reactionary force) and force drag due to the force of friction and force of gravity which will cause (happens first) the object to change its state of motion either from rest or from the objects present state of motion. What the net force does is Newton's second law. The first law is saying to alter the object's motion requires a net force. The second law says the acceleration of the object is in the direction of the net force, the acceleration has a magnitude proportional to the (cause) magnitude of the net force, and the magnitude of the acceleration is inversely proportional to the mass of the object, (a big objects takes more net force to move versus a smaller object). The second law then has the formula of the summation of force (Σf)=mass multiplied by acceleration (Σf=ma).

Newton's third law is in “forces” where when one body exerts force on another body the second body exerts an opposite and equal force in magnitude against the first body. The baseball hits the bat with the same force as the bat hits the ball, but the ball flies out as a home run because the mass is proportional (the ball has less mass than the bat). If the baseball was a ton of lead then the batters bat would cause little effect on the greater mass of the big lead baseball and the bat would be irreversibly deformed.

Then to increase employment in natural science as viewed by physics, while following Newton's laws would mean to change the effect of employment a change in the cause must happen first.

To employ is to do work which requires energy as the change in energy=work done. To create wealth is highly proportional to applied net force being in a forward direction. Only the net force (Σf) being greater than the opposing force can the value come into existence to justify a job. It takes more energy to employ two than it takes to employ one (assuming equal production per worker).

If the objective is to employ then the cause of employment is a positive net force when the effect from the summation of forces (Σf) is a result of employment where employment is an effect. To alter an effect is to first alter the cause, the cause is first and the effect is second in the order of time and this is not reversible. Then the origin of employment is from energy which is of the physical world as a force push from electrical generation plus fuel burned is of the physical world. If the environmentalists do not like the fuel burned part then there are many easy solutions. However, one solution not permissible is giving American domestic burnable efficient fuel to competitors because competitors will use efficient coal to put America out of business. It is better if America burns it first to America's own advantage.

There is an enormous amount of potential, gravity based, energy available in water moving downhill, particularly in the USA, due to the force of gravity which pulls for free. However, the true origin of competitive advantage is the upfront expense of generating energy. The efficient (least cost, least maintenance) generator of energy (energy is not produced it is generated) is the winner of the global competition assuming the availability of the raw materials which are processed into goods of value, where the value of the finished goods are greater than the value of the raw material and the finished goods are superior to a foreign produced finished good.

Then to employ is to first generate energy then minimize taxation, (eliminate income tax), bring government debt to a permanent zero forever, also via social science have businesses partially absorb full employment in exchange for zero taxes and minimized regulation, maximizing the summation of force then the result is the effect of increasing force push, reducing counter forces which results in greater net worth because what happens on one side of the equation must happen on the other side. To increase the cause will increase the effect in the laws of physics in the natural world as well as in the analogy of physics to economics.

Keynesian policies actually decrease net force, therefore can not possibly increase the effect. In the physics to economics question the effect is wealth. Keynesian policies cause more unemployment because the summation of force is lessened. To lessen the Σf then one must lessen national wealth. The Keynesian equation is to decrease the cause=an increase in the effect: this is not possible; a decrease in cause must always decrease the effect. The correct answer is to increase the cause which=an increase in the effect. The effect from the cause, (energy), is wealth and employment as employment can not occur without wealth.

Wealth is a result of something which causes wealth. Employment is a result (as an effect) of something which causes the need to do work. In physics, as Newton explains with his laws of motion, the net force (assuming it is positive) is necessary to alter that which has a constant velocity or is at rest (sitting still) to change velocity. Iron ore in the ground is a rest. To move it, to mine it, is to make a car and that takes energy. If then unemployment is stuck at 9% for example, then to move (increase) it to 5% (meaning more people working with legitimate accounting) without going into debt, or without decreasing stored wealth can only be accomplished by an increase in force net, (Σf). To increase force net in economics requires either more energy to be generated or the reactionary counter forces (taxation and the cost of unemployment) and/or other independent counter forces such as government debt must be reduced or eliminated or both.

Keynes completely neglected the origin of change which is first in order of time and is the cause of change, which is the applied force derived from energy being greater than the opposite and equal force from the resistance of mass within the system, which must be accelerated enabling a process to create an external output from the system to cause work and wealth to occur. Keynes never once considered lowering taxes or government spending. To the contrary, he proposes as a solution which is part of the overall plan of an income tax which is purposefully designed to surpass the increase in wealth. In the reasoning process of physical science, taxes are a counter force to a rich society.

Keynes writes as a citizen of constitutional-less state (England), ruled for most of its history by a Royal family and as such he has very little consideration for individual rights. Europeans have never had free speech, or mineral rights to their land, or the right to bear arms. Europeans are poorer than Americans because they are less free. He sees individual property as all up for grabs to suit his vision of economics. He also never mentions who the new ruling class will be. Their names, addresses, are missing yet the new rulers are the ones receiving the income tax which others earn and the new rulers are the main recipients of the printed money. He neglects to chastise the new rulers for hoarding tons of gold, he just does not like the old rulers. It is never clear when income is being suppressed, exactly who is doing the suppressing and exactly who is receiving the income taken from the income earner. Perhaps the reason so many governments find Keynesianism desirous is it allows for the increase in government compensation to seem more legitimate. Keynesianism can not make a society more wealthy, just more in debt, but it can certainly make those who receive the taken money from the people richer.

What does allow a society to change its wealth from an initial position to a greater changed position: an increase in net force.

### XVIII—the Physics Analogy to Economics

### A Summary and Position Final

It has been common throughout the study of physical law to base a theory on a process of the use of analogies. The analogy is a link by logical reference of the similarities in function of things known to be altered. Economics is of the physical world and reacted to by human society. Society must follow the principles and truths which constrain the natural sciences then agree to further constrain the natural world to some form of social orderliness.

A premise of the present subject mater is energy in necessary to either establish or change motion. In economics, the premise of the present subject mater is value is the change which occurs when natural resources change state, in various form, but never the less change state. As iron ore to steel, wood to house, soil to row crops, flammable to burn, and so on. The alteration, the change of state, the change in position is caused by the application of energy as an applied force. There can be large numbers of social science societal design constructs, but it always takes so much force to move so many kilograms so much distance in so much time. There is not any social science construct which can avoid the laws, principles and truths of physics. Then, important to the societal construct based on the field of social science as a design there must be conformity to the natural science of physical law, if there is an objective for the betterment of the human condition based upon the ever expansion of the increase of wealth.

Economics as a concept should also have a calculation method, just as energy as a concept has a calculation method. Then physics to economics is the melding of physics methods to economic problems. Physics is conceptually in definition of energy, mass, distance, time, space, velocity, direction, temperature and calculated in units of commonly accepted SI units of kilograms, meter and seconds. Applying the concept of physics to economics is to redefine the definition of economics, wealth, capital, debt, trade, taxation, and social expenses into an analogy definition similar to the concepts of natural science. Then motion in physics is energy force, less counter force, less natural counter force=the summation of force when the summation of force contacts the object as mass and increases the velocity of the mass when the mass maintains its form, but changes its behavior by changing its position from an increase in velocity which occurs in time. Then the analogy of physics to economics is the force applied via electricity plus fuel burned as the applied force which is counteracted upon by opposing users of energy such as taxation, government debt, at the cost of unemployment and also force drag of the material world as gravity and friction, which equal a summation of force, (Σf_{Economic}) or (Σf_{E}). Then the summation of force economic contacts the system (the object of study) of ownership entities of free people will change the velocity (speed with direction when the direction is assumed to be positive) of the change in ownership as the change in the transaction rate divided by the change in time.

### Physics

Fp(1−factors of counter force)−μmg=ma (the change in position of the mass via the increase in velocity in a change in time).

### Economics

Fp(1−factors of counter force)−μmg proportional to (α) ma

When the mass, the object of study, is the ownership entities of a free people with a change in velocity divided by a change in time.

Physics→Fp(1−f₁₂₃)−μmg=ma

Economics→Fp(1−f_{tax, debt, unemployment})−μmg α ma

Where:

Wealth=Kinetic Energy (KE)(½ mv²)

Cost of Capital=μg (friction multiplied by gravity)

Capital=mass

Government Debt=counter force (independent)

Taxation=counter force (reactive)

Cost of Unemployment=counter force (independent)

Where unemployment is not necessary

Trade=is a force push if positive and a counter force if negative

(Fp(1−fₜₐₓₐₜᵢₒₙ−f_{government debt}−f_{cost of unemployment}+/−f_{trade})−μmg=Σf_{E}

To expect is to discern and effect. To have an effect there must be a cause, in the physics to economics view. Then the physics view rejects the modern portfolio theory concept that the expected rate of return (ERR) is based upon markets and government debt.

The physics expected rate of return is an effect from a cause of the summation of force (Σf_{E}) where the expected rate of return is proportional to the summation of force_{economic} (ERRαΣf_{E}) when the system as a constant is the average velocity multiplied by the change in time divided by the initial kinetic energy: (K=(ũΔt)/KEᵢ

The change in energy (ΔE) divided by the initial energy (KEᵢ) is proportional to growth as a percentage ΔE/Eᵢ=growth. Then force multiplied by distance (Σf(ũΔt)/(KEᵢ) α growth

=ERR

Σf(ũΔt)/(½ mv²)=ΔE/Eᵢα growth=ERR

To have an effect as an ERR necessitates a cause derived from the origin of energy. Then the ERR is of energy as wealth is of energy in motion or kinetic energy (KE).

Employment is work done. To increase employment without shrinking the value of the system requires external applied force to the system where the output is work done plus heat. The heat occurs as motion occurs so as wealth is caused by the generation of energy some effect is always lost to the natural force drag of friction which results in heat.

Think of the economy as a balloon filled with air and as the air is let out in such a way as to enable a pin wheel to spin, the spinning pin wheel is work done, but notice, (observe) the size of the system (the balloon) shrinks. The balloon shrinks because the stored energy inside the balloon spins the wheel, thus depleting the stored energy of the system, making the system smaller (poorer). There must be external applied force as an input into the system to enable the system to expand where the output is due to the external input (Σf_{E}). This way the pin wheel spins without shrinking the system.

The ending of the gold standard and the beginning of the money printing is the same as letting the value out of the balloon. The fake money used stored wealth, depleting the USA of its value which lessons the relative power of America globally.

To increase the wealth of the USA is to increase the applied force derived from the origin of energy as the prime mover. Spending is not energy therefore spending can not be the prime mover. The pilgrim could not have become richer by spending as spending without earning first is simply a use of stored energy or stored wealth. To become more wealthy as a nation is to increase the summation of force_{Economic} (Σf_{E}), by either increasing electricity generated plus fuel burned, or by lessening the counter forces to generated energy which are predominately taxation, government debt, and the cost of unemployment, as there is not any reason to have unemployed, or do both, simultaneously increase energy generated and also lessen taxation, eliminating government debt and nearly eliminating the cost of unemployment.

Table 5 set forth below summarizes many of the concepts and applications described herein.

TABLE 5
The First Principle of Economics Process of Input to Output
The process to increase the wealth of the USA
Increasing the Wealth of the American Economy
How to cause an expected rate of return of an economy

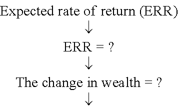

Applying natural science of physics as prinipals of truth
↓
To cause a change there must be a change in the input to the alter the output resulting in a
change assuming and increase, assuming that which is being accelerated is fairly constant
↓
To change requires a cause which results in an effect
↓
The effect is an alteration to the object of study where the behavior of the object changed velocity
↓
This means the cause is first
↓
Than a result occurs secondly
↓
Than additional results happen thirdly
↓
Cause and effect follow a natural science order of time where the cause is always first and the
effects are multiple and occur secondly, even if instantly
↓
This process follows the natural science principals of truth of the laws and concepts of physics
analogous to economics

| | |
|---|---|
| | Economics |
| Physics | Economies are an analogy to Physics |
| What constitutes a change in an objects velocity | What constitutes a change in Economics |
| according to physical law | (the desire is to increase wealth) |
| Physics determines where something must | Economics using the physics reasoning |
| always equal (balance with) something | process is a proportionality when something |
| an action = another action | is directly proportional (α) to something |
| There must be a cause, first in the order of time to | There must be a cause, first in the order of |
| result in a (positive) change, to make a gain | time, to result in an expected gain where the |
| where the gain is second in the order of time | gain is second in the order of time |
| The cause comes first | The cause comes first |
| The result comes second | The result comes second |
| Physics | Economics |
| Newton's second law of motion | Newton's second law of motion |
| Summation of force = mass multiplied by | as an analogy to Economics |
| acceleration | Summation of force α the economy of |
| Σf = ma | ownership entities multipled by acceleration |
| | Σf α ma |
| Summation of force is multiple forces which equal | Summation of force is multiple forces which |
| the summation of force Σf | equal the summation of force Σf |
| Energy applied as force push is counteracted | Energy applied as force push is counteracted |
| upon by multiple counter forces | upon by multiple counter forces equal to a |
| equal to a net force | net force |
| Energy applied as force push | Energy applied in economics is |
| counteracted upon by | electricity + fuel burned counteracted up on |
| (1 − factors_{1,2,3...}) − counter forces of nature as | by counter forces as factors of taxation, |
| friction multiplied by the object (mass) | government debt and the cost of |
| multiplied by gravity (μmg) | unemployment also counter acted upon by |
| | forces of nature |
| Fpush (1 − f_{1, 2, 3}) − friction (mass)(gravity) = | Force push (1 − factors of counter force) − |
| (mass)(acceleration) | frcition as a counterforce to production is |
| Fp(1 − f_{1, 2, 3}) − μmg = ma | proportional to the change in behavior of the |
| Σf = ma | ownership entities of a free people change |
| | velocity as acceleration |
| | Fp(1 − fₜₐₓ − f_{gov.debt} − f_{unemployment}) cost of |
| | capital, cost of maintenance, etc. |
| | α (ownership entities)(acceleration) |
| | Σf α ma |

Force Push = (mass) (acceleration)
written as . . .
Fp(1 − f_{1, 2, 3}) − μmg = ma

| | |
|---|---|
| Force Push | = Fp |
| Factors | = F |
| Coefficient of friction | = μ |
| Mass | = m |
| Acceleration to gravity | = g |
| Acceleration | = a = (Δx)/(Δt)² |
| Fp(1− F_{1, 2, 3}) − μmg | = Σf |
| x | = position |
| Δx | = change in position |

As a natural reaction of nature
due to gravity, friction
Force push = Fp = Electricity + Fuel Burned
Factors = factors of taxation, factors of government debt, factors of the cost of unemployment
Mass = m = ownership entities of a free people (the object of the study)
μmg = environmental constraints to be overcome
Acceleration = a = a change in the change of the ownership divided by the change in time
squared

| | |
|---|---|
| Physics | Economics |
| 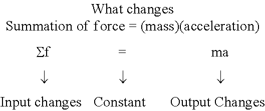 | 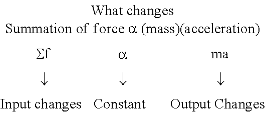 |
| 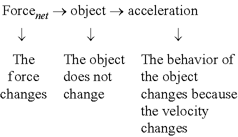 | 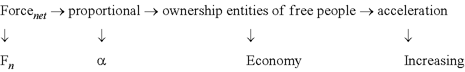 |
| To change the velocity of an object either at rest | To change the velocity of the economy |
| or already in motion the input (the net force | (assuming the U.S. economy already has |
| applied) must change, assuming a positive | motion but little or no growth than the input of |
| forward motion than an increase is the effect | force net applied must increase, assuming a |
| | positive (gain) is the objective |
| Energy must change to generate an output as | Energy must change (as an increase) to |
| work done plus heat | result in an economic gain in the total |
| A change in energy = ΔE | economy |
| | A change in energy = ΔE |
| A change in energy is noted as: | A change in energy is noted as: |
| ΔE = E_{f} − Eᵢ | ΔE = E_{f} − Eᵢ |
| A change in energy equals E_{final} − Eᵢₙᵢₜᵢₐₗ | A change in energy equals E_{final} − Eᵢₙᵢₜᵢₐₗ |
| In physics, in science, for energy to come out | In economics (which is largely of the physical |
| without shrinkage to the system than first, energy | world) to follow scientific reasoning means, to |
| must to go in | become more wealthy as a nation is an |
| Energy in = Energy out plus friction | efficient use of, “energy out”, than for that to |
| Eᵢₙ = Eₒᵤₜ + heat | happen a change in energy had to externally |
| | go in as, “energy in”, α for an economic gain |
| | out plus friction to occur |
| | Energy in = Energy out plus friction |
| | Eᵢₙ = Eₒᵤₜ + heat |
| Physics | Economics |
| Energy as a concept is . . . | Energy as a concept is . . . |
| Energy = summation of force multiplied by | Energy = summation of force multiplied by |
| distance | distance |
| E = Σf(d) | E = Σf(d) |
| Distance in physics is a dimension in space | Distance in the analogy of physics to |
| X = dimension in space | economics is the change in position of |
| Change in x = Δx = x_{f} − xᵢ | ownership. |
| Distance = velocity multiplied by the change in | For the economy to change wealth when |
| time | wealth as an output then the summation of |
| d = v(Δt) | force multiplied by the distance must occur. |
| Than Σf(d) = Σf(v)(Δt) | Distance is also the average velocity |
| Than the output as a change in energy is equal to | multiplied by the change in time. |
| the summation of force multiplied by distance | ΔE = Σf(\tilde{v})(Δt) |
| (v)(Δt) | |
| ΔE = Σf(\tilde{v})(Δt) | |
| Than the change in energy (ΔE) is equal to the | In economics the summation of force is |
| summation of force multiplied by average velocity | [Fp(1 − ftax − fgov.debt − funemployment) − |
| multiplied by the change in time | Friction to the environment] |
| ΔE = Σf(\tilde{v})(Δt) | The transaction rate multiplied by the change |
| 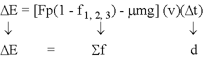 | in time. 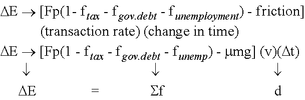 |

To change means the velocity must change.
To make a gain, move forward, or increase which means velocity is increase
ΔE = Σf(\tilde{v})(Δt)
The gain in economics is the expected return (ER) = change in energy

| Physics | | Economics | |
|---|---|---|---|
| ↓ | | ↓ | |
| 1. ΔE | = A change | 1. ΔE | = A return (R) |
| 2. ΔE/Δt | = Rate of change | 2. ΔE/Δt | = Rate of return (ER) |
| 3. (ΔE/Δt)Eᵢ | = Relative rate of change | 3. (ΔE/Δt)Eᵢ | = Expected rate of return |

(ERR)

For a positive return to occur the velocity of the object of study must change its speed.
The object of study in the economy is the ownership entity of a free people.
↓
In economics to increase the aggregate wealth of the USA requires acceleration

| | |
|---|---|
| ↓ | ↓ |
| Physics | Economics |
| The change in position of (x) | The change in the position of ownership |
| X = position | X = ownership |
| To have a change (positive) as a gain the position | To have a return greater than zero from a |
| of the x must change from xᵢₙᵢₜᵢₐₗ to x_{final} | prior period of time the ownership must |
| The change in x = | change. A change in ownership = new |
| Position final position initial | owner − old owner |
| Δx = x_{f} − xᵢ | Δx = x_{f} − xᵢ |
| That is the position of the object of study | This is the object of study which is the |
| changed its speed | ownership entities of a free people must |
| | change for a return to occur. |
| Velocity = | A rate of return is a change in return in a |
| A change in x/in a change in time | change in time |
| v = Δx/Δt | Velocity = |
| v = x_{f} − xᵢ/t_{f} − tᵢ | A change in ownership/in a change in time |
| v = distance/time | v = Δx/Δt |
| v = d/t | v = ownership_{f} − ownershipᵢ/t_{f} − tᵢ |
| d = v(Δt) | v = transaction rate |
| | transaction = v = ownership_{f} − ownershipᵢ |
| | transaction rate is a change in transaction in |
| | a change in time |
| | v = transaction/Δt = transaction rate |
| | d = v(Δt) |
| | d = (transaction rate)(Δt) |
| Acceleration is the change in the time rate of | Acceleration (a) of the economy is the |
| change of the position of x | change in the time rate of change of |
| a = Δ(Δx)/(Δt)² | ownership |
| a = (x_{f} − xᵢ)₂ − (x_{f} − xᵢ)/(Δt₂ − Δt₁)/(Δt_{f} − Δtᵢ) | a = Δ(Δownership)/Δt² |
| a = Δ²(x)/(Δt)² | a = (ownership_{f} − ownershipᵢ)₂ − (ownership_{f} − |
| a = (Δvelocity/Δtime) = Δv/Δt | ownershipᵢ)₁/(Δt₂ − Δt₁)/(Δt_{f} − Δtᵢ) |
| Acceleration of the object of study is an | a = Δ²(ownership)/(Δt)² |
| occurrence, second in the order of time, caused | a = (Δvelocity/Δtime) = Δv/Δt |
| by change in the summation of force. | a = Δ(transaction rate)/Δt |
| | Acceleration of the economy is an |
| | occurrence, second in the order of time, |
| | caused by an increase in the summation of |
| | force assuming a gain has occurred as the |
| | output. |

Economics
The expected rate of return (ERR) is a relative change to the time rate of the change of energy.
Change in energy/Change in time/Energy Initial = (ΔE/Δt)Eᵢ = (ΔE/Δt)/KEᵢ

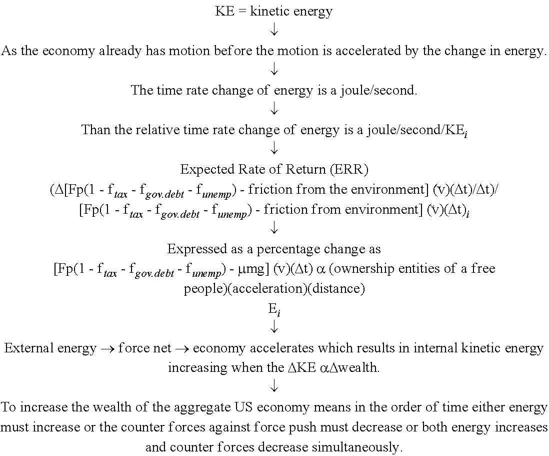

The subject matter described herein may be embodied in systems, apparatus, methods, and/or articles depending on the desired configuration. In particular, various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, calculators, and the like (also known as programs, software, software applications, applications, components, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs; optical disks; memory components such as in the form of memory chips, memory devices, and semiconductor memory devices; and Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor. Nonlimiting examples of semiconductor memory devices include volatile memory devices such as SRAM or DRAM devices, and nonvolatile memory devices such as ROM devices, flash memory devices, FeRAM devices, CBRAM devices, PRAM devices, SONOS devices, RRAM devices, Racetrack memory devices, NRAM devices, and Millipede devices.

Specifically, in certain embodiments, the present subject matter provides an article comprising a machine-readable medium embodying instructions that when performed by one or more machines result in operations which include the following. The instructions of the article include identifying at least one economic variable of an economic phenomena to be analyzed. The instructions also include assigning one or more physics variables to each of the identified economic variables, wherein the assigned physics variables correspond to the respective identified economic variable. And, the instructions include evaluating the assigned physics variables using physical laws to thereby analyze the economic phenomena.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Specifically, in certain embodiments, the present subject matter provides a system that includes a processor and a memory. The processor and memory are configured to perform operations that include identifying at least one economic variable of an economic phenomena to be analyzed. The operations also include assigning one or more physics variables to each of the identified economic variables, wherein the assigned physics variables correspond to the respective identified economic variable. And, the operations additionally include evaluating the assigned physics variables using physical laws to thereby analyze the economic phenomena.

Many other benefits will no doubt become apparent from future application and development of this technology.

All patents, published applications, standards and articles noted herein are hereby incorporated by reference in their entirety.

It will be understood that any one or more feature or component of one embodiment described herein can be combined with one or more other features or components of another embodiment. Thus, the present subject matter includes any and all combinations of components or features of the embodiments described herein.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A method of analyzing economic phenomena comprising:
identifying at least one economic variable of the economic phenomena to be analyzed;
assigning one or more physics variables to each of the identified economic variables, wherein the assigned physics variables correspond to the respective identified economic variable;
evaluating the assigned physics variables using physical laws to thereby analyze the economic phenomena.

2. The method of claim 1 wherein the physics variables are is selected from the group consisting of distance, velocity, acceleration, position, energy, and mass.

3. The method of claim 2 wherein the physics variable is distance, and distance is assigned to economic transaction rate and time.

4. The method of claim 2 wherein the physics variable is velocity, and velocity is assigned to economic variables of economic transaction rate and time.

5. The method of claim 2 wherein the physics variable is acceleration, and acceleration is assigned to economic variables of changes in economic transaction rates and changes in time.

6. The method of claim 2 wherein the physics variable is position, and position is assigned to at least one of (i) ownership entities, (ii) assets, (iii) net worth, and (iv) combinations of (i)-(iii).

7. The method of claim 2 wherein the physics variable is energy, and energy is assigned with wealth.

8. The method of claim 2 wherein the physics variable is mass, and mass is assigned with number of ownership entities.

9. The method of claim 1 wherein the economic phenomena is change in wealth and wherein identifying at least one economic variable of change in wealth is performed by selecting at least two variables from the group consisting of (i) gross domestic product, (ii) economic consumption, (iii) total energy available, (iv) costs of ownership changes, (v) taxation, (vi) cost of debt, and (vii) costs of unemployment.

10. The method of claim 1 wherein the economic phenomena is change in wealth and wherein the physics variables are selected from the group consisting of (i) gravity, (ii) friction, (iii) mass, (iv) distance, (v) time, (vi) force push, (vii) summation of forces, (viii) speed, (ix) velocity, and (x) acceleration.

11. An article comprising a machine-readable medium embodying instructions that when performed by one or more machines result in operations comprising:
identifying at least one economic variable of an economic phenomena to be analyzed;
assigning one or more physics variables to each of the identified economic variables, wherein the assigned physics variables correspond to the respective identified economic variable;
evaluating the assigned physics variables using physical laws to thereby analyze the economic phenomena.

12. The article of claim 11 wherein the article is selected from the group consisting of magnetic discs, optical disks, memory components, and programmable logic devices.

13. The article of claim 12 wherein the article is a semiconductor memory device.

14. A system comprising:
a processor and a memory, wherein the processor and the memory are configured to perform operations comprising:
identifying at least one economic variable of an economic phenomena to be analyzed;
assigning one or more physics variables to each of the identified economic variables, wherein the assigned physics variables correspond to the respective identified economic variable;
evaluating the assigned physics variables using physical laws to thereby analyze the economic phenomena.

15. A system as in claim 14, further comprising a user interface via which a user can select the economic variable for analysis.

16. A system as in claim 14, further comprising a user interface via which results of the analysis are presented to a user.

17. A system as in claim 14, further comprising means for receiving data related to the at least one economic variable.

18. A system as in claim 17, wherein the means for receiving the data comprises a mechanism that reads information coded on a machine-readable medium.

19. A system as in claim 17, wherein the means for receiving the data comprises a wired or wireless connection configured to receive a machine-readable signal from a database comprising the data related to the at least one economic variable.
